(19) United States
(12) Patent Application Publication
(10) Pub. No.: US 2024/0077946 A1
(43) Pub. Date: Mar. 7, 2024

(54) SYSTEMS AND METHODS OF GENERATING HIGH-DENSITY MULTI-MODAL HAPTIC RESPONSES USING AN ARRAY OF ELECTROHYDRAULIC-CONTROLLED HAPTIC TACTORS, AND METHODS OF MANUFACTURING ELECTROHYDRAULIC-CONTROLLED HAPTIC TACTORS FOR USE THEREWITH

(71) Applicant: Meta Platforms Technologies, LLC, Menlo Park, CA (US)

(72) Inventors: Priyanshu Agarwal, Kirkland, WA (US); FNU Purnendu, Boulder, CO (US); Nicholas Colonnese, Kirkland, WA (US)

(21) Appl. No.: 18/462,306

(22) Filed: Sep. 6, 2023

Related U.S. Application Data
(60) Provisional application No. 63/404,164, filed on Sep. 6, 2022.

(51) Int. Cl. G06F 3/01

(52) U.S. Cl. CPC G06F 3/016; G06F 3/014; G06F 3/017

(57) ABSTRACT

A wearable device includes wearable structure, an array of individually controlled electrohydraulic-controlled haptic tactors coupled to a portion of the wearable structure, a power source for providing a voltage, and circuitry configured to provide instructions for generating the haptic response. Each electrohydraulic-controlled haptic tactor is in fluid communication with an actuator pouch filled with a dielectric substance. A first end of the actuator pouch is positioned between at least two opposing electrodes that, when provided a voltage, are actuated to drive the dielectric substance within the actuator pouch, an intermediary portion of the actuator pouch fluidically couples first and second ends of the actuator pouch, and the second end of the actuator pouch is coupled with the electrohydraulic-controlled haptic tactor, such that movement of the dielectric substance to the second end of the actuator pouch is configured to cause the electrohydraulic-controlled haptic tactor to generate a haptic response.

### RELATED APPLICATIONS

This application claims priority to U.S. Provisional Patent Application No. 63/404,164, filed Sep. 6, 2022, titled “Systems And Methods Of Generating High-Density Multi-Modal Haptic Responses Using An Array Of Electrohydraulic-Controlled Haptic Tactors, And Methods Of Manufacturing Electrohydraulic-Controlled Haptic Tactors For Use Therewith,” which is hereby incorporated by reference in its entirety.

### TECHNICAL FIELD

The present disclosure relates generally to electrohydraulic-controlled (EC) haptic tactors, and more particularly to the generation of high-density multi-modal (fine tactile pressure and vibrations) haptic responses using an array of EC haptic tactors.

### BACKGROUND

Fingertips are the primary source of human interaction with the physical world as they are the most sensitive region of the human hand. Fingertips have a high density of sensitive mechanoreceptors that gives them a spatial tactile resolution in the sub-millimeter range. Fingertips can also sense a large range of forces (e.g., normal and/or shear forces), dynamic displacements (micrometer to mm), and vibrations. The sensitivity of fingertips has attracted efforts to augment them with sensation of touch for artificial-reality systems. However, the lack of haptic devices or haptic interfaces capable of generating the required stimulus (pressure, contact, vibration etc.) prevents the full utilization of the sense of touch in artificial-reality systems. Rigid electromechanical actuators can generate a wide range of forces to augment the tactile sensation; however, attaching rigid electromechanical actuators on fingertips is cumbersome. Rigid electromechanical actuators also cannot provide high-density haptic feedback due to their limited force-density and large form factor (which cannot be miniaturized). Existing fluidic actuators require an external pressure source, such as a pump, arrangement of tubes, and electromechanical valves to transport and control the fluid for actuation, which limits the actuation bandwidth of the system and makes it difficult to render high-frequency vibration. Further, fluidic pumps are noisy, inefficient and bulky, which makes it difficult to achieve a portable and untethered wearable system.

As such, there is a need of actuation technologies that address one or more of the above-identified challenges.

### SUMMARY

To address one or more of the challenges discussed above and bring a convincing sense of touch into artificial-reality environments, actuation technologies need to match the tactile sensitivity and resolution of the fingertips. To achieve this, the systems and devices disclosed herein integrate high-density soft actuators with multi-modal actuation capability in a wearable form factor. The systems and devices disclosed provide a thin, lightweight, wearable electrohydraulic haptic interface that can render high-density multi-modal (fine tactile pressure and vibrations) tactile sensations. In some embodiments, a haptic interface (e.g., an array of electrohydraulic-controlled haptic tactors) has a thin thickness (e.g., 200 micrometers), tactile resolution of at least 2 mm, and 16 individually controlled self-contained electrohydraulic-controlled tactors in an area of 1 cm². Each electrohydraulic-controlled tactor is capable of rendering both fine tactile pressure and high frequency vibration (e.g., 200 Hz to 300 Hz). This capability to render both pressure and vibration at this density provides a unique capability to generate haptic responses that simulate hardness, texture, curvature, sliding contacts etc. in an artificial-reality environment. Artificial-reality environments, include, but are not limited to, virtual-reality (VR) environments (including non-immersive, semi-immersive, and fully-immersive VR environments), augmented-reality environments (including marker-based augmented-reality environments, markerless augmented-reality environments, location-based augmented-reality environments, and projection-based augmented-reality environments), hybrid reality, and other types of mixed-reality environments. As the skilled artisan will appreciate upon reading the descriptions provided herein, the novel wearable devices described herein can be used with any of these types of artificial-reality environments.

The array of electrohydraulic-controlled (EC) haptic tactors are configured to couple with different wearable devices to improve users' interactions with artificial-reality environments and also improve user adoption of artificial-reality environments more generally by providing a form factor that is socially acceptable and compact, thereby allowing the user to wear the device throughout their day (and thus making it easier to interact with such environments in tandem with (as a complement to) everyday life). In some embodiments, the array of EC haptic tactors include the integration of stretchable membrane (e.g., an elastomer layer, such as Elastosil) with relatively inextensible dielectric substrates (e.g., Stretchlon Bagging Film) to achieve an electrohydraulic bubble actuator capable of achieving large displacements (e.g., at least 2 mm in a vertical direction) in a small form-factor (e.g., 2 cm×2.54 cm, 2.54 cm×2.54 cm, 2 cm×2 cm, etc.). The array of EC haptic tactors includes integrated stretchable tubing that allows for the dielectric substance (e.g., dielectric fluid, such as FR3) to be stored at a remote location from an actuation surface (e.g., fluid stored at adjacent to a fingernail while the fingertip or finger pad surface experiences actuation forces). The haptic responses generated by the array of EC haptic tactors includes physical characterization for quasi-static voltage-pressure behaviors, transient displacement responses, and vibrotactile frequency responses. The haptic responses generated by the array of EC haptic tactors also includes psychophysical characterization of the just-noticeable differences (JNDs) of the fine tactile pressure and vibrotactile frequency rendered by individual electrohydraulic bubble actuators (or EC haptic tactors). The array of EC haptic tactors are capable of simulating textures, hardness, as well as vibrations and subjective assessment of touch effects.

Systems and computer-readable storage media configured to perform or cause performance of the methods are summarized below.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

### BRIEF DESCRIPTION OF THE DRAWINGS

So that the present disclosure can be understood in greater detail, a more particular description may be had by reference to the features of various embodiments, some of which are illustrated in the appended drawings. The appended drawings, however, illustrate pertinent features of the present disclosure. The description may admit to other effective features as the person of skill in this art will appreciate upon reading this disclosure.

FIGS. 1A-1E illustrate an array of electrohydraulic-controlled haptic tactors, in accordance with some embodiment.

FIG. 2A illustrates an exploded view of an EC haptic tactor layer, in accordance with some embodiments.

FIG. 2B illustrates an assembled wireframe view of an array of EC haptic tactors, in accordance with some embodiments.

FIGS. 3A-3C illustrate an example implementation of an array of EC haptic tactors, in accordance with some embodiments.

FIGS. 4A-4F illustrates an example implementation of one or more arrays of EC haptic tactors in wearable device, in accordance with some embodiments.

FIG. 5 illustrates a graph showing the relationship between the actuator vertical height and the applied voltage, in accordance with some embodiments.

FIG. 6 illustrates a graph showing the relationship between the actuator vertical height and the pressure applied by actuator, in accordance with some embodiments.

FIG. 7 illustrates a method of manufacturing an EC haptic tactor layer, in accordance with some embodiments.

FIG. 8 illustrates a block diagram of a control architecture for a wireless, battery-operated EC haptic tactor (or array of EC haptic tactors 100) with a high-voltage (HV) direct current to direct current (DC-DC) converter, in accordance with some embodiments.

FIG. 9 illustrates a flowchart of a method of generating a haptic response at a wearable device, in accordance with some embodiments.

FIG. 10 illustrates a flowchart of a method of manufacturing an array of electrohydraulic-controlled haptic tactors for generating haptic responses, in accordance with some embodiments.

FIG. 11 illustrates a flowchart of a method of manufacturing a wearable device for generating a haptic response, in accordance with some embodiments.

FIGS. 12A-12D-2 illustrate example artificial-reality systems, in accordance with some embodiments.

FIGS. 13A-13B illustrate an example wrist-wearable device 1300, in accordance with some embodiments.

FIGS. 14A-14C illustrate example head-wearable devices, in accordance with some embodiments.

FIGS. 15A-15B illustrate an example handheld intermediary processing device, in accordance with some embodiments.

FIGS. 16A-16C illustrate an example smart textile-based garment, in accordance with some embodiments.

FIG. 17 illustrates a multi-dimensional knitting machine configured to produce multi-dimensional knitted smart textile-based garments in an automated fashion, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Having briefly summarized each of the figures, a detailed description of each of the figures follows next. Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

Embodiments of this disclosure can include or be implemented in conjunction with various types or embodiments of artificial-reality systems. Artificial-reality (AR), as described herein, is any superimposed functionality and or sensory-detectable presentation provided by an artificial-reality system within a user's physical surroundings. Such artificial-realities can include and/or represent virtual reality (VR), augmented reality, mixed artificial-reality (MAR), or some combination and/or variation one of these. For example, a user can perform a swiping in-air hand gesture to cause a song to be skipped by a song-providing API providing playback at, for example, a home speaker. An AR environment, as described herein, includes, but is not limited to, VR environments (including non-immersive, semi-immersive, and fully immersive VR environments); augmented-reality environments (including marker-based augmented-reality environments, markerless augmented-reality environments, location-based augmented-reality environments, and projection-based augmented-reality environments); hybrid reality; and other types of mixed-reality environments.

Artificial-reality content can include completely generated content or generated content combined with captured (e.g., real-world) content. The artificial-reality content can include video, audio, haptic events, or some combination thereof, any of which can be presented in a single channel or in multiple channels (such as stereo video that produces a three-dimensional effect to a viewer). Additionally, in some embodiments, artificial reality can also be associated with applications, products, accessories, services, or some combination thereof, which are used, for example, to create content in an artificial reality and/or are otherwise used in (e.g., to perform activities in) an artificial reality.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMU)s of a wrist-wearable device) and/or detected via image data captured by an imaging device of a wearable device (e.g., a camera of a head-wearable device)) or a combination of the user's hands. In-air means, in some embodiments, that the user hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single or double finger tap on a table, on a user's hand or another finger, on the user's leg, a couch, a steering wheel, etc.). The different hand gestures disclosed herein can be detected using image data and/or sensor data (e.g., neuromuscular signals sensed by one or more biopotential sensors (e.g., EMG sensors) or other types of data from other sensors, such as proximity sensors, time-of-flight sensors, sensors of an inertial measurement unit, etc.) detected by a wearable device worn by the user and/or other electronic devices in the user's possession (e.g., smartphones, laptops, imaging devices, intermediary devices, and/or other devices described herein).

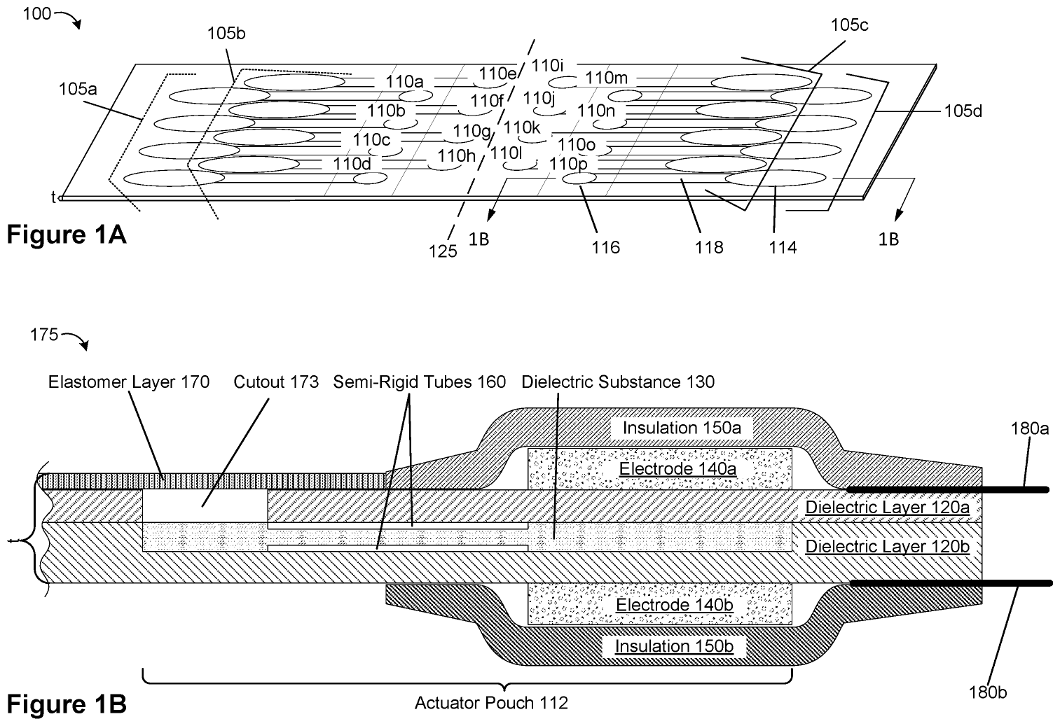

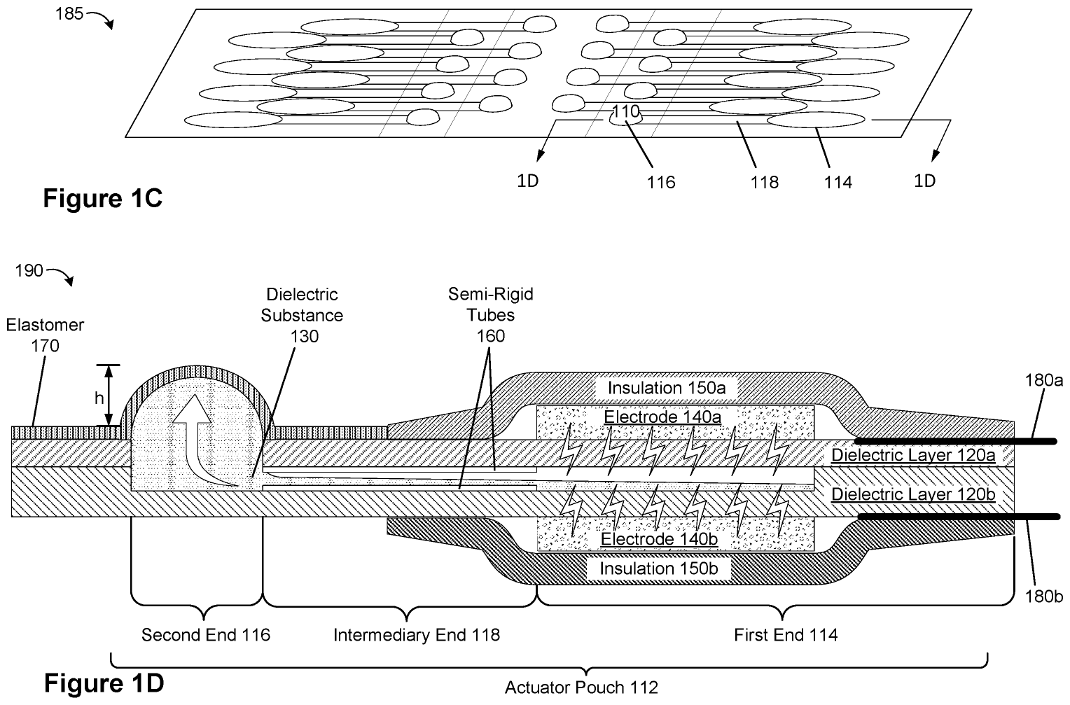

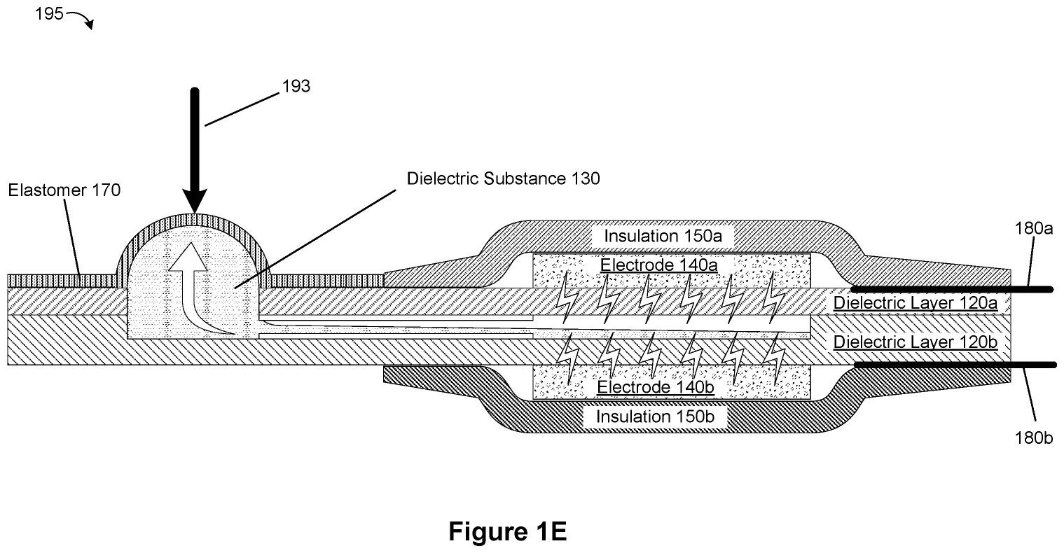

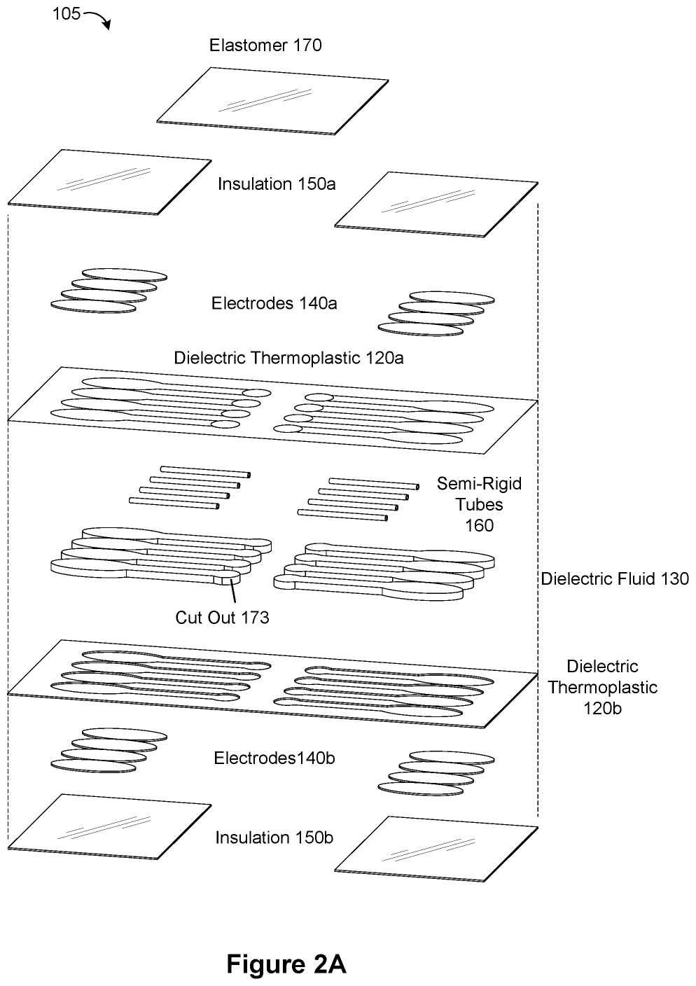

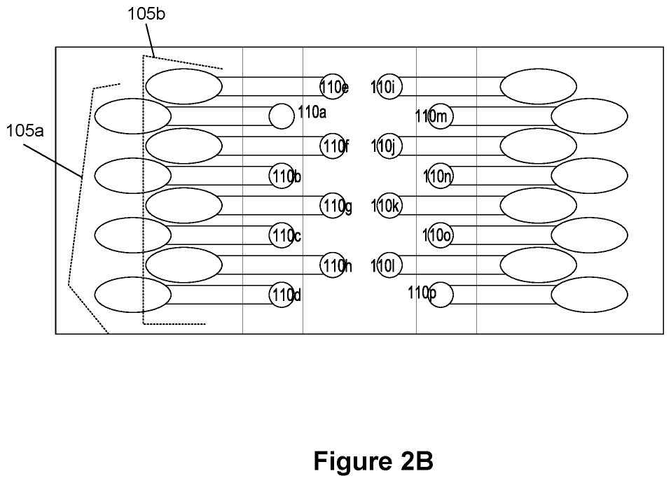

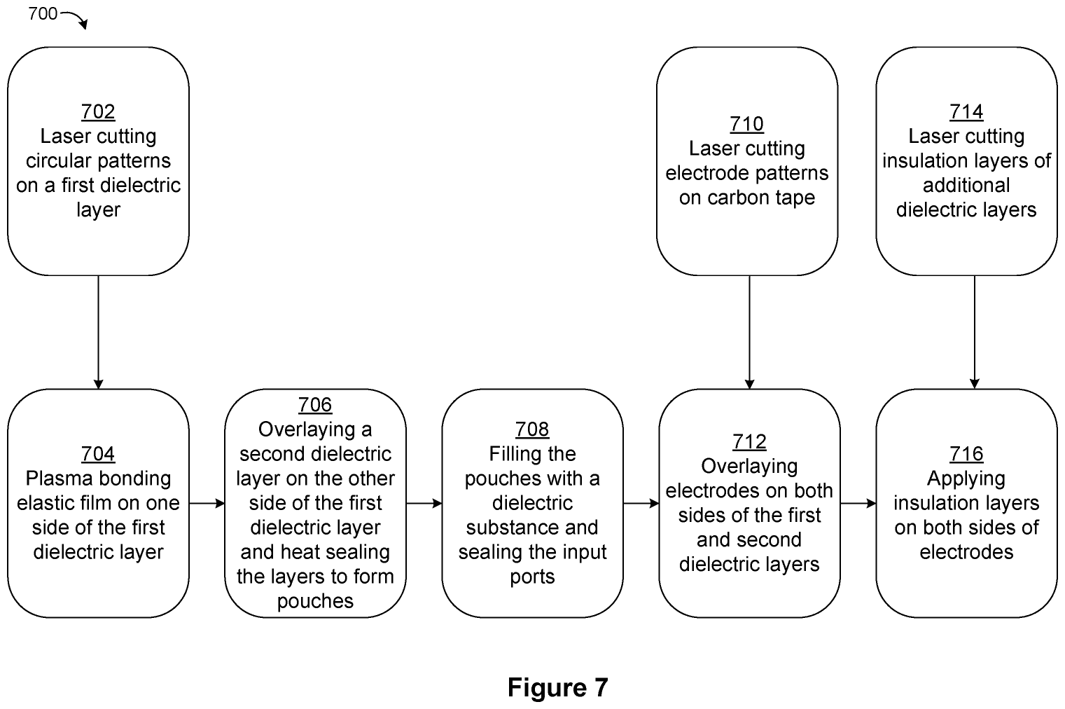

FIGS. 1A-1E illustrate an array of electrohydraulic-controlled haptic tactors, in accordance with some embodiment. FIG. 1A shows a first view of the array of electrohydraulic-controlled (EC) haptic tactors 100. The array of EC haptic tactors 100 includes one or more EC haptic tactors 110 (e.g., EC haptic tactors 110a through 110p) that are configured to provide respective haptic responses. In particular, each EC haptic tactor 110 is configured to provide both fine tactile pressure and high frequency vibrations (e.g., between 200 Hz and 300 Hz). The respective haptic responses of the EC haptic tactors 110 enable the array of EC haptic tactors 100 to provide high density multi-modal haptic sensations. In some embodiments, a high density multi-modal haptic sensation, for purposes of this disclosure, is a plurality of haptic responses with predetermined resolutions (e.g., 2 mm or less) provided within a predetermined area (e.g., 1 cm2), where the predetermined resolutions are less than the predetermined area. The high density multi-modal haptic sensations allow the array of EC haptic tactors 100 to provide users with unique sensations, such as hardness, texture, curvature, sliding contacts etc., in an artificial-reality environment. As discussed in detail below, the array of EC haptic tactors 100 improves users' interactions with artificial-reality environments and improves user adoption by providing a socially acceptable and compact form factor. In some embodiments, the array of EC haptic tactors 100 has a predetermined thickness (t). For example, in some embodiments, the predetermined thickness is 200 μm. In some embodiments, the predetermined thickness is between 200 μm and 700 μm. In some embodiments, the predetermined thickness is based on the material and number of layers used in the fabrication of the array of EC haptic tactors 100. Fabrication of the array of EC haptic tactors 100 is discussed below in reference to FIGS. 2A and 7.

The EC haptic tactors 110 generate haptic responses (e.g., tactile pressure and/or vibrations) responsive to respective voltages applied to the EC haptic tactors 110. In particular, the structure of each EC haptic tactor 110 is configured to allow for the application of accurate and precise localized haptic responses on a user's skin through provided voltages as described herein. In some embodiments, the EC haptic tactors 110 have a response time of approximately 25 ms (where approximately means+/−5 ms). Each EC haptic tactor 110 is in fluid communication with an actuator pouch 112 filled with a dielectric substance 130 (FIG. 1B). In some embodiments, a predetermined amount of the dielectric substance 130 is between 170-250 microliters. In some embodiments, the predetermined amount of the dielectric substance 130 is approximately 225 microliters (e.g., where approximately means+/−8 microliters). A first end 114 of the actuator pouch 112 forms part of a reservoir fluidically coupled with the EC haptic tactor 110 (e.g., storing a portion of the dielectric substance 130). The first end 114 of the actuator pouch 112 is coupled between at least two opposing electrodes 140 (FIG. 1B; e.g., at least one electrode 140a on a top surface of a portion of the actuator pouch 112 and at least one electrode 140b on a bottom surface, opposite the top surface, of the portion of the actuator pouch 112). In some embodiments, when a voltage is provided to the least two opposing electrodes 140 an electrostatic force is created that attracts the at least two opposing electrodes 140 together closing the first end 114 of the actuator pouch 112. When the at least two opposing electrodes 140 are closed by a provided voltage a portion of the dielectric substance 130 is pushed or driven to a second end 116 (opposite of the first end 114) of the actuator pouch 112 via an intermediary portion 118 (e.g., a neck portion) of the actuator pouch 112.

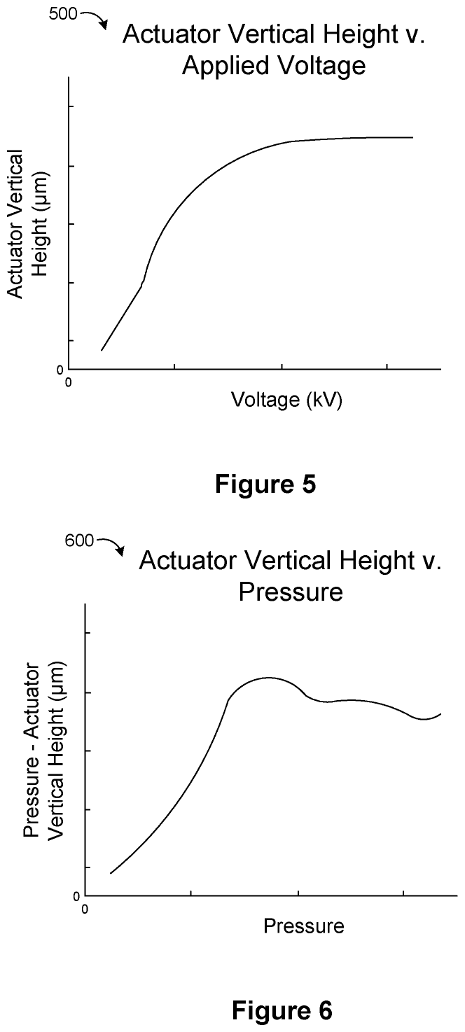

The intermediary portion 118 of the actuator pouch 112 fluidically couples the first end 114 and the second end 116 of the actuator pouch 112. The second end 116 of the actuator pouch 112 is coupled with the EC haptic tactor 110, such that movement of the dielectric substance 130 to the second end 116 of the actuator pouch 112 is configured to cause the EC haptic tactor to expand a predetermined amount. The second end 116 of the actuator pouch 112 is fluidically coupled to an expandable surface (e.g., the EC haptic tactor 110, which is formed, in part, of an elastomer layer 170; FIG. 1B) that is configured to expand a portion of the second end 116 up to a predetermined amount when the dielectric substance 130 is driven to the second end 116 by the voltage provided to the at least two opposing electrodes 140. In some embodiments, the predetermined amount is a predetermined vertical distance or height (e.g., 2 mm). In some embodiments, the vertical distance or height that the second end 116 of the actuator pouch 112 expands up to is based on the voltages applied (e.g., the larger the voltage the closer the second end 116 of the actuator pouch 112 expands up to the predetermined vertical distance or height). The vertical distance, for purposes of this disclosure, is a distance expending in a perpendicular direction from the expandable surface of the actuator pouch 112 away from the actuator pouch 112 (e.g., height “h” shown in FIG. 1D. Additional information on the relationship between voltages and the predetermined vertical distance (or height) are provided below in reference to FIG. 5.

In some embodiments, the array of EC haptic tactors 100 is formed by a one or more of EC haptic tactor layers 105 (e.g., EC haptic tactor layers 105a through 105d). Each EC haptic tactor layer 105 includes a predetermined number of EC haptic tactors 110. For example, in FIG. 1A, a first EC haptic tactor layer 105a includes first through fourth EC haptic tactors 110a-110d, a second EC haptic tactor layer 105b includes fifth through eight EC haptic tactors 110e-110h, a third EC haptic tactor layer 105c includes ninth through twelfth EC haptic tactors 110i-1101, a fourth EC haptic tactor layer 105d includes thirteenth through sixteenth EC haptic tactors 110m-110p. In some embodiments, the predetermined number of EC haptic tactors 110 of an EC haptic tactor layer 105 is at least one, at least 2, at least 4, etc. The predetermined number of EC haptic tactors 110 for each EC haptic tactor layer 105 can be the same or distinct. In some embodiments, the EC haptic tactors 110 are separated by a predetermined distance. In some embodiments, each respective EC haptic tactor 110 of the array of EC haptic tactors 100 is separated by a predetermined distance from an adjacent EC haptic tactor 110 of the array of EC haptic tactors 100. In some embodiments, the predetermined distance is substantially the same as the predetermined diameter of the EC haptic tactors 110 expandable surface. The predetermined distance can be a center-to-center distance between 0.3 mm to 0.5 mm, a center-to-center distance between 0.5 mm to 1 mm, a center-to-center distance between 1 mm to 2 mm, etc. The center-to-center distance is measured from center of the expandable surface of adjacent second ends 116 of the actuator pouch 112.

In some embodiments, the one or more EC haptic tactor layers 105 forming the array of EC haptic tactors 100 are superimposed or overlaid one another to form part of the array of EC haptic tactors 100. In some embodiments, the array of EC haptic tactors 100 can be formed of multiple overlaid EC haptic tactor layers 105. For example, in FIG. 1A, the array of EC haptic tactors 100 includes two different overlaid EC haptic tactor layers 105 the second EC haptic tactor layer 105b overlaid on the first EC haptic tactor layer 105a and the fourth EC haptic tactor layer 105d overlaid on the third EC haptic tactor layer 105c. Overlaid EC haptic tactor layers 105 are positioned such that respective second ends of the EC haptic tactors 110 are in the same direction and offset such that respective second ends 116 of EC haptic tactors 110 do not overlap. This allows for each expandable surface of the second ends 116 of EC haptic tactors 100 to contact the user's skin. For example, in FIG. 1A, the first and second EC haptic tactor layers 105a and 105b are offset such that the second ends of the EC haptic tactors 110 of the first and second EC haptic tactor layers 105a and 105b do not overlap, and respective second ends of the EC haptic tactors 110 of the first and second EC haptic tactor layers 105a and 105b face imaginary central line 125. Similarly, the third and fourth EC haptic tactor layers 105c and 105d are offset such that the second ends of the EC haptic tactors 110 of the third and fourth EC haptic tactor layers 105c and 105d do not overlap, and respective second ends of the EC haptic tactors 110 of the third and fourth EC haptic tactor layers 105c and 105d face imaginary central line 125.

The EC haptic tactor layers 105 are used to form arrays of EC haptic tactors 100 with different configurations and with different numbers of haptic generators. For example, as shown in FIG. 1A, the first through fourth EC haptic tactor layers 105a-105d form an array of EC haptic tactors 100 with 16 EC haptic tactors 110a-110p. Additionally, one or more EC haptic tactors 110 can have the same or distinct predetermined diameters (e.g., between 0.3 to 1.5 mm). As the skilled artisan will appreciate upon reading the descriptions provided herein, the array of EC haptic tactors 100 can have any number of EC haptic tactors 110 (e.g., at least 4, at least 8, etc.) and/or EC haptic tactors 110 positioned at different locations.

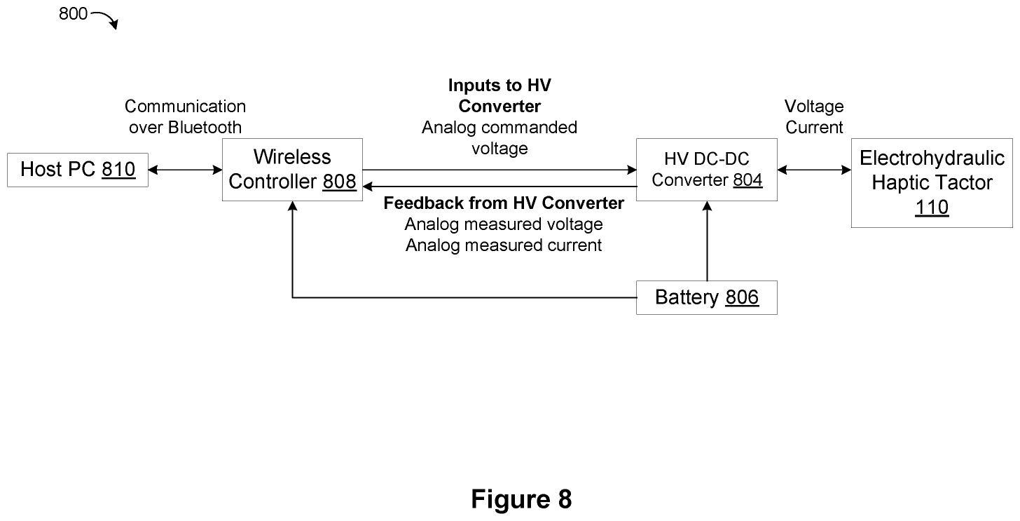

Turning to FIG. 1B, a first cross section of the array of EC haptic tactors 100 is shown. In particular, the first cross section 175 illustrates a cross section of an EC haptic tactor 110 and an actuator pouch 112. As described above, the EC haptic tactor 110 is in fluid communication with an actuator pouch 112, a first end 114 of the actuator pouch 112 coupled between at least two opposing electrodes 140a and 140b, a dielectric substance 130, and an elastomer layer 170 that forms an expandable surface of a second end 116 of the actuator pouch 112. In some embodiments, an intermediary portion 118 of the actuator pouch 112 includes a semi-rigid tube 160 that forms a channel for the dielectric substance 130 to move between the first end 114 and second end 116 of the actuator pouch 112. In some embodiments, insulating layers 150 are disposed over the at least two opposing electrodes 140 to prevent a user or people in proximity of the user from being electrocuted and/or protect the EC haptic tactor 110 from damage. In some embodiments, the at least two opposing electrodes 140a and 140b are coupled to respective conductors 180a and 180b that provide voltages from a power source (e.g., battery 806; FIG. 8) to the at least two opposing electrodes 140a and 140b.

In some embodiments, the actuator pouch 112 is formed of two dielectric (thermoplastic) layers 120a and 120b. The dielectric layers 120 can be Stretchlon (e.g., Stretchlon Bagging Film) or other similar material. At least one dielectric layer (e.g., a top dielectric layer 120a) includes a cutout 173. The cutout 173 defines a predetermined diameter of the expandable surface (e.g., the bubble dimensions of the EC haptic tactor 110). The predetermined diameter of the expandable surface can be, in some embodiments, is 0.3 mm to 1.5 mm. The cutout 173 is plasma bonded with an elastomer layer 170, which forms the expandable surface of the EC haptic tactor 110, which expands when the dielectric substance 130 moves into the second end 116 of the actuator pouch 112. In some embodiments, the elastomer layer 170 has a predetermined thickness (e.g., 20 μm). The two dielectric layers 120a and 120b are partially heat sealed to allow for the dielectric substance 130 to be injected between the two dielectric layers 120a and 120b. The dielectric substance 130 can be Cargill FR3, Novec 7300 and Novec 7500 and/or other similar substance. After the dielectric substance 130 is injected between the two dielectric layers 120a and 120b, the two dielectric layers 120a and 120b are fully heat sealed to create an airtight pouch. Integration of a stretchable membrane (e.g., the elastomer layer 170) with relatively inextensible dielectric substrates (e.g., dielectric layers 120) achieves an EC bubble actuator (e.g., the expandable surface of the EC haptic tactor 110) that is capable of achieving large displacements (e.g., 2 mm) in a small form-factor (e.g., area of 1 cm2).

The actuator pouch 112 disclosed herein includes its own reservoir (e.g., at the first end 114 of the actuator pouch 112) and does not require a dielectric substance 130 to be provided from a separate reservoir. This allows for systems to use the array of EC haptic tactors 100 without complicated tubing systems and/or complicated pumping systems for distributing a dielectric substance 130. Although not required, the array of EC haptic tactors 100 can be configured to receive dielectric substances 130 from a separate reservoir. While the array of EC haptic tactors 100 is configured to operate without complicated pumping systems and/or complicated tubing systems, the array of EC haptic tactors 100 can be modified to include such systems or integrate with other complicated pumping systems and/or complicated tubing systems. In such complicated systems, a pressure-changing device such as a pneumatic device, hydraulic device, a pneudraulic device, or some other device capable of adding and removing a medium (e.g., fluid, liquid, gas) can used with the array of EC haptic tactors 100.

In some embodiments, before the two dielectric layers 120a and 120b are fully heat sealed, an optional semi-rigid tube 160 is inserted between the two dielectric layers 120a and 120b, which is configured to stiffen the intermediary portion 118 of the actuator pouch 112 and form a channel for the dielectric substance 130 to move between the first end 114 and second end 116 of the actuator pouch 112. In some embodiments, the semi-rigid tube 160 is formed of elastomer and is flexible to allow for non-restrictive movement while preventing constriction when moved. In some embodiments, the semi-rigid tube 160 has 300 μm inner diameter and 600 μm outer diameter. As further discussed in detail below, the semi-rigid tube 160 allows for the dielectric substance 130 to be stored at a location distinct from the generation of the haptic response (e.g., at the back of the fingertip while the haptic response is generated adjacent to the finger, which achieve high density actuation in a wearable form-factor). In some embodiments, the thickness of the EC haptic tactors 110 is the predetermined thickness t of the array of EC haptic tactors 100. In some embodiments, the predetermined thickness is between 200 μm and 700 μm. In some embodiments, the thickness of the EC haptic tactors 110 is based on the material and number of layers used in the fabrication of the EC haptic tactors 100. Fabrication of the array of EC haptic tactors 100 is discussed below in reference to FIGS. 2A and 7.

The insulation layers 150 can be additional dielectric (thermoplastic) layers (e.g., Stretchlon). As indicated above, insulation layers 150 are configured to cover the at least two opposing electrodes 140a and 140b. In some embodiments, the insulation layers 150 is also configured to cover conductors 180a and 180b. The at least two opposing electrodes 140a and 140b can be conductive carbon tape or other conductive flexible material.

FIG. 1C shows a second view of the array of EC haptic tactors 100. In particular, the second view 185 shows the array of EC haptic tactors 100 in an actuated stated. In FIG. 1C, a voltage is applied to the at least two opposing electrodes 140a and 140b, which causes the first end 114 of the actuator pouch 112 to close (as shown in FIG. 1D) and drive a portion of the dielectric substance 130 to the second end 116 of the actuator pouch 112. When the second end 116 of the actuator pouch 112 receives the dielectric substance 130, the elastomer layer 170 expands up to a predetermined amount or height. In some embodiments, the expansion of the elastomer layer 170 is based on the voltage provided to the at least two opposing electrodes 140a and 140b. More specifically, increases in the voltage provided the at least two opposing electrodes 140a and 140b increases the amount of dielectric fluid (e.g., dielectric substance 130) that moves into the second end 116 of the actuator pouch 112 and increases the amount (e.g., the height) at which the EC haptic tactor 110 expands. Similarly, in some embodiments, a pressure and/or vibration force generated by an EC haptic tactor 110 is based on the voltage provide to the at least two opposing electrodes 140a and 140b (e.g., larger voltages result in the generation of stronger pressure and/or vibrations). Additional detail on the provided voltages are provided below.

FIG. 1D shows a second cross section of the array of EC haptic tactors 100. In particular, the second cross section 190 illustrates a cross section of an EC haptic tactor 110 when a voltage is provided to the at least two opposing electrodes 140a and 140b (represented by the lightning bolts on each of the at least two opposing electrodes 140a and 140b). When the voltage is provided to the at least two opposing electrodes 140a and 140b, the at least two opposing electrodes 140a and 140b are attracted to one another and the first end 114 of the actuator pouch 112 closes or collapses. When the first end 114 of the actuator pouch 112 closes, the dielectric substance 130 is driven to the second end 116 of the actuator pouch 112 which causes the expandable surface of a second end 116 of the actuator pouch 112 (e.g., the elastomer layer 170) to expand. In particular, the expandable surface rises by a height (h) relative to the voltage provided. The expandable surface maintains a substantially circular shape (e.g., a bubble shape) with a predetermined diameter of the cutout 173. As mentioned above in reference to FIGS. 1B, the predetermined diameter can be a diameter between 0.3 mm to 1.5 mm.

The second end 116 of the actuator pouch 112, when receiving the dielectric substance 130, causes the EC haptic tactor 110 to expand and generate a respective perceptible percussion force. In some embodiments, the perceptible percussion force is based on the vertical distance (h) that the expandable surface rises (e.g., the greater the vertical distance, the greater the skin depression or spatial tactile resolution). In some embodiments, each expandable surface of the EC haptic tactor 110 can expand up to a predetermined vertical distance (e.g., 2 mm). Additionally or alternatively, the second end 116 of the actuator pouch 112, when receiving the dielectric substance 130, causes the EC haptic tactor 110 to expand and generate a respective perceptible vibration force. In some embodiments, the respective perceptible vibration force is between 200 to 300 Hz.

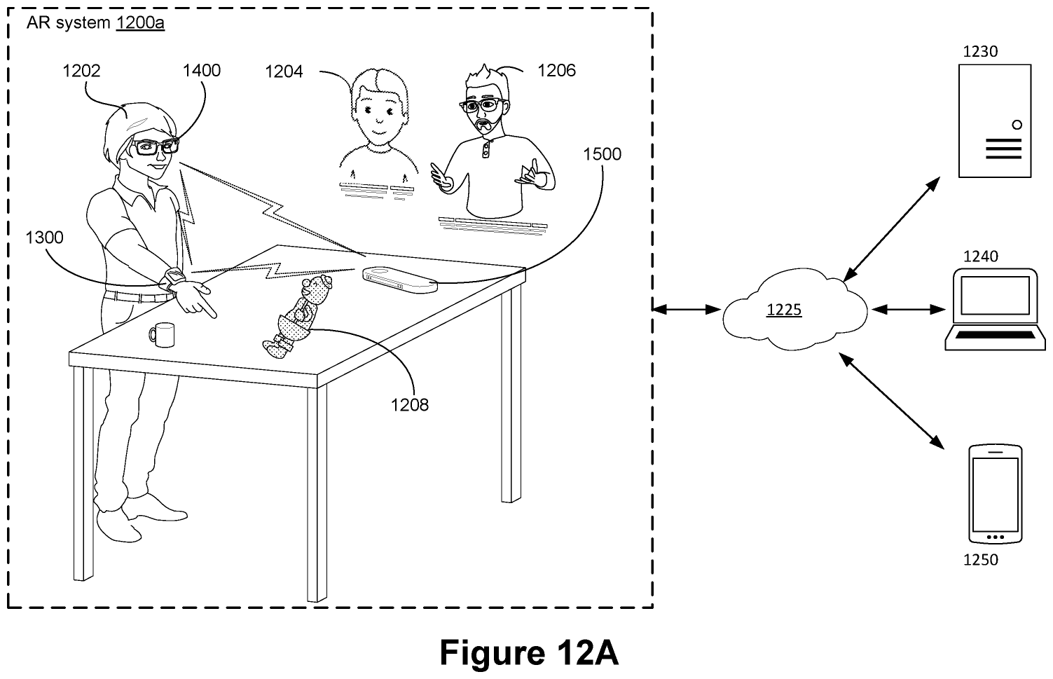

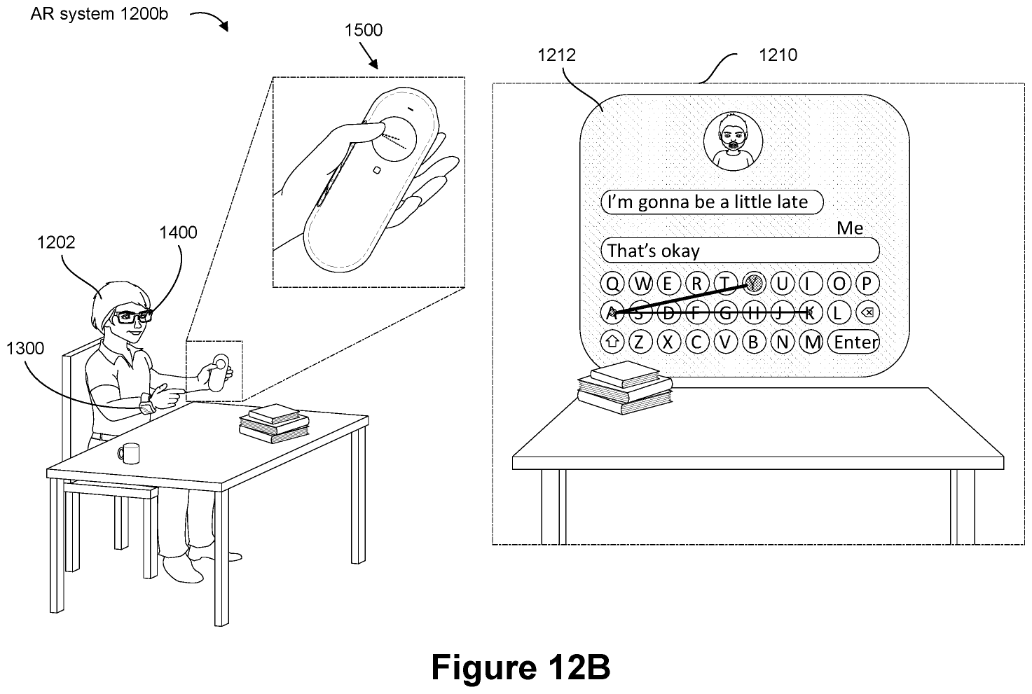

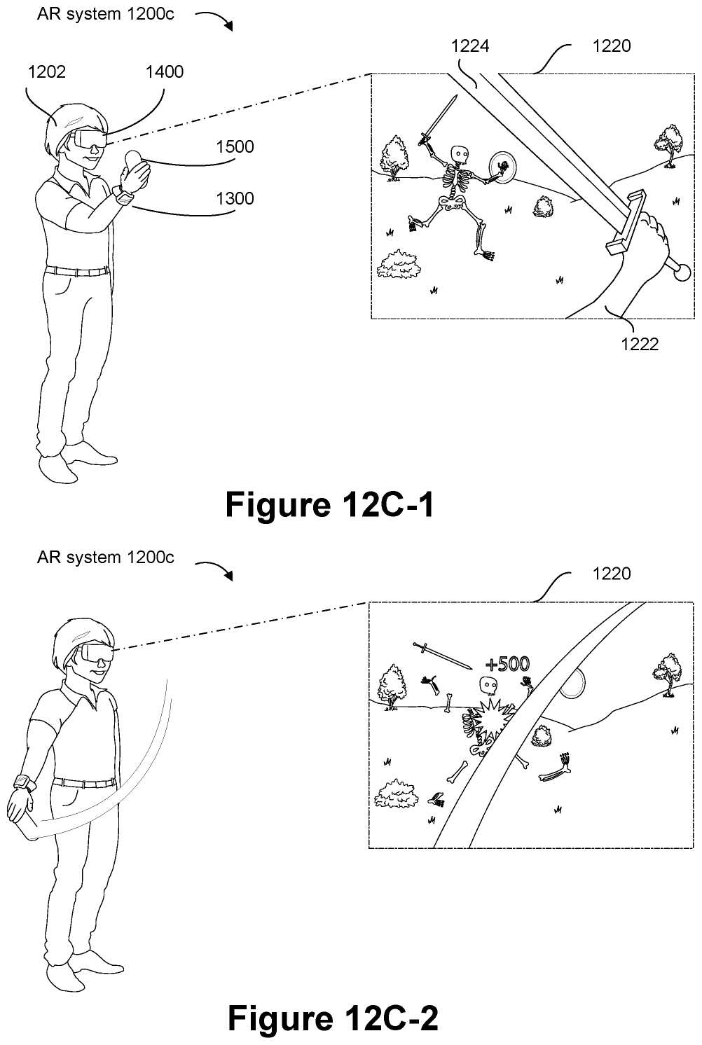

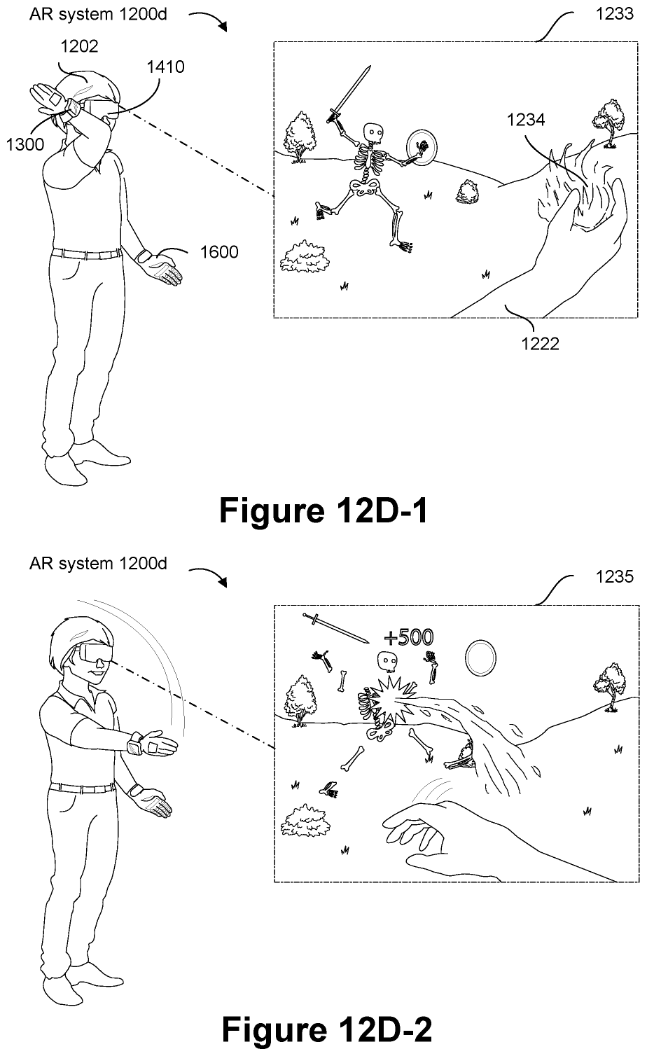

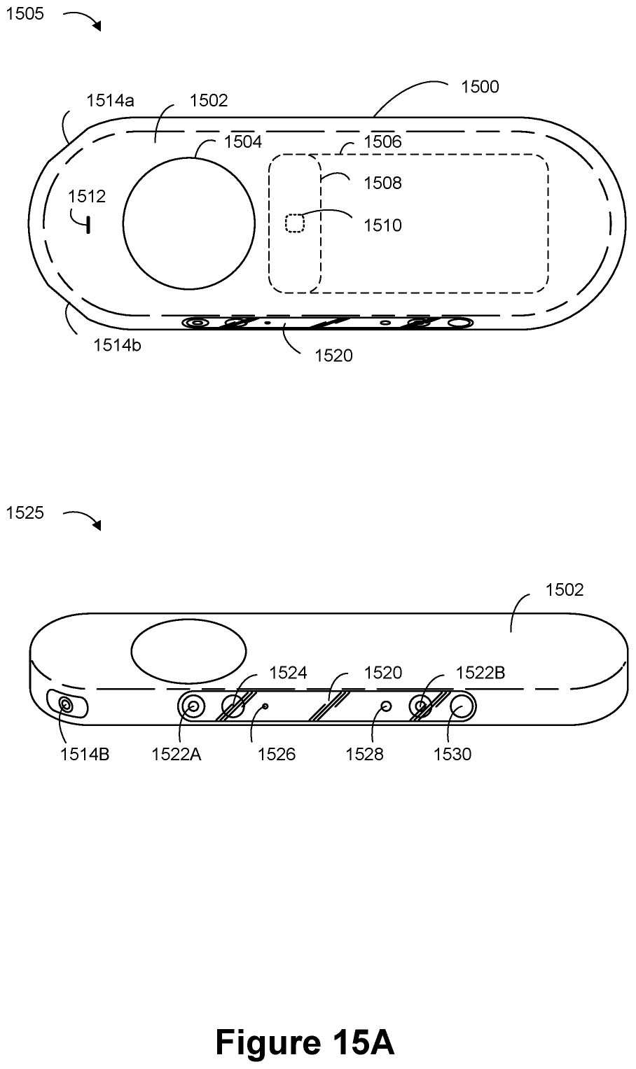

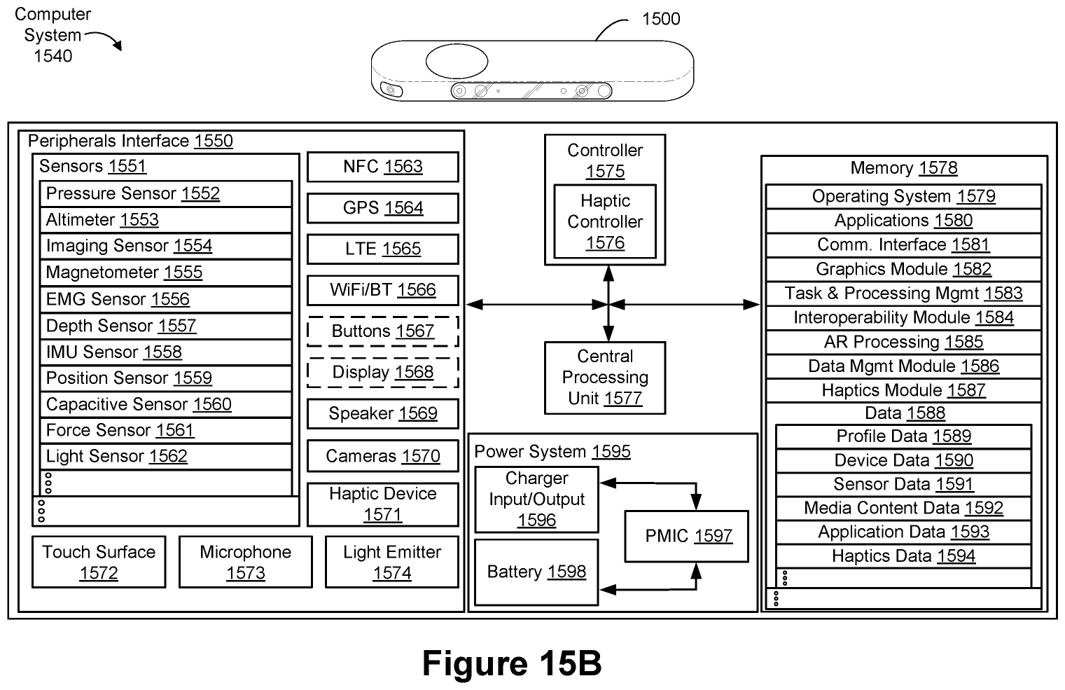

In some embodiments, each EC haptic tactor 110 of the array of EC haptic tactors 100 is individually controlled by circuitry (e.g., computer systems of one or more devices shown and described below in reference to FIG. 12A-17). In some embodiments, the circuitry is configured to adaptively or dynamically adjust a voltage provided to the at least two opposing electrodes 140a and 140b. In some embodiments, the voltage of each EC haptic tactor 110 is independently adjustable. In some embodiments, the voltage provided to the at least two opposing electrodes 140a and 140b is adjusted based on user participation in an artificial-reality environment and/or instructions received via an intermediary device (e.g., a handheld intermediary processing device 1500 (FIGS. 15A and 15B), a smartphone 1250, server 1230, computer 1240, or other devices described below in reference to FIGS. 12A-12D-2). In some embodiments, the voltage provided to the at least two opposing electrodes 140a and 140b is adjusted based on the amount of pressure and/or voltage required for a particular haptic response and/or to maintain an applied pressure and/or voltage (e.g., to counteract an opposite pressure, such as a pressure generated when the user presses an EC haptic tactor 100 against a surface). In some embodiments, the voltage provided to the at least two opposing electrodes 140a and 140b is adjusted based on the predetermined height voltage required for a particular haptic response and/or to maintain a particular height (e.g., to prevent an EC haptic tactor 100 from being pushed in when a counter force is applied). In some embodiments, the voltage provided to the at least two opposing electrodes 140a and 140b is adjusted based on how quickly the haptic response is to be generated. Additional detail on the adjustments to the voltage provide to the at least two opposing electrodes 140a and 140b is provide below in reference to FIG. 5.

In some embodiments, a voltage provided to the at least two opposing electrodes 140a and 140b is at least 3 kV. In some embodiments, a voltage provided to the at least two opposing electrodes 140a and 140b is between 3 kV and 5 kV. In some embodiments, a voltage provided to the at least two opposing electrodes 140a and 140b is up to 10 kV.

FIG. 1E shows a third cross section of the array of EC haptic tactors 100. In particular, the third cross section 195 illustrates a cross section of an EC haptic tactor 110 when a voltage is provided to the at least two opposing electrodes 140a and 140b and a counter force is applied to the EC haptic tactor 110. In particular, the counter force 193 pushes downward against the expansion of the expandable surface of the EC haptic tactor 110 and pushed back the dielectric substance 130 in the second end 116 of the actuator pouch 112. As described above in reference to FIG. 1D, a provided voltage can be adjusted to maintain a haptic response (e.g., such that the expandable surface of the EC haptic tactor 110 is not pushed back and/or stops vibrating).

In some embodiments, while a voltage is provided to the at least two electrodes 140a and 140b, the circuitry (e.g., AR system 1200a; FIG. 12A) is configured to detect a force applied to the EC haptic tactor 110. More specifically, the circuitry can detect when and how much force is applied to the EC haptic tactor 110 (e.g., against the expanded expandable surface of the EC haptic tactor 110). In some embodiments, the circuitry can detect a force applied to each respective EC haptic tactor 110 of the array of EC haptic tactors 100. The force applied to the respective EC haptic tactors 110 is determined based on a voltage provided to the at least two opposing electrodes 140a and 140b and a change to the displacement of the height of the expanded expandable surface of the EC haptic tactor 110 (and/or the amount of dielectric substance 130 pushed back in the second end 116 of the actuator pouch 112). The more force that is applied to the expanded expandable surface of the EC haptic tactor 110 the more dielectric substance that is pushed back to the first end 114 of the actuator pouch 112, which separates the attracted at least two opposing electrodes 140a and 140b (if the force is large enough relative to the provided voltage).

FIG. 2A illustrates an exploded view of an EC haptic tactor layer, in accordance with some embodiments. FIG. 2B illustrates an assembled wireframe view of an array of EC haptic tactors, in accordance with some embodiments.

In some embodiments, an EC haptic tactor layer 105 consists of several different layers. The EC haptic tactor layer 105 includes a first dielectric layer (also referred to as a top dielectric layer 120a). The top dielectric layer 120a defines a top portion of a plurality of EC haptic tactors 110 and includes a plurality of cutouts 173 for each EC haptic tactor 110 of the EC haptic tactor layer 105. In some embodiments, each cutout 173 has a predetermined diameter. In some embodiments, the predetermined diameter is 0.3 mm. In some embodiments, the predetermined diameter is 0.5 mm. In some embodiments, the predetermined diameter is between 0.3 mm and 1.5 mm. Each EC haptic tactor 110 of the EC haptic tactor layer 105 can have the same or distinct predetermined diameter. The EC haptic tactor layer 105 further includes an elastomer layer 170 bonded to the top dielectric layer 120a. More specifically, the elastomer layer 170 is bonded over the plurality of cutouts 173 and provides an expandable surface for each EC haptic tactor 110 of the EC haptic tactor layer 105. The elastomer layer 170 can be a stretchable silicone membrane, such as Elastosil. In some embodiments, the elastomer layer 170 has a predetermined thickness (e.g., 20 μm). In some embodiments, the elastomer layer 170 has a lateral dimension of 18 mm×18 mm).

The EC haptic tactor layer 105 also includes a second dielectric layer (also referred to as a bottom dielectric layer 120b). The bottom dielectric layer 120b (e.g., Stretchlon Bagging Film) defines a bottom portion of the plurality of EC haptic tactors 110 and is configured to be coupled with the top dielectric layer 120a to form a plurality of actuator pouches 112 (FIGS. 1A-1D) for respective EC haptic tactors 110. In some embodiments, before the plurality of actuator pouches 112 are fully sealed (e.g., through heat sealing of the top and bottom dielectric layers 120a and 120b), each actuator pouch 112 is filled with a dielectric substance 130 via an injection port (not shown). After the actuator pouches 112 are filled with the dielectric substance 130, they are (heat) sealed to form an airtight pouch. In some embodiments, before the plurality of actuator pouches 112 are filled with the dielectric substance 130, a respective semi-rigid tube 160 is inserted into each actuator pouch of the plurality of actuator pouches 112. The semi-rigid tube 160 is an elastomer, such as silicon, and allows each intermediary portion 118 of the plurality of actuator pouches 112 to be flexible. The flexibility of the intermediary portions 118 of the plurality of actuator pouches 112 allows for the dielectric substance 130 to be stored at distinct locations from the expandable surfaces of EC haptic tactors 110.

In some embodiment, adjacent expandable surfaces of the EC haptic tactors 110 of the EC haptic tactor layer 105 are separated by a predetermined center-to-center distance. In some embodiments, adjacent expandable surfaces of the EC haptic tactors 110 of the EC haptic tactor layer 105 are separated by the same or distinct center-to-center distances. Examples of the different center-to-center distances are provided above in reference to FIG. 1A. In some embodiments, the EC haptic tactor layer 105 includes a first set 210 of EC haptic tactors 110 and a second set 220 of EC haptic tactors 110. The first set 210 of EC haptic tactors 110 and the second set 220 of EC haptic tactors 110 are opposite to each other (e.g., respective expandable surfaces of the EC haptic tactors 110 of the first set 210 are adjacent to respective expandable surfaces of the EC haptic tactors 110 of the second set 220). In some embodiments, the first set 210 and second set 220 of EC haptic tactors 110 have the same or distinct number of EC haptic tactors 110.

The EC haptic tactor layer 105 further includes a plurality of electrodes 140a coupled to the top dielectric layer 120a and another plurality of electrodes 140b coupled to the bottom dielectric layer 120b. The respective electrodes of the plurality of electrodes 140a and 140b are coupled to each actuator pouch 112 opposite to the expandable surface. The plurality of electrodes 140a and 140b can be carbon tape electrodes.

The EC haptic tactor layer 105 can further include top and bottom inflation layers 150a and 150b. The top insulation layer 150a is configured to couple to and cover the plurality of electrodes 140a coupled to the top dielectric layer 120a and the bottom insulation layer 150b is configured to couple to and cover the other plurality of electrodes 140b coupled to the bottom dielectric layer 120b. In some embodiments, the top and bottom inflation layers 150a and 150b are Stretchlon.

Turning to FIG. 2B, two EC haptic tactor layers 105 are superimposed or overlaid one another. In some embodiments, the EC haptic tactor layers 105 are offset such that the EC haptic tactors 110 do not overlap. For example, as shown in FIG. 2B, a first EC haptic tactor layer 105a is offset from a second EC haptic tactor layer 105b such that EC haptic tactors 110 of the second EC haptic tactor layer 105b are positioned between the center-to-center distances of the EC haptic tactors 110 of the first EC haptic tactor layer 105a. In some embodiments, the different EC haptic tactor layers 105 have different configurations. For example, the second EC haptic tactor layer 105b can include a first set 230 of EC haptic tactors that is spaced apart from a second set 240 of EC haptic tactors by a first distance (d1), and the first EC haptic tactor layer 105a can include a first set 210 of EC haptic tactors that is spaced apart from a second set 220 of EC haptic tactors by a second distance (d2). The configurations shown above in reference to FIGS. 1A-2B are non-limiting. Different numbers of EC haptic tactors 110, EC haptic tactor layers 105, separation distances, predetermined diameters, etc. can be used to configure an array of EC haptic tactors 100.

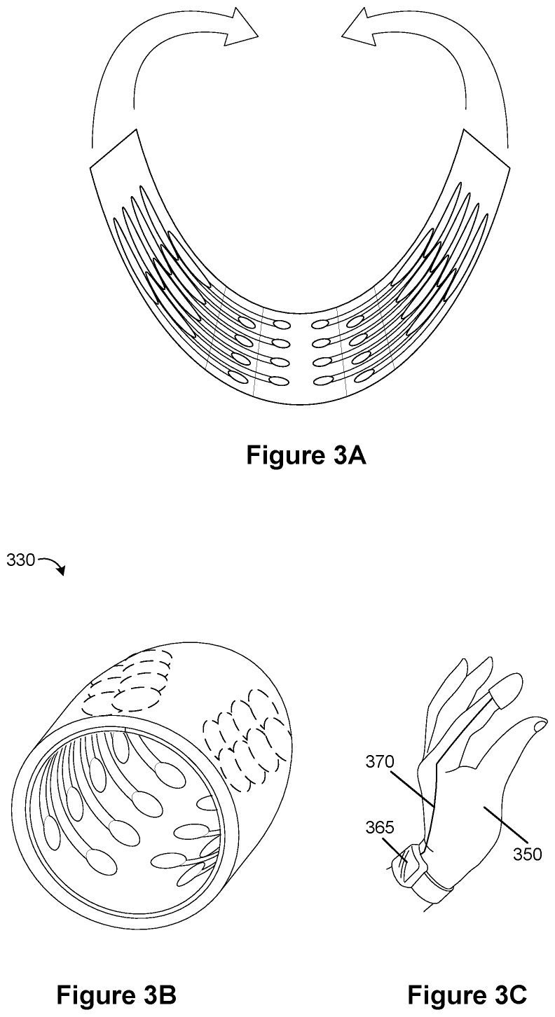

FIGS. 3A-3C illustrate an example implementation of an array of EC haptic tactors, in accordance with some embodiments. FIG. 3A shows an array of EC haptic tactors 100 arranged as a finger wearable device 330. The array of EC haptic tactors 100 is flexible and adjustable to fit a number of different form factors. For example, the array of EC haptic tactors 100 can be arranged to be positioned at a wearable structure of a wrist-wearable device, a glove, arm wearable device, head-wearable device, foot-wearable device, etc.

FIG. 3B shows the array of EC haptic tactors 100 configured as a finger wearable device 330. In the finger wearable device 330, the expandable surface of each EC haptic tactor 110 (e.g., the second end 116 of the EC haptic tactor 110) is positioned at a fingertip or finger pad portion of a user's finger and the reservoir of each EC haptic tactor 110 (e.g., the first end 114 of the EC haptic tactor 110) is positioned at a fingernail or top portion of the of the user's finger. Respective intermediary portions 118 of the EC haptic tactors 110 of the array of EC haptic tactors 100 are positioned on side portions of the user's finger (e.g., between the finger pad portion and fingernail portion of the user's finger). In some embodiments, each EC haptic tactor 110 of the array of EC haptic tactors 100 includes a semi-rigid tube 160 within the intermediary portion 118. The semi-rigid tube 160 allows for the dielectric substance 130 to move from the first end 114 of the EC haptic tactor 110 to the second end 116 of the EC haptic tactor 110 without generating a haptic response on the side portions of the user's finger. Additionally, the semi-rigid tube 160 reduces the chances of or prevents the intermediary portion 118 from bending or kinking, which would prevent an EC haptic tactor 110 from generating a haptic response. Further, the semi-rigid tube 160 allows for the dielectric substance 130 to move from the first end 114 of the EC haptic tactor 110 to the second end 116 of the EC haptic tactor 110 efficiently (e.g., without additional resistance or interference caused by the bending of the user's finger).

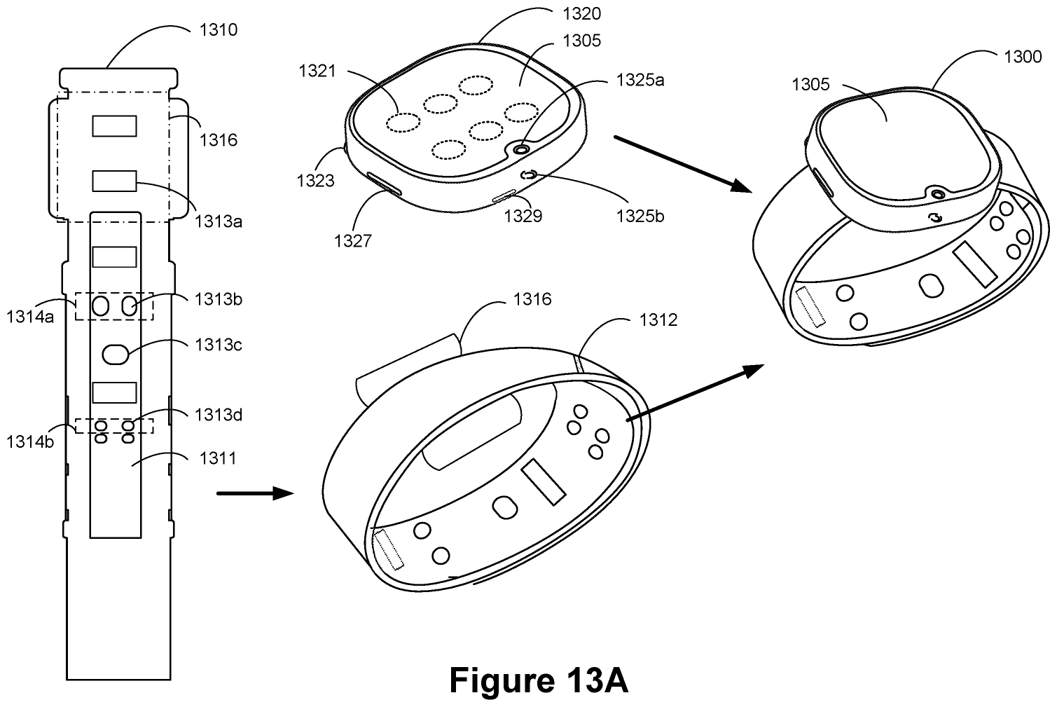

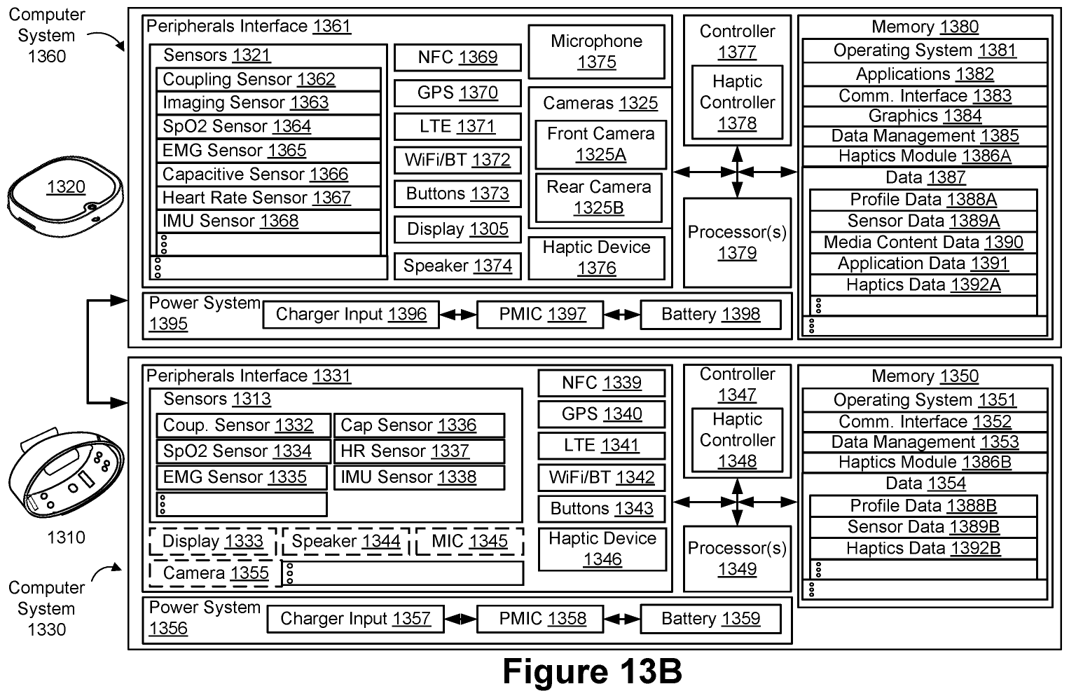

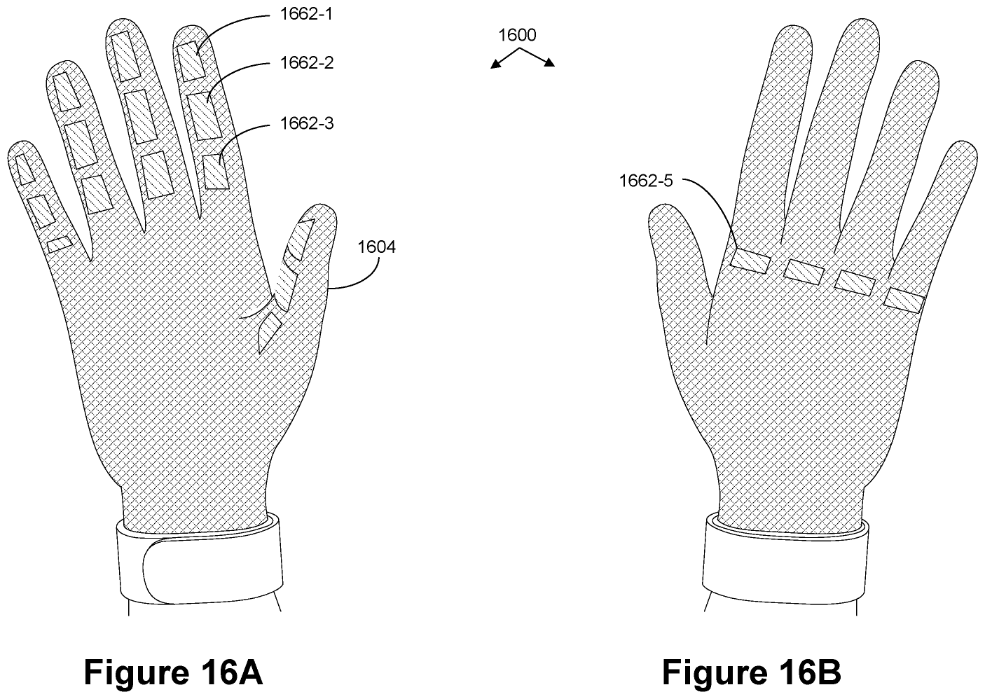

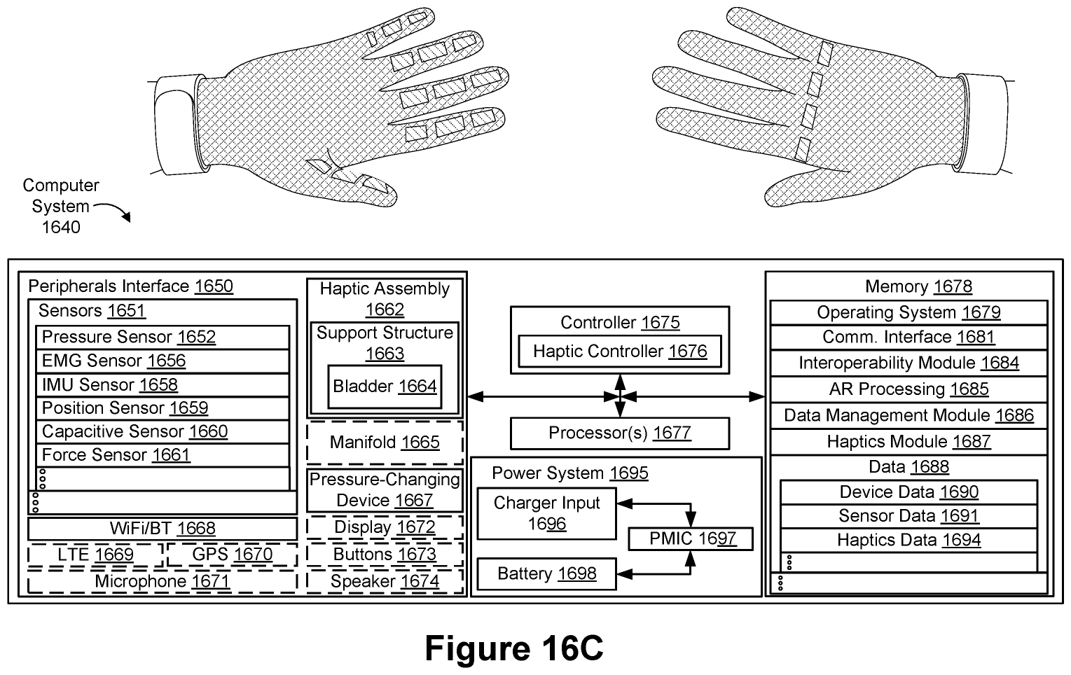

Although not shown, in some embodiments, the finger wearable device 330 includes circuitry (e.g., a computer system 1640; FIG. 16C) for providing instructions for generating a haptic response and a power source (e.g., a battery 806; FIG. 8) for providing voltages that are used in generating the haptic response. The different components of similar wearable devices are provided below in reference to FIGS. 13A-16C.

FIG. 3C shows the finger wearable device 330 worn by a user 350. In some embodiments, a wrist-wearable device 365 is communicatively coupled with the finger wearable device 330 and provides one or more instructions for generating a haptic response via the array of EC haptic tactors 100. In some embodiments, the finger wearable device 330 is communicatively coupled with the wrist-wearable device 365 (or other device such as a smartphone, head-wearable device, computer, etc.) via a wired 370 or wireless connection (e.g., Bluetooth). In some embodiments, the voltages for generating the haptic response are provided via a communicatively coupled device (e.g., the wrist-wearable device 365). Alternatively, in some embodiments, the finger wearable device 330 uses its power source to provide different voltages to the array of EC haptic tactors 100 for generating a haptic response.

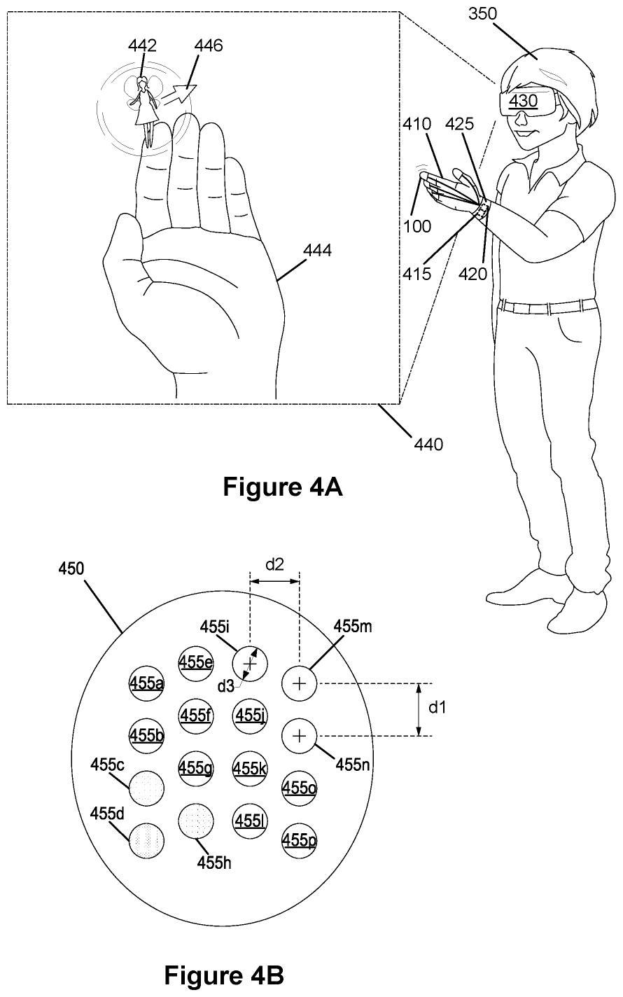

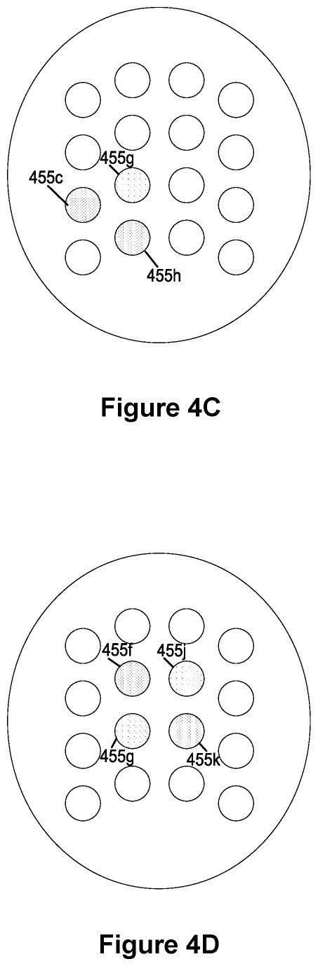

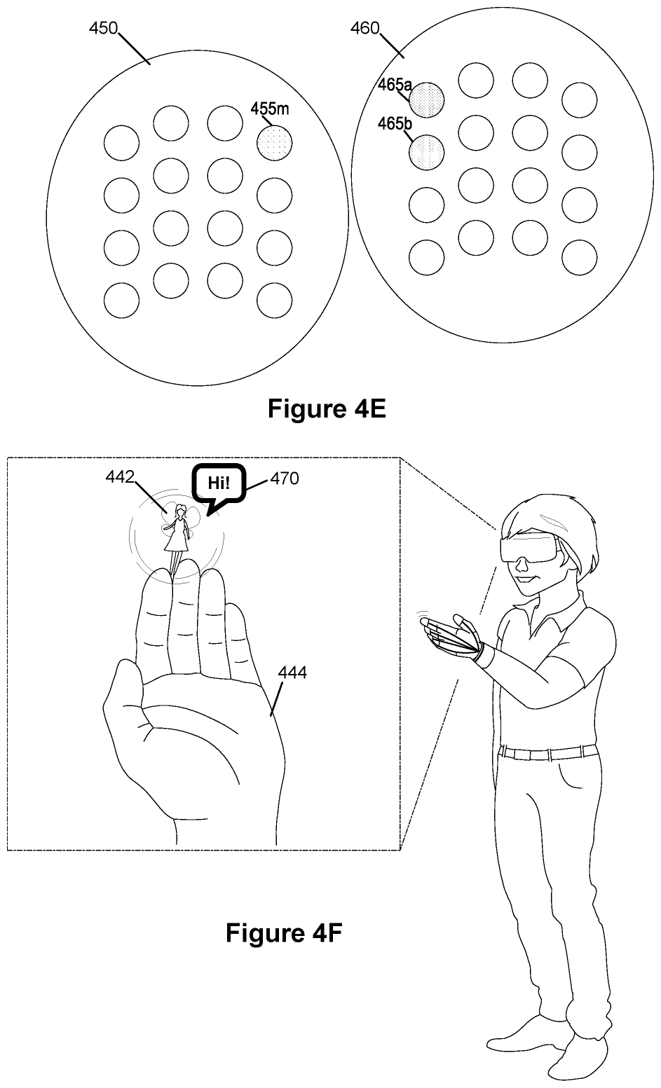

FIGS. 4A-4F illustrates an example implementation of one or more arrays of EC haptic tactors in wearable device, in accordance with some embodiments. In some embodiments, an array of EC haptic tactors 100 is coupled to at least a portion of wearable structure. In some embodiments, another array of EC haptic tactors 100 is coupled to at least another portion of the wearable device. For example, as shown in FIG. 4A, in some embodiments, the wearable device is a is a wearable glove 410 including one or more arrays of EC haptic tactors 100. In some embodiments, a first array of EC haptic tactors 100 is coupled to is a first finger of the wearable glove 410 that is configured to contact a user's first finger, and a second array of EC haptic tactors 100 is coupled to is a second finger of the wearable glove that is configured to contact a user's second finger. In some embodiments, an array of EC haptic tactors 100 can be coupled to the user's wrist, palmar side of the hand, dorsal side of the hand, thumb, and/or any other portion of the wearable glove 410. In some embodiments, each array of EC haptic tactors 100 is coupled to a user's finger as described above in reference to FIGS. 3A-3C (e.g., the second end 116 of the EC haptic tactors 110 adjacent to the user's fingertips or finger pad).

In some embodiments, the wearable glove 410 includes a power source 415 for providing voltages to the one or more arrays of EC haptic tactors 100 to the wearable glove 410 and circuitry 420 (analogous to computer system 1640; FIG. 16C) for providing instructions for generating a haptic response. The circuitry 420 includes a communications interface 1681 (FIG. 16C) for communicatively coupling with the one or more arrays of EC haptic tactors 100, the power source 415, a head-wearable device 430, and/or other intermediary device (e.g., a handheld intermediary processing device 1500, a smartphone, a computer, a tablet, a server, and/or other devices described below in reference to FIGS. 12A-12D-2). In some embodiments, the wearable glove 410 is communicatively coupled with other wearable accessories for facilitating the generation of one or more haptic response. For example, in some embodiments, the wearable glove 410 is communicatively coupled with a power band 425 (e.g., a wristband including a respective power source 415 (e.g., a battery 806; FIG. 8) and/or circuitry 420) that is configured to provide an additional power source for generating haptic responses and/or extend the battery life of the wearable glove 410.

As described below in reference to FIG. 16C, in some embodiments, the circuitry 420 (analogous to computer system 1640; FIG. 16C) includes memory storing one or more programs or applications that, when executed by one or more processors, provide instructions for generating haptic response. Additionally or alternatively, in some embodiments, the wearable glove 410 is communicatively coupled with one or more wearable devices (e.g., a head-wearable device 430) and/or intermediary devices (e.g., a handheld intermediary processing device 1500, a server, a computer, a smartphone and/or other devices described below in reference to FIGS. 12A-12D-2) that are configured to provide data and/or instructions to and between the wearable glove 410 and another device. The data and/or instructions are configured to cause performance of one or more operations in conjunction to the operations performed by the wearable glove 410. In some embodiments, the wearable glove 410 is communicatively coupled with other user devices (e.g., by way of a Bluetooth connection between the two devices, and/or the two devices can also both be connected to an intermediary device that provides instructions and data to and between the devices). For example, the wearable glove 410 can be communicatively coupled with a head-wearable device 430, which is configured to cause performance of one or more operations in conjunction to the operations performed by the wearable glove 410.

Returning to FIG. 4A, the user 350 is wearing the wearable glove 410 and a communicatively coupled head-wearable device 430. The user 350 is further performing one or more operations in an artificial-reality environment 440. In particular, the user 350 is playing a game that is executed by the head-wearable device 430 and/or the wearable glove 410. The artificial-reality environment 440 includes a virtual object 442 (e.g., a fairy) that is interacting with a virtual representation of the user's hand 444. As shown by arrow 446 in FIG. 4A, the virtual object 442 is in the process of moving to the right of the user's hand 444 (e.g., toward the pinkie finger).

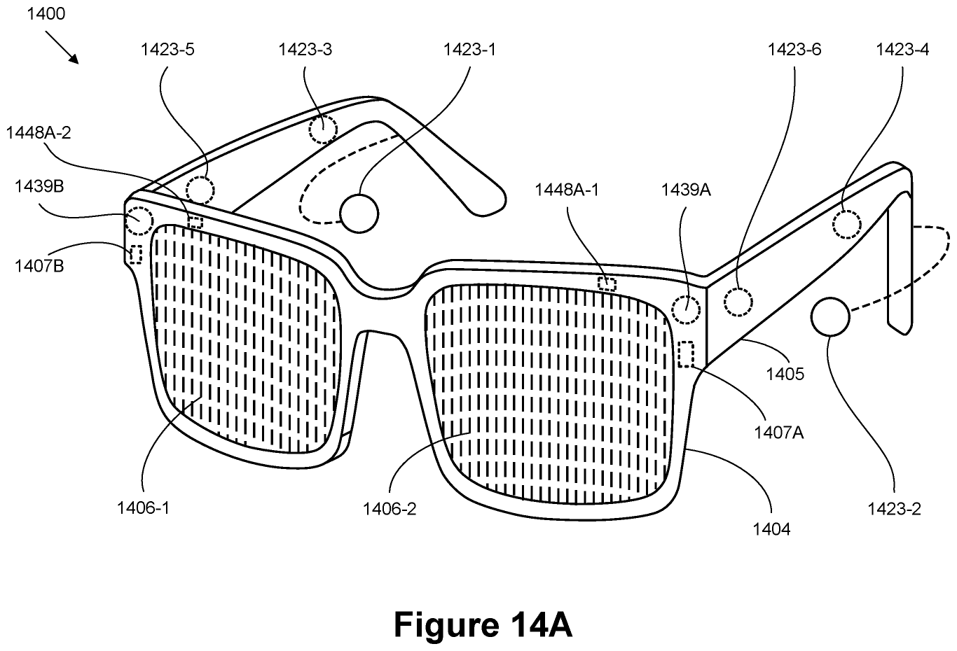

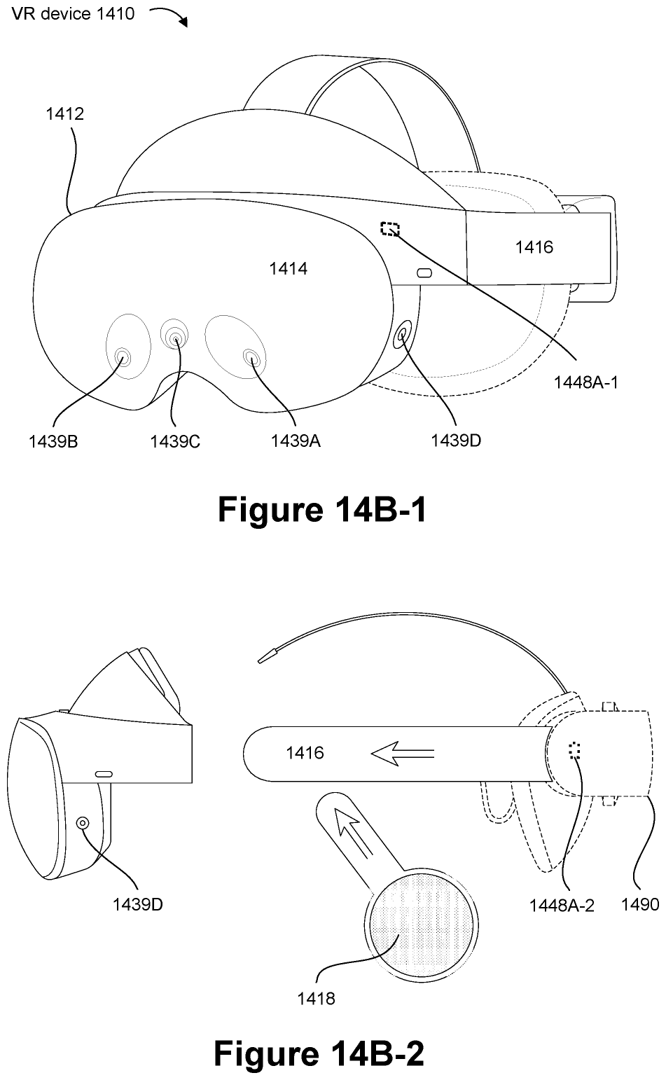

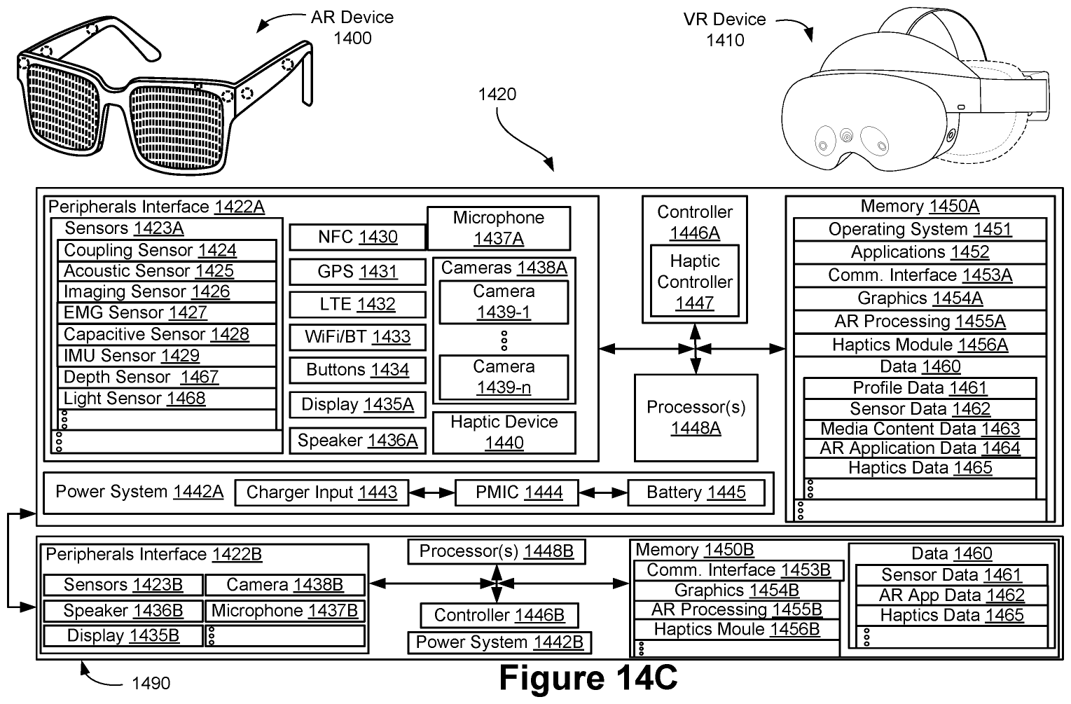

The head-wearable device 430 (analogous to AR device 1400 and VR device 1410) includes an electronic display, sensors, and a communication interface, and/or other components described below in reference to FIGS. 14A-14C). The electronic display presents images to the user in accordance with data generated at the head-wearable device 430 and/or received from a communicatively coupled device. The head-wearable device 430 can presents AR content, media, or other content to the user 350. Examples of the AR content and/or other content presented by the head-wearable device 430 include images (e.g., images that emulate real-world objects objects), video, audio, application data, or some combination thereof. In some embodiments, audio is presented via an external device (e.g., speakers and/or headphones) that receives audio information from the head-wearable device 430, an intermediary device (e.g., handheld intermediary processing device 1500; FIGS. 15A and 15B), and/or other communicatively coupled device, and presents audio data based on the audio information.

FIG. 4B shows a top view of an index finger 450 of the wearable glove 410. The index finger 450 of the wearable glove 410 includes an array of EC haptic tactors 100. In particular, FIG. 4B illustrates the index finger 450 of the wearable glove 410 on which the virtual object 442 is positioned. The array of EC haptic tactors 100 includes expandable surfaces 455a-445p (analogous to the second ends 116 of the EC haptic tactors 110). In some embodiments, each expandable surface 455 has a predetermined diameter d3. The predetermined diameter can be 0.3 mm to 1.5 mm. The predetermined diameter d3 of each expandable surface 455 can be the same or distinct. For example, in some embodiments, each expandable surface 455 diameter is 0.3 mm. In some embodiments, each expandable surface 455 is separated by predetermined center-to-center distance (e.g., distances d1 and d2). In some embodiments, the expandable surfaces are separated by the same predetermined center-to-center distance or distinct predetermined center-to-center distances. For example, expandable surface 455i can be separated from expandable surface 455m by a distance d2 and the expandable surface 455m can be separated from expandable surface 455n by the distance d1. In some embodiments, the predetermined center-to-center distance is substantially the same as the predetermined diameter of the expandable surfaces 455. The predetermined center-to-center distance is between 0.3 mm to 0.5 mm, between 0.5 mm to 1 mm, between 1 mm to 2 mm, etc. In an example embodiments, the predetermined diameter is 1.5 mm and the predetermined center-to-center distance is 3 mm.

The wearable glove 410 and/or the head-wearable device 430 can provide instructions, via circuitry 420, to individually control each EC haptic tactor 110 of the array of EC haptic tactors 100. In some embodiments, one or more EC haptic tactor 110 are activated based on user participation in an artificial-reality environment and/or instructions received via an intermediary device. For example, as shown in FIG. 4B, the third, fourth, and eighth expandable surfaces 455c, 455d, and 455h are activated based on the position of the virtual object 442 on the virtual representation of the user's hand 444. The fourth expandable surface 455d is expanded at a greater vertical distance than the third and eighth expandable surfaces 455c and 455h (as noted by the darker shading of the fourth expandable surface 455d). More specifically, the user 350 would feel a haptic response on the bottom left of their finger pad, with the larger force being at the most bottom left corner (e.g., at the fourth expandable surface 455d). In some embodiments, the wearable glove 410 and/or the head-wearable device 430 are configured to, via the circuitry 420, adaptively adjust a voltage provided to the EC haptic tactor 110 of the array of EC haptic tactors 100 based on the user's participation in an artificial-reality environment. For example, if the user 350 were to move their finger up and down the virtual object 442 on the virtual representation of the user's hand 444 may begin to bounce, which would cause the wearable glove 410 and/or the head-wearable device 430 to generate a different haptic response that is sensed on the user's finger (e.g., relative to the virtual objects 442 current position). The haptic response can simulate the bounce of the virtual object 442 (e.g., a changing vertical force as well as associated changes in vibrations).

Each array of EC haptic tactors 100 is configured to generate the physical characterization a quasi-static voltage-pressure behavior, a transient displacement response, and vibrotactile frequency response, as well as psychophysical characterization of the just-noticeable differences (JNDs) of the fine tactile pressure and vibrotactile frequency rendered by individual expandable surfaces 455 of EC haptic tactors 110. In some embodiments, the array of EC haptic tactors 100 is configured to render textures, hardness, as well as vibrations and subjective assessment of finger feel effects that demonstrate the rich tactile information that can be sensed by a fingertip. Each EC haptic tactor 110 of the array of EC haptic tactors 100 can generate a respective perceptible percussion force and/or a respective perceptible vibration force at distinct portion of wearable structure (e.g., at different portions of the user's finger) based on the provided voltages. The voltages that can be provided to the EC haptic tactors 110 of the array of EC haptic tactors 100 is between 3 kV to 10 kV. In some embodiments, the respective perceptible vibration force is between 200 to 300 Hz. Additional information on the types of haptic responses are provided above in reference to FIGS. 1A-1E.

Turning to FIG. 4C, the virtual object 442 moves on the virtual representation of the user's hand 444 toward the upper right corner of the user's finger. The wearable glove 410 and/or the head-wearable device 430 dynamically adjust the voltage provided to the array of EC haptic tactors 100 such that the third, seventh, and eighth expandable surfaces 455c, 455g, and 455h are activated based on the new position of the virtual object 442 on the virtual representation of the user's hand 444. For example, the third and seventh expandable surfaces 455c and 455g are expanded at a greater vertical distance than the eighth expandable surface 455h (as noted by the darker shading of the third and seventh expandable surfaces 455c and 455g). As a result, the user 350 would feel the haptic responses moving from the bottom left of their finger pad toward the center of the finger pad.

Similarly in FIG. 4D, the virtual object 442 moves on the virtual representation of the user's hand 444 further toward the upper right corner of the user's finger. The wearable glove 410 and/or the head-wearable device 430 dynamically adjust the voltage provided to the array of EC haptic tactors 100 such that the sixth, seventh, tenth and eleventh expandable surfaces 455f, 455g, 455j and 455k are activated based on the new position of the virtual object 442 on the virtual representation of the user's hand 444. For example, the sixth and eleventh expandable surfaces 455f and 455k are expanded at a greater vertical distance than the seventh and tenth expandable surfaces 455g and 445k (as noted by the darker shading of the sixth and eleventh expandable surfaces 455f and 455k). As a result, the user 350 would feel the haptic responses moving further toward the upper right of the finger pad.

Turning to FIG. 4E, the virtual object 442 jumps for the user's index finger to the middle finger on the virtual representation of the user's hand 444. The wearable glove 410 and/or the head-wearable device 430 dynamically adjust the voltages provided to the array of EC haptic tactors 100 on the index finger 450 of the wearable glove 410 and an array of EC haptic tactors 100 on a middle finger 460 of the wearable glove 410. The array of EC haptic tactors 100 on the middle finger 460 of the wearable glove 410 are similar to the array of EC haptic tactors 100 on the index finger 450 of the wearable glove 410. For example, both the index finger 450 and the middle finger 460 of the wearable glove 410 have the same number of EC haptic tactors 100 (e.g., expandable surfaces 455 and expandable surfaces 465, respectively). While the index finger 450 and the middle finger 460 of the wearable glove 410 have the same number of EC haptic tactors 100, in some embodiments, different portions of wearable glove 410 can have a different number of EC haptic tactors 100.

In the example shown in FIG. 4E, the wearable glove 410 and/or the head-wearable device 430 dynamically adjust the voltages provided to the arrays of EC haptic tactors 100 on the index finger 450 and the middle finger 460 of the wearable glove 410 such that the thirteenth expandable surface 455m of the index finger 450 of the wearable glove 410 is activated, and first and second expandable surfaces 465a and 465b of the middle finger 460 of the wearable glove 410 are activated based on the new position of the virtual object 442 on the virtual representation of the user's hand 444. As the virtual object 442 jumps between fingers, the first and second expandable surfaces 465a and 465b of the middle finger 460 of the wearable glove 410 are expanded at a greater vertical distance than the thirteenth expandable surface 455m of the index finger 450 of the wearable glove 410 (as noted by the darker shading of the first and second expandable surfaces 465a and 465b of the middle finger 460 of the wearable glove 410). As a result, the user 350 would feel a greater number or more pronounced haptic responses at the upper left of the finger pad of the middle finger, and a fewer number or more subtle haptic responses at the upper right of the finger pad of the index finger.

In some embodiments, the user 350 can provide one or more inputs via the one or more arrays of EC haptic tactors 100 of the wearable glove 410. In some embodiments, the user 350 can interact with the virtual object 442 via the one or more activated EC haptic tactor 110 (e.g., activated that are activated by the wearable glove 410 and/or the head-wearable device 430 based on user participation in the artificial-reality environment). For example, while a voltage is provided to the first and second expandable surfaces 465a and 465b of the middle finger 460 and the thirteenth expandable surface 455m of the index finger 450 (in response to movement of the virtual object 442), the wearable glove 410 and/or the head-wearable device 430 can detect a force applied to any of the first and second expandable surfaces 465a and 465b of the middle finger 460 and the thirteenth expandable surface 455m of the index finger 450; and, in response to detecting a force applied to any of the first and second expandable surfaces 465a and 465b of the middle finger 460 and the thirteenth expandable surface 455m of the index finger 450, the wearable glove 410 and/or the head-wearable device 430 cause an input command to be performed in the artificial-reality environment. In FIG. 4F, the input command results in the virtual object 442 generating a greeting response 470 or otherwise interacting with the user 350.

FIG. 5 illustrates a graph showing the relationship between the actuator vertical height and the applied voltage, in accordance with some embodiments. More specifically, plot 500 shows a change in the vertical distance or height of an expandable surface of an EC haptic tactor 110 when different voltages are applied. In some embodiments, the vertical distance or height of the expandable surface of the EC haptic tactor 110 increases up to a predetermined vertical distance (e.g., 2 mm) based on the voltage. In some embodiments, the height of the expandable surface of the EC haptic tactor 110 reaches the predetermined vertical distance at approximately 3-5 kV. As the voltage increases further, the height of the expandable surface of the EC haptic tactor 110 does not increase significantly.

FIG. 6 illustrates a graph showing the relationship between the actuator vertical height and the pressure applied by actuator, in accordance with some embodiments. More specifically, plot 600 shows a pressure applied by the expandable surface of the EC haptic tactor 110 when expanded to different heights. As the expandable surface of an EC haptic tactor 110 is expanded to greater vertical distances, the more pressure that the EC haptic tactor 110 can provide to a user. After the expandable surface EC haptic tactor 110 reaches a plateau vertical distance (e.g., 1.5 to 2 mm), the pressure that the EC haptic tactor 110 can continue to increase. This prevents the expandable surface EC haptic tactor 110 from being pushed in and/or allows the EC haptic tactor 110 to provide firm pressure. Further, as described above in reference to FIGS. 1A-4F, the different pressures that the EC haptic tactors 110 can provide enable the array of EC haptic tactors 100 to be dynamically adjusted.

FIG. 7 illustrates a method of manufacturing an EC haptic tactor layer, in accordance with some embodiments. The method 700 of manufacturing the EC haptic tactor layer 105 (FIGS. 1A-2B), at first process, includes laser cutting (702) circular patterns on a first dielectric layer 120a (FIGS. 1A-2B; e.g., Strechlon). The circular patterns are analogous to cutouts 173 of FIG. 1A-2B and have a predetermined diameter. The method 700 of manufacturing the EC haptic tactor layer 105, at second process, includes plasma bonding (704) elastic film (e.g., an elastomer layer 170 (FIG. 1A-2B), such as Elastosil) on one side of the first dielectric layer 120a. The elastic film is used to form the expandable surface of each EC haptic tactor 110 (FIGS. 1A-4F). The method 700 of manufacturing the EC haptic tactor layer 105, at third process, includes overlaying (706) a second dielectric layer 120b (FIGS. 1A-2B; e.g., Strechlon) on the other side of the first dielectric layer 120a and heat sealing the layers to form pouches (e.g., actuator pouches 112; FIGS. 1A-2B). The method 700 of manufacturing the EC haptic tactor layer 105, at fourth process, includes filling (708) the pouches with a dielectric substance 130 (FIGS. 1A-2B) and sealing the input ports (used to fill the actuator pouches 112)

The method 700 of manufacturing the EC haptic tactor layer 105, at fifth and sixth processes, includes laser cutting (710) electrode patterns on carbon tape or other electrodes, and overlaying (712) electrodes on both sides of the first and second dielectric layers. For example, as shown in FIGS. 1A-2B, electrodes 140a and 140b are coupled to both of the first and second dielectric layers 120a and 120b respectively. The method 700 of manufacturing the EC haptic tactor layer 105, at seventh and eighth processes, includes laser cutting (714) insulation layers of additional dielectric layers (e.g., strechlon), and applying (716) insulation layers on both sides of electrodes. For example, as shown in FIGS. 1A-2B, insulation layers 150a and 150b are coupled over the electrodes 140a and 140b, respectively. In some embodiments, flexi-cables (e.g., conductors 180a and 180b) are secured and insulating tape is applied.

FIG. 8 illustrates a block diagram of a control architecture for a wireless, battery-operated EC haptic tactor 110 (or array of EC haptic tactors 100; FIGS. 1A-4F) with a high-voltage (HV) direct current to direct current (DC-DC) converter, in accordance with some embodiments. Schematic 800 of FIG. 8 illustrates an EC haptic tactor 110 coupled to a high voltage direct current to a HV DC-DC converter 804. The coupling is configured to pass voltage and current to and from the HV DC-DC converter 804 to the EC haptic tactor 110. The HV DC-DC converter 804 is coupled to a battery 806, which supplies direct current to the HV DC-DC converter 804. The battery 806 is also coupled to a wireless controller 808, and supplies power to the controller 808 (also referred to as a wireless controller). The controller 808 is coupled to the HV DC-DC converter 804 and is configured to transmit inputs to the HV DC-DC converter 804 (e.g., commands regarding how much voltage to apply to the EC haptic tactor 110 to simulate different interface objects). In some embodiments, the voltage that is commanded is an analog commanded voltage. The HV DC-DC converter 804 is configured to provide feedback to the controller 808. In some embodiments, the feedback includes analog measured voltage and analog measured current. The controller 808 is coupled and in bi-directional communication (e.g., via Bluetooth) with a host PC 810 (e.g., a mobile device, a wearable device, a receiving device, a desktop computer, etc.).

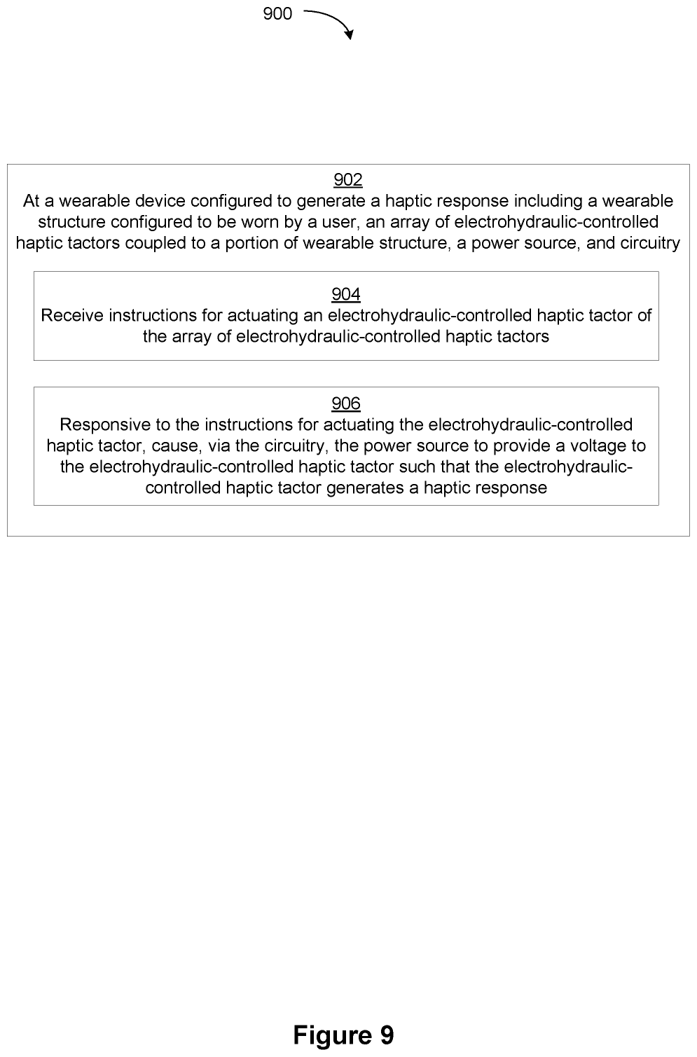

FIG. 9 illustrates a flowchart of a method of generating a haptic response at a wearable device, in accordance with some embodiments. Operations (e.g., steps) of the method 900 can be performed by one or more processors (e.g., central processing unit and/or MCU) of the systems and the devices described above in reference to FIGS. 1A-8 and 12A-17. At least some of the operations shown in FIG. 9 correspond to instructions stored in a computer memory or computer-readable storage medium (e.g., storage, RAM, and/or memory) of the systems and devices illustrated in FIGS. 12A-17. Operations of the method 900 can be performed by a single device alone or in conjunction with one or more processors and/or hardware components of another communicatively coupled device (e.g., such as the systems shown in FIGS. 1A-8) and/or instructions stored in memory or computer-readable medium of the other device communicatively coupled to the system (e.g., a head-wearable device, wrist-wearable device, and wearable glove). In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device, but should not be construed as limiting the performance of the operation to the particular device in all embodiments.

In some embodiments, the method 900 is performed (902) at a wearable device configured to generate a haptic response including a wearable structure configured to be worn by a user, an array of EC haptic tactors 100 (FIGS. 1A-8) coupled to a portion of wearable structure, a power source, and circuitry. The method 900 includes receiving (904) instructions for actuating an EC haptic tactor 110 (FIGS. 1A-8) of the array of EC haptic tactors 100 and, responsive to the instructions for actuating the EC haptic tactor 100, causing (906), via the circuitry, the power source to provide a voltage to the EC haptic tactor 110 such that the EC haptic tactor 110 generates a haptic response. For example, as shown in FIGS. 1A-4F, different haptic responses are generated and provided to a user (e.g., based on user participation in an artificial-reality environment and/or instructions received via an intermediary device).

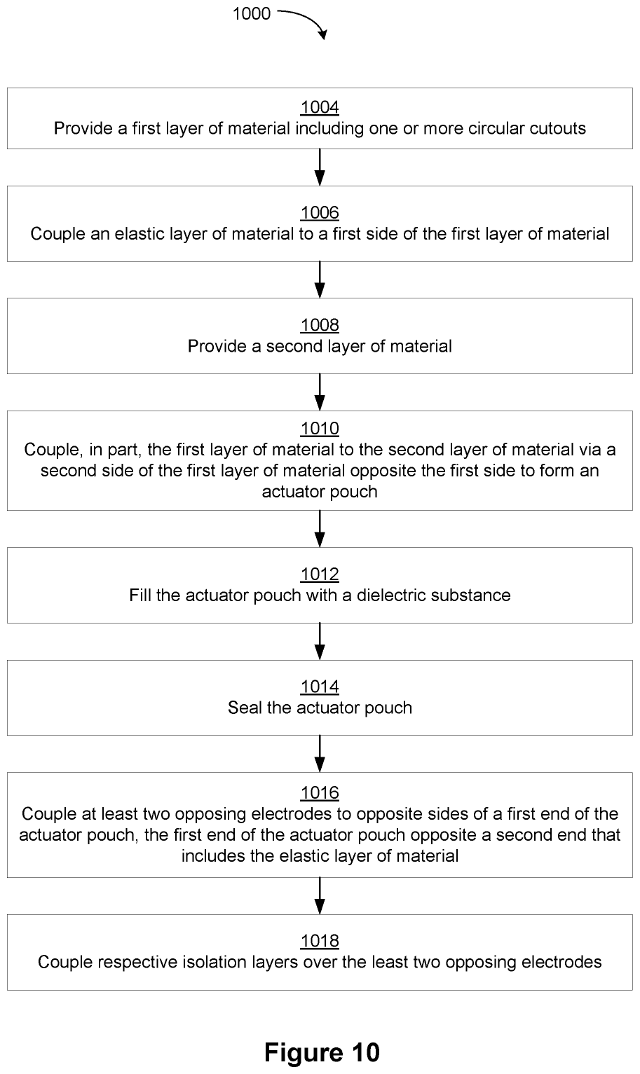

FIG. 10 illustrates a flowchart of a method of manufacturing an array of electrohydraulic-controlled haptic tactors for generating haptic responses, in accordance with some embodiments. The method 1000 of manufacturing an array of EC haptic tactors 100 (FIGS. 1A-8) includes providing (1004) a first layer of material including one or more circular cutouts. For example, as described above in reference to FIGS. 1A-2B and 7, a first dielectric layer 120a is provided for forming the array of EC haptic tactors 100. In some embodiments, the circular cutouts (also referred to as cutouts 173) are cutout (e.g., via laser cutting) from the first dielectric layer 120a. The method 1000 of manufacturing the array of EC haptic tactors 100 includes coupling (1006) an elastic layer of material to a first side of the first layer of material. For example, as described above in reference to FIGS. 1A-2B and 7, an elastomer layer 170 is coupled to (e.g., plasma bonded) to the dielectric layer 120a covering the circular cutouts 173 on a single side (e.g., a top surface).

The method 1000 of manufacturing the array of EC haptic tactors 100 includes providing (1008) a second layer of material, coupling (1010), in part, the first layer of material to the second layer of material via a second side of the first layer of material opposite the first side to form an actuator pouch. For example, as described above in reference to FIGS. 2A and 7, a second dielectric layer 120b is coupled to (e.g., heat sealed) to the first dielectric layer 120a on an opposite side of the surface coupled to the elastomer layer. This forms part of an actuator pouch 112 (e.g., FIGS. 1A-2B) that is configured to receive a dielectric substance. The method 1000 of manufacturing the array of EC haptic tactors 100 includes filling (1012) the actuator pouch 112 with a dielectric substance and sealing (1014) the actuator pouch. More specifically, after the actuator pouch 112 is filled with the dielectric substance it is sealed to create an airtight container as described above in reference to FIGS. 1A-2B and 7.

The method 1000 of manufacturing the array of EC haptic tactors 100 further includes coupling (1016) at least two opposing electrodes to opposite sides of a first end of the actuator pouch, the first end of the actuator pouch opposite a second end that includes the elastic layer of material; and coupling (1018) respective isolation layers over the least two opposing electrodes. At least two opposing electrodes 140a and 140b (FIGS. 1A-2B and 7) are coupled to a part of each actuator pouch 112 of an EC haptic tactor 110 of the array of EC haptic tactors 100. The at least two opposing electrodes 140a and 140b, when provided a voltage, are attracted to one another and cause a portion of the actuator pouch 112 to close, which causes the expandable surface of an EC haptic tactor 100 to expand. In some embodiments, the insulation layers 150a and 150b (FIGS. 1A-2B and 7) are laser cut from a dielectric substance.

In some embodiments, one or more conductors 180a and 180b are coupled to the at least two opposing electrodes 140a and 140b. The one or more conductors 180a and 180b provide a voltage from a power source for actuating each EC haptic tactor 110 of the array of EC haptic tactors 100.

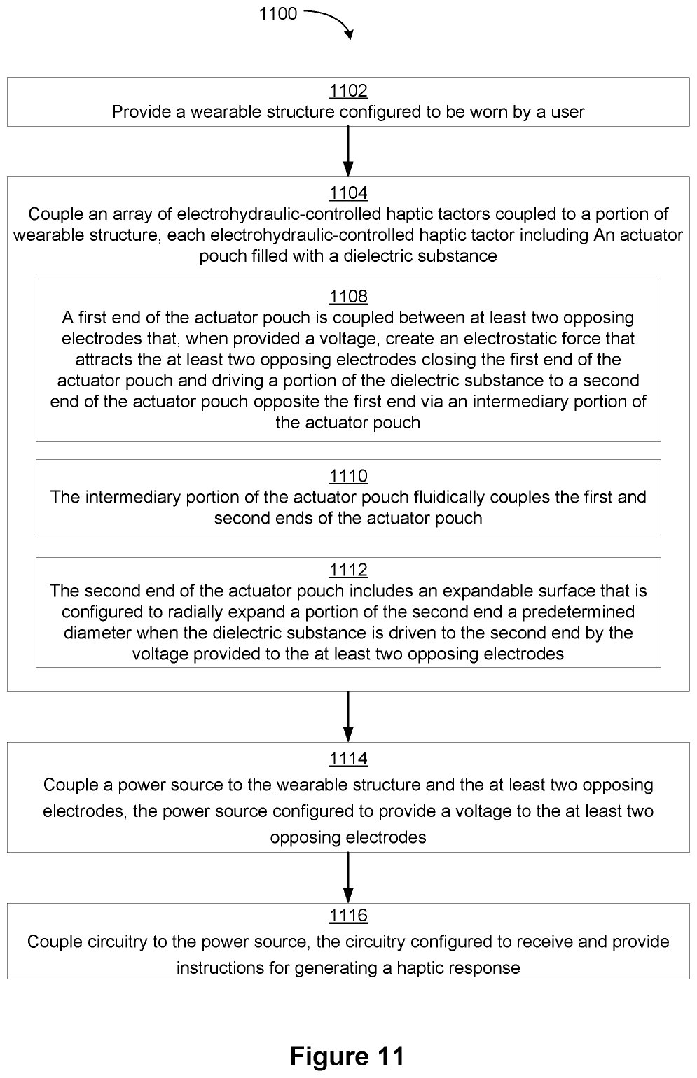

FIG. 11 illustrates a flowchart of a method of manufacturing a wearable device for generating a haptic response, in accordance with some embodiments. The method 1100 of manufacturing the wearable device includes providing (1102) a wearable structure configured to be worn by a user. For example, a wearable structure can be a glove (FIGS. 4A-4F), a wrist-wearable device (e.g., a watch, armband, etc.), a head-wearable device (e.g., a headband, a head-mounted display, etc.), socks, or other garments as described in reference to FIGS. 1A-8 and 12A-17. The method 1100 of manufacturing the wearable device includes coupling (1104) an array of EC haptic tactors 100 (e.g., FIGS. 1A-7) to a portion of wearable structure. Each EC haptic tactor 110 includes an actuator pouch filled 112 with a dielectric substance 130 (e.g., FIGS. 1A-7). A first end 114 of the actuator pouch 112 is (1108) coupled between at least two opposing electrodes 140a and 140b that, when provided a voltage, create an electrostatic force that attracts the at least two opposing electrodes 140a and 140b closing the first end 114 of the actuator pouch 112 and driving a portion of the dielectric substance 130 to a second end 116 of the actuator pouch 112 opposite the first end 114 via an intermediary portion 118 of the actuator pouch 112. The intermediary portion 118 of the actuator pouch 112 fluidically couples (1110) the first and second ends 114 and 116 of the actuator pouch 112. The second end 116 of the actuator pouch 112 includes (1112) an expandable surface that is configured to expand a portion of the second end up to a predetermined vertical distance when the dielectric substance is driven to the second end by the voltage provided to the at least two opposing electrodes. Examples of the array of EC haptic tactors 100 and the EC haptic tactors 110 are provided above in reference to FIGS. 1A-7.

The method 1100 of manufacturing the wearable device includes coupling (1114) a power source (e.g., battery 806; FIG. 8) to the wearable structure and the at least two opposing electrodes 140a and 140b. The power source is configured to provide a voltage to the at least two opposing electrodes. The method 1100 of manufacturing the wearable device further includes coupling (1116) circuitry (e.g., AR system 1200a; FIG. 12A) to the power source. The circuitry is configured to receive and provide instructions for generating a haptic response. In some embodiments, the method 1100 of manufacturing the wearable device includes coupling one or more conductors 180a and 180b to the at least two opposing electrodes. The conductors 180a and 180b are configured to carry a voltage from the power source to the at least two electrodes.

The devices described above are further detailed below, including systems, wrist-wearable devices, headset devices, and smart textile-based garments. Specific operations described above may occur as a result of specific hardware, such hardware is described in further detail below. The devices described below are not limiting and features on these devices can be removed or additional features can be added to these devices. The different devices can include one or more analogous hardware components. For brevity, analogous devices and components are described below. Any differences in the devices and components are described below in their respective sections.

As described herein, a processor (e.g., a central processing unit (CPU), microcontroller unit (MCU), etc.), is an electronic component that is responsible for executing instructions and controlling the operation of an electronic device (e.g., a wrist-wearable device 1300, a head-wearable device, an HIPD 1500, a smart textile-based garment 1600, or other computer system). There are various types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., virtual-reality animations, such as three-dimensional modeling); (iv) a field-programmable gate array (FPGA) that can be programmed and reconfigured after manufacturing, and/or can be customized to perform specific tasks, such as signal processing, cryptography, and machine learning; (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (IoT) devices; (ii) programmable logic controllers (PLCs) which may be configured to be used in industrial automation systems to control and monitor manufacturing processes; (iii) system-on-a-chip (SoC) controllers that integrate multiple components such as processors, memory, I/O interfaces, and other peripherals into a single chip; and/or DSPs. As described herein, a graphics module is a component or software module that is designed to handle graphical operations and/or processes, and can include a hardware module and/or a software module.

As described herein, memory refers to electronic components in a computer or electronic device that store data and instructions for the processor to access and manipulate. The devices described herein can include volatile and non-volatile memory. Examples of memory can include: (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware, and/or boot loaders); (iii) flash memory, magnetic disk storage devices, optical disk storage devices, other non-volatile solid state storage devices, which can be configured to store data in electronic devices (e.g., USB drives, memory cards, and/or solid-state drives (SSDs); and (iv) cache memory configured to temporarily store frequently accessed data and instructions. Memory, as described herein, can include structured data (e.g., SQL databases, MongoDB databases, GraphQL data, JSON data, etc.). Other examples of memory can include: (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or any other types of data described herein.

As described herein, a power system of an electronic device is configured to convert incoming electrical power into a form that can be used to operate the device. A power system can include various components, including: (i) a power source, which can be an alternating current (AC) adapter or a direct current (DC) adapter power supply; (ii) a charger input, and can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and to ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals, and can provide a means for input and output of data and signals. Examples of peripheral interfaces can include: (i) universal serial bus (USB) and/or micro-USB interfaces configured for connecting devices to an electronic device; (ii) Bluetooth interfaces configured to allow devices to communicate with each other, including Bluetooth low energy (BLE); (iii) near field communication (NFC) interfaces configured to be short-range wireless interface for operations such as access control; (iv) POGO pins, which may be small, spring-loaded pins configured to provide a charging interface; (v) wireless charging interfaces; (vi) GPS interfaces; (vii) WiFi interfaces for providing a connection between a device and a wireless network; (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can includer: (i) imaging sensors for collecting imaging data (e.g., including one or more cameras disposed on a respective electronic device); (ii) biopotential-signal sensors; (iii) inertial measurement unit (e.g., IMUs) for detecting, for example, angular rate, force, magnetic field, and/or changes in acceleration; (iv) heart rate sensors for measuring a user's heart rate; (v) SpO2 sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) light sensors (e.g., time-of-flight sensors, infrared light sensors, visible light sensors, etc.), and/or sensor for sensing data from the user or the user's environment. As described herein biopotential-signal-sensing components are devices used to measure electrical activity within the body (e.g., biopotential-signal sensors). Some types of biopotential-signal sensors include: (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) electromyography (EMG) sensors configured to measure the electrical activity of muscles and to diagnose neuromuscular disorders; (iv) electrooculography (EOG) sensors configure to measure the electrical activity of eye muscles to detect eye movement and diagnose eye disorders.

As described herein, an application stored in memory of an electronic device (e.g., software) includes instructions stored in the memory. Examples of such applications include: (i) games; (ii) word processors; (iii) messaging applications; (iv) media-streaming applications; (v) financial applications; (vi) calendars; (vii) clocks; (viii) web-browsers; (ix) social media applications, (x) camera applications, (xi) web-based applications; (xii) health applications; (xiii) artificial reality applications, and/or any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs), protocols like HTTP and TCP/IP, etc.).

As described herein, a graphics module is a component or software module that is designed to handle graphical operations and/or processes, and can include a hardware module and/or a software module.

As described herein, non-transitory computer-readable storage media are physical devices or storage medium that can be used to store electronic data in a non-transitory form (e.g., such that the data is stored permanently until it is intentionally deleted or modified. Example AR Systems 12A-12D-2

FIGS. 12A-12D-2 illustrate example artificial-reality systems, in accordance with some embodiments. FIG. 12A shows a first AR system 1200a and first example user interactions using a wrist-wearable device 1300, a head-wearable device (e.g., AR device 1400), and/or a handheld intermediary processing device (HIPD) 1500. FIG. 12B shows a second AR system 1200b and second example user interactions using a wrist-wearable device 1300, AR device 1400, and/or an HIPD 1500. FIGS. 12C-1 and 12C-2 show a third AR system 1200c and third example user interactions using a wrist-wearable device 1300, a head-wearable device (e.g., VR device 1410), and/or an HIPD 1500. FIGS. 12D1 and 12D2 show a fourth AR system 1200d and fourth example user interactions using a wrist-wearable device 1300, VR device 1410, and/or a smart textile-based garment 1600 (e.g., wearable gloves 410; FIGS. 4A-4F). As the skilled artisan will appreciate upon reading the descriptions provided herein, the above-example AR systems (described in detail below) can perform various functions and/or operations described above with reference to FIGS. 1A-9.

The wrist-wearable device 1300 and one or more of its components are described below in reference to FIGS. 13A-13B; the head-wearable devices and their one or more components are described below in reference to FIGS. 14A-14D; and the HIPD 1500 and its one or more components are described below in reference to FIGS. 15A-15B. The smart textile-based garment 1600 and its one or more components are described below in reference to FIGS. 16A-16C. The wrist-wearable device 1300, the head-wearable devices, and/or the HIPD 1500 can communicatively couple via a network 1225 (e.g., cellular, near field, Wi-Fi, personal area network, wireless LAN, etc.). Additionally, the wrist-wearable device 1300, the head-wearable devices, and/or the HIPD 1500 can also communicatively couple with one or more servers 1230, computers 1240 (e.g., laptops, computers, etc.), mobile devices 1250 (e.g., smartphones, tablets, etc.), and/or other electronic devices via the network 1225 (e.g., cellular, near field, Wi-Fi, personal area network, wireless LAN, etc.) Similarly, the smart textile-based garment 1600, when used, can also communicatively couple with the wrist-wearable device 1300, the head-wearable devices, the HIPD 1500, the one or more servers 1230, the computers 1240, the mobile devices 1250, and/or other electronic devices via the network 1225.

Turning to FIG. 12A, a user 1202 is shown wearing the wrist-wearable device 1300 and the AR device 1400, and having the HIPD 1500 on their desk. The wrist-wearable device 1300, the AR device 1400, and the HIPD 1500 facilitate user interaction with an AR environment. In particular, as shown by the first AR system 1200a, the wrist-wearable device 1300, the AR device 1400, and/or the HIPD 1500 cause presentation of one or more avatars 1204, digital representations of contacts 1206, and virtual objects 1208. As discussed below, the user 1202 can interact with the one or more avatars 1204, digital representations of the contacts 1206, and virtual objects 1208 via the wrist-wearable device 1300, the AR device 1400, and/or the HIPD 1500.

The user 1202 can use any of the wrist-wearable device 1300, the AR device 1400, and/or the HIPD 1500 to provide user inputs. For example, the user 1202 can perform one or more hand gestures that are detected by the wrist-wearable device 1300 (e.g., using one or more EMG sensors and/or IMUs, described below in reference to FIGS. 13A-13B) and/or AR device 1400 (e.g., using one or more image sensor or camera, described below in reference to FIGS. 14A-14B) to provide a user input. Alternatively, or additionally, the user 1202 can provide a user input via one or more touch surfaces of the wrist-wearable device 1300, the AR device 1400, and/or the HIPD 1500, and/or voice commands captured by a microphone of the wrist-wearable device 1300, the AR device 1400, and/or the HIPD 1500. In some embodiments, the wrist-wearable device 1300, the AR device 1400, and/or the HIPD 1500 include a digital assistant to help the user in providing a user input (e.g., completing a sequence of operations, suggesting different operations or commands, providing reminders, confirming a command, etc.). In some embodiments, the user 1202 can provide a user input via one or more facial gestures and/or facial expressions. For example, cameras of the wrist-wearable device 1300, the AR device 1400, and/or the HIPD 1500 can track the user 1202's eyes for navigating a user interface.

The wrist-wearable device 1300, the AR device 1400, and/or the HIPD 1500 can operate alone or in conjunction to allow the user 1202 to interact with the AR environment. In some embodiments, the HIPD 1500 is configured to operate as a central hub or control center for the wrist-wearable device 1300, the AR device 1400, and/or another communicatively coupled device. For example, the user 1202 can provide an input to interact with the AR environment at any of the wrist-wearable device 1300, the AR device 1400, and/or the HIPD 1500, and the HIPD 1500 can identify one or more back-end and front-end tasks to cause the performance of the requested interaction and distribute instructions to cause the performance of the one or more back-end and front-end tasks at the wrist-wearable device 1300, the AR device 1400, and/or the HIPD 1500. In some embodiments, a back-end task is background processing task that is not perceptible by the user (e.g., rendering content, decompression, compression, etc.), and a front-end task is a user-facing task that is perceptible to the user (e.g., presenting information to the user, providing feedback to the user, etc.)). As described below in reference to FIGS. 15A-15B, the HIPD 1500 can perform the back-end tasks and provide the wrist-wearable device 1300 and/or the AR device 1400 operational data corresponding to the performed back-end tasks such that the wrist-wearable device 1300 and/or the AR device 1400 can perform the front-end tasks. In this way, the HIPD 1500, which has more computational resources and greater thermal headroom than the wrist-wearable device 1300 and/or the AR device 1400, performs computationally intensive tasks and reduces the computer resource utilization and/or power usage of the wrist-wearable device 1300 and/or the AR device 1400.

In the example shown by the first AR system 1200a, the HIPD 1500 identifies one or more back-end tasks and front-end tasks associated with a user request to initiate an AR video call with one or more other users (represented by the avatar 1204 and the digital representation of the contact 1206) and distributes instructions to cause the performance of the one or more back-end tasks and front-end tasks. In particular, the HIPD 1500 performs back-end tasks for processing and/or rendering image data (and other data) associated with the AR video call and provides operational data associated with the performed back-end tasks to the AR device 1400 such that the AR device 1400 perform front-end tasks for presenting the AR video call (e.g., presenting the avatar 1204 and the digital representation of the contact 1206).

In some embodiments, the HIPD 1500 can operate as a focal or anchor point for causing the presentation of information. This allows the user 1202 to be generally aware of where information is presented. For example, as shown in the first AR system 1200a, the avatar 1204 and the digital representation of the contact 1206 are presented above the HIPD 1500. In particular, the HIPD 1500 and the AR device 1400 operate in conjunction to determine a location for presenting the avatar 1204 and the digital representation of the contact 1206. In some embodiments, information can be presented a predetermined distance from the HIPD 1500 (e.g., within 5 meters). For example, as shown in the first AR system 1200a, virtual object 1208 is presented on the desk some distance from the HIPD 1500. Similar to the above example, the HIPD 1500 and the AR device 1400 can operate in conjunction to determine a location for presenting the virtual object 1208. Alternatively, in some embodiments, presentation of information is not bound by the HIPD 1500. More specifically, the avatar 1204, the digital representation of the contact 1206, and the virtual object 1208 do not have to be presented within a predetermined distance of the HIPD 1500.

User inputs provided at the wrist-wearable device 1300, the AR device 1400, and/or the HIPD 1500 are coordinated such that the user can use any device to initiate, continue, and/or complete an operation. For example, the user 1202 can provide a user input to the AR device 1400 to cause the AR device 1400 to present the virtual object 1208 and, while the virtual object 1208 is presented by the AR device 1400, the user 1202 can provide one or more hand gestures via the wrist-wearable device 1300 to interact and/or manipulate the virtual object 1208.

FIG. 12B shows the user 1202 wearing the wrist-wearable device 1300 and the AR device 1400, and holding the HIPD 1500. In the second AR system 1200b, the wrist-wearable device 1300, the AR device 1400, and/or the HIPD 1500 are used to receive and/or provide one or more messages to a contact of the user 1202. In particular, the wrist-wearable device 1300, the AR device 1400, and/or the HIPD 1500 detect and coordinate one or more user inputs to initiate a messaging application and prepare a response to a received message via the messaging application.

In some embodiments, the user 1202 initiates, via a user input, an application on the wrist-wearable device 1300, the AR device 1400, and/or the HIPD 1500 that causes the application to initiate on at least one device. For example, in the second AR system 1200b the user 1202 performs a hand gesture associated with a command for initiating a messaging application (represented by messaging user interface 1212); the wrist-wearable device 1300 detects the hand gesture; and, based on a determination that the user 1202 is wearing AR device 1400, causes the AR device 1400 to present a messaging user interface 1212 of the messaging application. The AR device 1400 can present the messaging user interface 1212 to the user 1202 via its display (e.g., as shown by user 1202's field of view 1210). In some embodiments, the application is initiated and ran on the device (e.g., the wrist-wearable device 1300, the AR device 1400, and/or the HIPD 1500) that detects the user input to initiate the application, and the device provides another device operational data to cause the presentation of the messaging application. For example, the wrist-wearable device 1300 can detect the user input to initiate a messaging application; initiate and run the messaging application; and provide operational data to the AR device 1400 and/or the HIPD 1500 to cause presentation of the messaging application. Alternatively, the application can be initiated and ran at a device other than the device that detected the user input. For example, the wrist-wearable device 1300 can detect the hand gesture associated with initiating the messaging application and cause the HIPD 1500 to run the messaging application and coordinate the presentation of the messaging application.

Further, the user 1202 can provide a user input provided at the wrist-wearable device 1300, the AR device 1400, and/or the HIPD 1500 to continue and/or complete an operation initiated are at another device. For example, after initiating the messaging application via the wrist-wearable device 1300 and while the AR device 1400 present the messaging user interface 1212, the user 1202 can provide an input at the HIPD 1500 to prepare a response (e.g., shown by the swipe gesture performed on the HIPD 1500). The user 1202's gestures performed on the HIPD 1500 can be provided and/or displayed on another device. For example, the user 1202's swipe gestured performed on the HIPD 1500 are displayed on a virtual keyboard of the messaging user interface 1212 displayed by the AR device 1400.

In some embodiments, the wrist-wearable device 1300, the AR device 1400, the HIPD 1500, and/or other communicatively couple device can present one or more notifications to the user 1202. The notification can be an indication of a new message, an incoming call, an application update, a status update, etc. The user 1202 can select the notification via the wrist-wearable device 1300, the AR device 1400, the HIPD 1500, and cause presentation of an application or operation associated with the notification on at least one device. For example, the user 1202 can receive a notification that a message was received at the wrist-wearable device 1300, the AR device 1400, the HIPD 1500, and/or other communicatively couple device and provide a user input at the wrist-wearable device 1300, the AR device 1400, and/or the HIPD 1500 to review the notification, and the device detecting the user input can cause an application associated with the notification to be initiated and/or presented at the wrist-wearable device 1300, the AR device 1400, and/or the HIPD 1500.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 1400 can present to the user 1202 game application data and the HIPD 1500 can use a controller to provide inputs to the game. Similarly, the user 1202 can use the wrist-wearable device 1300 to initiate a camera of the AR device 1400, and the user can use the wrist-wearable device 1300, the AR device 1400, and/or the HIPD 1500 to manipulate the image capture (e.g., zoom in or out, apply filters, etc.) and capture image data.

Turning to FIGS. 12C-1 and 12C-2, the user 1202 is shown wearing the wrist-wearable device 1300 and a VR device 1410, and holding the HIPD 1500. In the third AR system 1200c, the wrist-wearable device 1300, the VR device 1410, and/or the HIPD 1500 are used to interact within an AR environment, such as a VR game or other AR application. While the VR device 1410 present a representation of a VR game (e.g., first AR game environment 1220) to the user 1202, the wrist-wearable device 1300, the VR device 1410, and/or the HIPD 1500 detect and coordinate one or more user inputs to allow the user 1202 to interact with the VR game.

In some embodiments, the user 1202 can provide a user input via the wrist-wearable device 1300, the VR device 1410, and/or the HIPD 1500 that causes an action in a corresponding AR environment. For example, the user 1202 in the third AR system 1200c (shown in FIG. 12C-1) raises the HIPD 1500 to prepare for a swing in the first AR game environment 1220. The VR device 1410, responsive to the user 1202 raising the HIPD 1500, causes the AR representation of the user 1222 to perform a similar action (e.g., raise a virtual object, such as a virtual sword 1224). In some embodiments, each device uses respective sensor data and/or image data to detect the user input and provide an accurate representation of the user 1202's motion. For example, image sensors 1558 (e.g., SLAM cameras or other cameras discussed below in FIGS. 15A and 15B) of the HIPD 1500 can be used to detect a position of the 1500 relative to the user 1202's body such that the virtual object can be positioned appropriately within the first AR game environment 1220; sensor data from the wrist-wearable device 1300 can be used to detect a velocity at which the user 1202 raises the HIPD 1500 such that the AR representation of the user 1222 and the virtual sword 1224 are synchronized with the user 1202's movements; and image sensors 1426 (FIGS. 14A-14C) of the VR device 1410 can be used to represent the user 1202's body, boundary conditions, or real-world objects within the first AR game environment 1220.

In FIG. 12C-2, the user 1202 performs a downward swing while holding the HIPD 1500. The user 1202's downward swing is detected by the wrist-wearable device 1300, the VR device 1410, and/or the HIPD 1500 and a corresponding action is performed in the first AR game environment 1220. In some embodiments, the data captured by each device is used to improve the user's experience within the AR environment. For example, sensor data of the wrist-wearable device 1300 can be used to determine a speed and/or force at which the downward swing is performed and image sensors of the HIPD 1500 and/or the VR device 1410 can be used to determine a location of the swing and how it should be represented in the first AR game environment 1220, which, in turn, can be used as inputs for the AR environment (e.g., game mechanics, which can use detected speed, force, locations, and/or aspects of the user 1202's actions to classify a user's inputs (e.g., user performs a light strike, hard strike, critical strike, glancing strike, miss, etc.) or calculate an output (e.g., amount of damage)).

While the wrist-wearable device 1300, the VR device 1410, and/or the HIPD 1500 are described as detecting user inputs, in some embodiments, user inputs are detected at a single device (with the single device being responsible for distributing signals to the other devices for performing the user input). For example, the HIPD 1500 can operate an application for generating the first AR game environment 1220 and provide the VR device 1410 with corresponding data for causing the presentation of the first AR game environment 1220, as well as detect the 1202's movements (while holding the HIPD 1500) to cause the performance of corresponding actions within the first AR game environment 1220. Additionally or alternatively, in some embodiments, operational data (e.g., sensor data, image data, application data, device data, and/or other data) of one or more devices is provide to a single device (e.g., the HIPD 1500) to process the operational data and cause respective devices to perform an action associated with processed operational data.

FIGS. 12D-1 and 12D-2, the user 1202 is shown wearing the wrist-wearable device 1300, the VR device 1410, smart textile-based garments 1600. In the fourth AR system 1200d, the wrist-wearable device 1300, the VR device 1410, and/or the smart textile-based garments 1600 (e.g., analogous with the wearable device described above in reference to FIGS. 1A-11) are used to interact within an AR environment (e.g., any AR system described above in reference to FIGS. 12A-12C-2 and 4A-4F.) While the VR device 1410 present a representation of a VR game (e.g., second AR game environment 1233) to the user 1202, the wrist-wearable device 1300, the VR device 1410, and/or the smart textile-based garments 1600 detect and coordinate one or more user inputs to allow the user 1202 to interact with the AR environment.

In some embodiments, the user 1202 can provide a user input via the wrist-wearable device 1300, the VR device 1410, and/or the smart textile-based garments 1600 that causes an action in a corresponding AR environment. For example, the user 1202 in the fourth AR system 1200d (shown in FIG. 12D-1) raises a hand wearing the smart textile-based garments 1600 to prepare for cast spell or throw an object within the second AR game environment 1233. The VR device 1410, responsive to the user 1202 holding up their hand (wearing a smart textile-based garments 1600), causes the AR representation of the user 1222 to perform a similar action (e.g., hold a virtual object, such as a casting a fireball 1234). In some embodiments, each device uses respective sensor data and/or image data to detect the user input and provide an accurate representation of the user 1202's motion.

In FIG. 12D-2, the user 1202 performs a throwing motion while wearing the smart textile-based garment 1600. The user 1202's throwing motion is detected by the wrist-wearable device 1300, the VR device 1410, and/or the smart textile-based garments 1600 and a corresponding action is performed in the second AR game environment 1233. As described above, the data captured by each device is used to improve the user's experience within the AR environment. Although not shown, the smart textile-based garments 1600 can be used in conjunction with an AR device 1410 and/or an HIPD 1500.

Having discussed example AR systems, devices for interacting with such AR systems, and other computing systems more generally, will now be discussed in greater detail below. Some definitions of devices and components that can be included in some or all of the example devices discussed below are defined here for ease of reference. A skilled artisan will appreciate that certain types of the components described below may be more suitable for a particular set of devices, and less suitable for a different set of devices. But subsequent reference to the components defined here should be considered to be encompassed by the definitions provided.

In some embodiments discussed below example devices and systems, including electronic devices and systems, will be discussed. Such example devices and systems are not intended to be limiting, and one of skill in the art will understand that alternative devices and systems to the example devices and systems described herein may be used to perform the operations and construct the systems and device that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

### Example Wrist-Wearable Devices

FIGS. 13A and 13B illustrate an example wrist-wearable device 1300, in accordance with some embodiments. The wrist-wearable device 1300 is an instance of the wearable device 365 described in reference to FIG. 3C herein, such that the wrist-wearable devices should be understood to have the features of the wrist-wearable device 1300 and vice versa. FIG. 13A illustrates components of the wrist-wearable device 1300, which can be used individually or in combination, including combinations that include other electronic devices and/or electronic components.

FIG. 13A shows a wearable band 1310 and a watch body 1320 (or capsule) being coupled, as discussed below, to form the wrist-wearable device 1300. The wrist-wearable device 1300 can perform various functions and/or operations associated with navigating through user interfaces and selectively opening applications, as well as the functions and/or operations described above with reference to FIG. 3C.

As will be described in more detail below, operations executed by the wrist-wearable device 1300 can include: (i) presenting content to a user (e.g., displaying visual content via a display 1305); (ii) detecting (e.g., sensing) user input (e.g., sensing a touch on peripheral button 1323 and/or at a touch screen of the display 1305, a hand gesture detected by sensors (e.g., biopotential sensors)); (iii) sensing biometric data via one or more sensors 1313 (e.g., neuromuscular signals, heart rate, temperature, sleep, etc.); messaging (e.g., text, speech, video, etc.); image capture via one or more imaging devices or cameras 1325; wireless communications (e.g., cellular, near field, Wi-Fi, personal area network, etc.); location determination; financial transactions; providing haptic feedback; alarms; notifications; biometric authentication; health monitoring; sleep monitoring; etc.

The above-example functions can be executed independently in the watch body 1320, independently in the wearable band 1310, and/or via an electronic communication between the watch body 1320 and the wearable band 1310. In some embodiments, functions can be executed on the wrist-wearable device 1300 while an AR environment is being presented (e.g., via one of the AR systems 1200a to 1200d). As the skilled artisan will appreciate upon reading the descriptions provided herein, the novel wearable devices described herein can be used with other types of AR environments.

The wearable band 1310 can be configured to be worn by a user such that an inner (or inside) surface of the wearable structure 1311 of the wearable band 1310 is in contact with the user's skin. When worn by a user, sensors 1313 contact the user's skin. The sensors 1313 can sense biometric data such as a user's heart rate, saturated oxygen level, temperature, sweat level, neuromuscular signal sensors, or a combination thereof. The sensors 1313 can also sense data about a user's environment including a user's motion, altitude, location, orientation, gait, acceleration, position, or a combination thereof. In some embodiment, the sensors 1313 are configured to track a position and/or motion of the wearable band 1310. The one or more sensors 1313 can include any of the sensors defined above and/or discussed below with respect to FIG. 13B.

The one or more sensors 1313 can be distributed on an inside and/or an outside surface of the wearable band 1310. In some embodiments, the one or more sensors 1313 are uniformly spaced along the wearable band 1310. Alternatively, in some embodiments, the one or more sensors 1313 are positioned at distinct points along the wearable band 1310. As shown in FIG. 13A, the one or more sensors 1313 can be the same or distinct. For example, in some embodiments, the one or more sensors 1313 can be shaped as a pill (e.g., sensor 1313a), an oval, a circle a square, an oblong (e.g., sensor 1313c) and/or any other shape that maintains contact with the user's skin (e.g., such that neuromuscular signal and/or other biometric data can be accurately measured at the user's skin). In some embodiments, the one or more sensors 1313 are aligned to form pairs of sensors (e.g., for sensing neuromuscular signals based on differential sensing within each respective sensor). For example, sensor 1313b is aligned with an adjacent sensor to form sensor pair 1314a and sensor 1313d aligned with an adjacent sensor to form sensor pair 1314b. In some embodiments, the wearable band 1310 does not have a sensor pair. Alternatively, in some embodiments, the wearable band 1310 has a predetermined number of sensor pairs (one pair of sensors, three pairs of sensors, four pairs of sensors, six pairs of sensors, sixteen pairs of sensors, etc.).

The wearable band 1310 can include any suitable number of sensors 1313. In some embodiments, the number and arrangement of sensors 1313 depends on the particular application for which the wearable band 1310 is used. For instance, a wearable band 1310 configured as an armband, wristband, or chest-band may include a plurality of sensors 1313 with different number of sensors 1313 and different arrangement for each use case, such as medical use cases as compared to gaming or general day-to-day use cases.

In accordance with some embodiments, the wearable band 1310 further includes an electrical ground electrode and a shielding electrode. The electrical ground and shielding electrodes, like the sensors 1313, can be distributed on the inside surface of the wearable band 1310 such that they contact a portion of the user's skin. For example, the electrical ground and shielding electrodes can be at an inside surface of coupling mechanism 1316 or an inside surface of a wearable structure 1311. The electrical ground and shielding electrodes can be formed and/or use the same components as the sensors 1313. In some embodiments, the wearable band 1310 includes more than one electrical ground electrode and more than one shielding electrode.

The sensors 1313 can be formed as part of the wearable structure 1311 of the wearable band 1310. In some embodiments, the sensors 1313 are flush or substantially flush with the wearable structure 1311 such that they do not extend beyond the surface of the wearable structure 1311. While flush with the wearable structure 1311, the sensors 1313 are still configured to contact the user's skin (e.g., via a skin-contacting surface). Alternatively, in some embodiments, the sensors 1313 extend beyond the wearable structure 1311 a predetermined distance (e.g., 0.1-2 mm) to make contact and depress into the user's skin. In some embodiment, the sensors 1313 are coupled to an actuator (not shown) configured to adjust an extension height (e.g., a distance from the surface of the wearable structure 1311) of the sensors 1313 such that the sensors 1313 make contact and depress into the user's skin. In some embodiments, the actuators adjust the extension height between 0.01 mm-1.2 mm. This allows the user to customize the positioning of the sensors 1313 to improve the overall comfort of the wearable band 1310 when worn while still allowing the sensors 1313 to contact the user's skin. In some embodiments, the sensors 1313 are indistinguishable from the wearable structure 1311 when worn by the user.

The wearable structure 1311 can be formed of an elastic material, elastomers, etc. configured to be stretched and fitted to be worn by the user. In some embodiments, the wearable structure 1311 is a textile or woven fabric. As described above, the sensors 1313 can be formed as part of a wearable structure 1311. For example, the sensors 1313 can be molded into the wearable structure 1311 or be integrated into a woven fabric (e.g., the sensors 1313 can be sewn into the fabric and mimic the pliability of fabric (e.g., the sensors 1313 can be constructed from a series woven strands of fabric)).

The wearable structure 1311 can include flexible electronic connectors that interconnect the sensors 1313, the electronic circuitry, and/or other electronic components (described below in reference to FIG. 13B) that are enclosed in the wearable band 1310. In some embodiments, the flexible electronic connectors are configured to interconnect the sensors 1313, the electronic circuitry, and/or other electronic components of the wearable band 1310 with respective sensors and/or other electronic components of another electronic device (e.g., watch body 1320). The flexible electronic connectors are configured to move with the wearable structure 1311 such that the user adjustment to the wearable structure 1311 (e.g., resizing, pulling, folding, etc.) does not stress or strain the electrical coupling of components of the wearable band 1310.

As described above, the wearable band 1310 is configured to be worn by a user. In particular, the wearable band 1310 can be shaped or otherwise manipulated to be worn by a user. For example, the wearable band 1310 can be shaped to have a substantially circular shape such that it can be configured to be worn on the user's lower arm or wrist. Alternatively, the wearable band 1310 can be shaped to be worn on another body part of the user, such as the user's upper arm (e.g., around a bicep), forearm, chest, legs, etc. The wearable band 1310 can include a retaining mechanism 1312 (e.g., a buckle, a hook and loop fastener, etc.) for securing the wearable band 1310 to the user's wrist or other body part. While the wearable band 1310 is worn by the user, the sensors 1313 sense data (referred to as sensor data) from the user's skin. In particular, the sensors 1313 of the wearable band 1310 obtain (e.g., sense and record) neuromuscular signals.

The sensed data (e.g., sensed neuromuscular signals) can be used to detect and/or determine the user's intention to perform certain motor actions. In particular, the sensors 1313 sense and record neuromuscular signals from the user as the user performs muscular activations (e.g., movements, gestures, etc.). The detected and/or determined motor actions (e.g., phalange (or digits) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on the display 1305 of the wrist-wearable device 1300 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table; dynamic gestures, such as grasping a physical or virtual object; and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by the sensors 1313 can be used to provide a user with an enhanced interaction with a physical object (e.g., devices communicatively coupled with the wearable band 1310) and/or a virtual object in an artificial-reality application generated by an artificial-reality system (e.g., user interface objects presented on the display 1305, or another computing device (e.g., a smartphone)).

In some embodiments, the wearable band 1310 includes one or more haptic devices 1346 (FIG. 13B; e.g., a vibratory haptic actuator) that are configured to provide haptic feedback (e.g., a cutaneous and/or kinesthetic sensation, etc.) to the user's skin. The sensors 1313, and/or the haptic devices 1346 can be configured to operate in conjunction with multiple applications including, without limitation, health monitoring, social media, games, and artificial reality (e.g., the applications associated with artificial reality).

The wearable band 1310 can also include coupling mechanism 1316 (e.g., a cradle or a shape of the coupling mechanism can correspond to shape of the watch body 1320 of the wrist-wearable device 1300) for detachably coupling a capsule (e.g., a computing unit) or watch body 1320 (via a coupling surface of the watch body 1320) to the wearable band 1310. In particular, the coupling mechanism 1316 can be configured to receive a coupling surface proximate to the bottom side of the watch body 1320 (e.g., a side opposite to a front side of the watch body 1320 where the display 1305 is located), such that a user can push the watch body 1320 downward into the coupling mechanism 1316 to attach the watch body 1320 to the coupling mechanism 1316. In some embodiments, the coupling mechanism 1316 can be configured to receive a top side of the watch body 1320 (e.g., a side proximate to the front side of the watch body 1320 where the display 1305 is located) that is pushed upward into the cradle, as opposed to being pushed downward into the coupling mechanism 1316. In some embodiments, the coupling mechanism 1316 is an integrated component of the wearable band 1310 such that the wearable band 1310 and the coupling mechanism 1316 are a single unitary structure. In some embodiments, the coupling mechanism 1316 is a type of frame or shell that allows the watch body 1320 coupling surface to be retained within or on the wearable band 1310 coupling mechanism 1316 (e.g., a cradle, a tracker band, a support base, a clasp, etc.).

The coupling mechanism 1316 can allow for the watch body 1320 to be detachably coupled to the wearable band 1310 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 1320 to the wearable band 1310 and to decouple the watch body 1320 from the wearable band 1310. For example, a user can twist, slide, turn, push, pull, or rotate the watch body 1320 relative to the wearable band 1310, or a combination thereof, to attach the watch body 1320 to the wearable band 1310 and to detach the watch body 1320 from the wearable band 1310. Alternatively, as discussed below, in some embodiments, the watch body 1320 can be decoupled from the wearable band 1310 by actuation of the release mechanism 1329.

The wearable band 1310 can be coupled with a watch body 1320 to increase the functionality of the wearable band 1310 (e.g., converting the wearable band 1310 into a wrist-wearable device 1300, adding an additional computing unit and/or battery to increase computational resources and/or a battery life of the wearable band 1310, adding additional sensors to improve sensed data, etc.). As described above, the wearable band 1310 (and the coupling mechanism 1316) is configured to operate independently (e.g., execute functions independently) from watch body 1320. For example, the coupling mechanism 1316 can include one or more sensors 1313 that contact a user's skin when the wearable band 1310 is worn by the user and provide sensor data for determining control commands.

A user can detach the watch body 1320 (or capsule) from the wearable band 1310 in order to reduce the encumbrance of the wrist-wearable device 1300 to the user. For embodiments in which the watch body 1320 is removable, the watch body 1320 can be referred to as a removable structure, such that in these embodiments the wrist-wearable device 1300 includes a wearable portion (e.g., the wearable band 1310) and a removable structure (the watch body 1320).

Turning to the watch body 1320, the watch body 1320 can have a substantially rectangular or circular shape. The watch body 1320 is configured to be worn by the user on their wrist or on another body part. More specifically, the watch body 1320 is sized to be easily carried by the user, attached on a portion of the user's clothing, and/or coupled to the wearable band 1310 (forming the wrist-wearable device 1300). As described above, the watch body 1320 can have a shape corresponding to the coupling mechanism 1316 of the wearable band 1310. In some embodiments, the watch body 1320 includes a single release mechanism 1329 or multiple release mechanisms (e.g., two release mechanisms 1329 positioned on opposing sides of the watch body 1320, such as spring-loaded buttons) for decoupling the watch body 1320 and the wearable band 1310. The release mechanism 1329 can include, without limitation, a button, a knob, a plunger, a handle, a lever, a fastener, a clasp, a dial, a latch, or a combination thereof.

A user can actuate the release mechanism 1329 by pushing, turning, lifting, depressing, shifting, or performing other actions on the release mechanism 1329. Actuation of the release mechanism 1329 can release (e.g., decouple) the watch body 1320 from the coupling mechanism 1316 of the wearable band 1310, allowing the user to use the watch body 1320 independently from wearable band 1310, and vice versa. For example, decoupling the watch body 1320 from the wearable band 1310 can allow the user to capture images using rear-facing camera 1325B. Although the is shown positioned at a corner of watch body 1320, the release mechanism 1329 can be positioned anywhere on watch body 1320 that is convenient for the user to actuate. In addition, in some embodiments, the wearable band 1310 can also include a respective release mechanism for decoupling the watch body 1320 from the coupling mechanism 1316. In some embodiments, the release mechanism 1329 is optional and the watch body 1320 can be decoupled from the coupling mechanism 1316 as described above (e.g., via twisting, rotating, etc.).

The watch body 1320 can include one or more peripheral buttons 1323 and 1327 for performing various operations at the watch body 1320. For example, the peripheral buttons 1323 and 1327 can be used to turn on or wake (e.g., transition from a sleep state to an active state) the display 1305, unlock the watch body 1320, increase or decrease a volume, increase or decrease a brightness, interact with one or more applications, interact with one or more user interfaces, etc. Additionally, or alternatively, in some embodiments, the display 1305 operates as a touch screen and allows the user to provide one or more inputs for interacting with the watch body 1320.

In some embodiments, the watch body 1320 includes one or more sensors 1321. The sensors 1321 of the watch body 1320 can be the same or distinct from the sensors 1313 of the wearable band 1310. The sensors 1321 of the watch body 1320 can be distributed on an inside and/or an outside surface of the watch body 1320. In some embodiments, the sensors 1321 are configured to contact a user's skin when the watch body 1320 is worn by the user. For example, the sensors 1321 can be placed on the bottom side of the watch body 1320 and the coupling mechanism 1316 can be a cradle with an opening that allows the bottom side of the watch body 1320 to directly contact the user's skin. Alternatively, in some embodiments, the watch body 1320 does not include sensors that are configured to contact the user's skin (e.g., including sensors internal and/or external to the watch body 1320 that configured to sense data of the watch body 1320 and the watch body 1320's surrounding environment). In some embodiment, the sensors 1313 are configured to track a position and/or motion of the watch body 1320.

The watch body 1320 and the wearable band 1310 can share data using a wired communication method (e.g., a Universal Asynchronous Receiver/Transmitter (UART), a USB transceiver, etc.) and/or a wireless communication method (e.g., near field communication, Bluetooth, etc.). For example, the watch body 1320 and the wearable band 1310 can share data sensed by the sensors 1313 and 1321, as well as application and device specific information (e.g., active and/or available applications, output devices (e.g., display, speakers, etc.), input devices (e.g., touch screen, microphone, imaging sensors, etc.).

In some embodiments, the watch body 1320 can include, without limitation, a front-facing camera 1325A and/or a rear-facing camera 1325B, sensors 1321 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 1363; FIG. 13B), a touch sensor, a sweat sensor, etc.). In some embodiments, the watch body 1320 can include one or more haptic devices 1376 (FIG. 13B; a vibratory haptic actuator) that is configured to provide haptic feedback (e.g., a cutaneous and/or kinesthetic sensation, etc.) to the user. The sensors 1321 and/or the haptic device 1376 can also be configured to operate in conjunction with multiple applications including, without limitation, health monitoring applications, social media applications, game applications, and artificial reality applications (e.g., the applications associated with artificial reality).

As described above, the watch body 1320 and the wearable band 1310, when coupled, can form the wrist-wearable device 1300. When coupled, the watch body 1320 and wearable band 1310 operate as a single device to execute functions (operations, detections, communications, etc.) described herein. In some embodiments, each device is provided with particular instructions for performing the one or more operations of the wrist-wearable device 1300. For example, in accordance with a determination that the watch body 1320 does not include neuromuscular signal sensors, the wearable band 1310 can include alternative instructions for performing associated instructions (e.g., providing sensed neuromuscular signal data to the watch body 1320 via a different electronic device). Operations of the wrist-wearable device 1300 can be performed by the watch body 1320 alone or in conjunction with the wearable band 1310 (e.g., via respective processors and/or hardware components) and vice versa. In some embodiments, operations of the wrist-wearable device 1300, the watch body 1320, and/or the wearable band 1310 can be performed in conjunction with one or more processors and/or hardware components of another communicatively coupled device (e.g., the HIPD 1500; FIGS. 15A-15B).

As described below with reference to the block diagram of FIG. 13B, the wearable band 1310 and/or the watch body 1320 can each include independent resources required to independently execute functions. For example, the wearable band 1310 and/or the watch body 1320 can each include a power source (e.g., a battery), a memory, data storage, a processor (e.g., a central processing unit (CPU)), communications, a light source, and/or input/output devices.

FIG. 13B shows block diagrams of a computing system 1330 corresponding to the wearable band 1310, and a computing system 1360 corresponding to the watch body 1320, according to some embodiments. A computing system of the wrist-wearable device 1300 includes a combination of components of the wearable band computing system 1330 and the watch body computing system 1360, in accordance with some embodiments.

The watch body 1320 and/or the wearable band 1310 can include one or more components shown in watch body computing system 1360. In some embodiments, a single integrated circuit includes all or a substantial portion of the components of the watch body computing system 1360 are included in a single integrated circuit. Alternatively, in some embodiments, components of the watch body computing system 1360 are included in a plurality of integrated circuits that are communicatively coupled. In some embodiments, the watch body computing system 1360 is configured to couple (e.g., via a wired or wireless connection) with the wearable band computing system 1330, which allows the computing systems to share components, distribute tasks, and/or perform other operations described herein (individually or as a single device).

The watch body computing system 1360 can include one or more processors 1379, a controller 1377, a peripherals interface 1361, a power system 1395, and memory (e.g., a memory 1380), each of which are defined above and described in more detail below.

The power system 1395 can include a charger input 1396, a power-management integrated circuit (PMIC) 1397, and a battery 1398, each are which are defined above. In some embodiments, a watch body 1320 and a wearable band 1310 can have respective charger inputs (e.g., charger input 1396 and 1357), respective batteries (e.g., battery 1398 and 1359), and can share power with each other (e.g., the watch body 1320 can power and/or charge the wearable band 1310, and vice versa). Although watch body 1320 and/or the wearable band 1310 can include respective charger inputs, a single charger input can charge both devices when coupled. The watch body 1320 and the wearable band 1310 can receive a charge using a variety of techniques. In some embodiments, the watch body 1320 and the wearable band 1310 can use a wired charging assembly (e.g., power cords) to receive the charge. Alternatively, or in addition, the watch body 1320 and/or the wearable band 1310 can be configured for wireless charging. For example, a portable charging device can be designed to mate with a portion of watch body 1320 and/or wearable band 1310 and wirelessly deliver usable power to a battery of watch body 1320 and/or wearable band 1310. The watch body 1320 and the wearable band 1310 can have independent power systems (e.g., power system 1395 and 1356) to enable each to operate independently. The watch body 1320 and wearable band 1310 can also share power (e.g., one can charge the other) via respective PMICs (e.g., PMICs 1397 and 1358) that can share power over power and ground conductors and/or over wireless charging antennas.

In some embodiments, the peripherals interface 1361 can include one or more sensors 1321, many of which listed below are defined above. The sensors 1321 can include one or more coupling sensor 1362 for detecting when the watch body 1320 is coupled with another electronic device (e.g., a wearable band 1310). The sensors 1321 can include imaging sensors 1363 (one or more of the cameras 1325, and/or separate imaging sensors 1363 (e.g., thermal-imaging sensors)). In some embodiments, the sensors 1321 include one or more SpO2 sensors 1364. In some embodiments, the sensors 1321 include one or more biopotential-signal sensors (e.g., EMG sensors 1365, which may be disposed on a user-facing portion of the watch body 1320 and/or the wearable band 1310). In some embodiments, the sensors 1321 include one or more capacitive sensors 1366. In some embodiments, the sensors 1321 include one or more heart rate sensors 1367. In some embodiments, the sensors 1321 include one or more IMU sensors 1368. In some embodiments, one or more IMU sensors 1368 can be configured to detect movement of a user's hand or other location that the watch body 1320 is placed or held).

In some embodiments, the peripherals interface 1361 includes a near-field communication (NFC) component 1369, a global-position system (GPS) component 1370, a long-term evolution (LTE) component 1371, and/or a Wi-Fi and/or Bluetooth communication component 1372. In some embodiments, the peripherals interface 1361 includes one or more buttons 1373 (e.g., the peripheral buttons 1323 and 1327 in FIG. 13A), which, when selected by a user, cause operation to be performed at the watch body 1320. In some embodiments, the peripherals interface 1361 includes one or more indicators, such as a light emitting diode (LED), to provide a user with visual indicators (e.g., message received, low battery, active microphone and/or camera, etc.).

The watch body 1320 can include at least one display 1305, for displaying visual representations of information or data to the user, including user-interface elements and/or three-dimensional virtual objects. The display can also include a touch screen for inputting user inputs, such as touch gestures, swipe gestures, and the like. The watch body 1320 can include at least one speaker 1374 and at least one microphone 1375 for providing audio signals to the user and receiving audio input from the user. The user can provide user inputs through the microphone 1375 and can also receive audio output from the speaker 1374 as part of a haptic event provided by the haptic controller 1378. The watch body 1320 can include at least one camera 1325, including a front-facing camera 1325A and a rear-facing camera 1325B. The cameras 1325 can include ultra-wide-angle cameras, wide angle cameras, fish-eye cameras, spherical cameras, telephoto cameras, a depth-sensing cameras, or other types of cameras.

The watch body computing system 1360 can include one or more haptic controllers 1378 and associated componentry (e.g., haptic devices 1376) for providing haptic events at the watch body 1320 (e.g., a vibrating sensation or audio output in response to an event at the watch body 1320). The haptic controllers 1378 can communicate with one or more haptic devices 1376, such as electroacoustic devices, including a speaker of the one or more speakers 1374 and/or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). The haptic controller 1378 can provide haptic events to that are capable of being sensed by a user of the watch body 1320. In some embodiments, the one or more haptic controllers 1378 can receive input signals from an application of the applications 1382.

In some embodiments, the computer system 1330 and/or the computer system 1360 can include memory 1380, which can be controlled by a memory controller of the one or more controllers 1377 and/or one or more processors 1379. In some embodiments, software components stored in the memory 1380 include one or more applications 1382 configured to perform operations at the watch body 1320. In some embodiments, the one or more applications 1382 include games, word processors, messaging applications, calling applications, web browsers, social media applications, media streaming applications, financial applications, calendars, clocks, etc. In some embodiments, software components stored in the memory 1380 include one or more communication interface modules 1383 as defined above. In some embodiments, software components stored in the memory 1380 include one or more graphics modules 1384 for rendering, encoding, and/or decoding audio and/or visual data; and one or more data management modules 1385 for collecting, organizing, and/or providing access to the data 1387 stored in memory 1380. In some embodiments, software components stored in the memory 1380 include one or more haptics modules 1386A for determining, generating, and provided instructions for causing the performance of a haptic response, such as the haptic responses described above in reference to FIGS. 1A-9. The haptics modules 1386A is analogous to the haptics modules 1687 (FIG. 16C) such that features of the haptics modules 1687 described below are included in the haptics modules 1386A. In some embodiments, one or more of applications 1382 and/or one or more modules can work in conjunction with one another to perform various operations and tasks at the watch body 1320.

In some embodiments, software components stored in the memory 1380 can include one or more operating systems 1381 (e.g., a Linux-based operating system, an Android operating system, etc.). The memory 1380 can also include data 1387. The data 1387 can include profile data 1388A, sensor data 1389A, media content data 1390, application data 1391, and haptics data 1392A, which stores data related to the performance of the features described above in reference to FIGS. 1A-9. The haptics data 1392A is analogous to the haptics data 1694 (FIG. 16C) such that features of the haptics data 1694 described below are included in the haptics data 1392A.

It should be appreciated that the watch body computing system 1360 is an example of a computing system within the watch body 1320, and that the watch body 1320 can have more or fewer components than shown in the watch body computing system 1360, combine two or more components, and/or have a different configuration and/or arrangement of the components. The various components shown in watch body computing system 1360 are implemented in hardware, software, firmware, or a combination thereof, including one or more signal processing and/or application-specific integrated circuits.

Turning to the wearable band computing system 1330, one or more components that can be included in the wearable band 1310 are shown. The wearable band computing system 1330 can include more or fewer components than shown in the watch body computing system 1360, combine two or more components, and/or have a different configuration and/or arrangement of some or all of the components. In some embodiments, all, or a substantial portion of the components of the wearable band computing system 1330 are included in a single integrated circuit. Alternatively, in some embodiments, components of the wearable band computing system 1330 are included in a plurality of integrated circuits that are communicatively coupled. As described above, in some embodiments, the wearable band computing system 1330 is configured to couple (e.g., via a wired or wireless connection) with the watch body computing system 1360, which allows the computing systems to share components, distribute tasks, and/or perform other operations described herein (individually or as a single device).

The wearable band computing system 1330, similar to the watch body computing system 1360, can include one or more processors 1349, one or more controllers 1347 (including one or more haptics controller 1348), a peripherals interface 1331 that can includes one or more sensors 1313 and other peripheral devices, power source (e.g., a power system 1356), and memory (e.g., a memory 1350) that includes an operating system (e.g., an operating system 1351), data (e.g., data 1354 including profile data 1388B, sensor data 1389B, haptics data 1392B, etc.), and one or more modules (e.g., a communications interface module 1352, a data management module 1353, a haptics modules 1386B, etc.).

The one or more sensors 1313 can be analogous to sensors 1321 of the computer system 1360 and in light of the definitions above. For example, sensors 1313 can include one or more coupling sensors 1332, one or more SpO2 sensor 1334, one or more EMG sensors 1335, one or more capacitive sensor 1336, one or more heart rate sensor 1337, and one or more IMU sensor 1338.

The peripherals interface 1331 can also include other components analogous to those included in the peripheral interface 1361 of the computer system 1360, including an NFC component 1339, a GPS component 1340, an LTE component 1341, a Wi-Fi and/or Bluetooth communication component 1342, and/or one or more haptic devices 1376 as described above in reference to peripherals interface 1361. In some embodiments, the peripherals interface 1331 includes one or more buttons 1343, a display 1333, a speaker 1344, a microphone 1345, and a camera 1355. In some embodiments, the peripherals interface 1331 includes one or more indicators, such as an LED.

It should be appreciated that the wearable band computing system 1330 is an example of a computing system within the wearable band 1310, and that the wearable band 1310 can have more or fewer components than shown in the wearable band computing system 1330, combine two or more components, and/or have a different configuration and/or arrangement of the components. The various components shown in wearable band computing system 1330 can be implemented in one or a combination of hardware, software, firmware, including one or more signal processing and/or application-specific integrated circuits.

The wrist-wearable device 1300 with respect to FIG. 13A is an example of the wearable band 1310 and the watch body 1320 coupled, so the wrist-wearable device 1300 will be understood to include the components shown and described for the wearable band computing system 1330 and the watch body computing system 1360. In some embodiments, wrist-wearable device 1300 has a split architecture (e.g., a split mechanical architecture, a split electrical architecture) between the watch body 1320 and the wearable band 1310. In other words, all of the components shown in the wearable band computing system 1330 and the watch body computing system 1360 can be housed or otherwise disposed in a combined watch device 1300, or within individual components of the watch body 1320, wearable band 1310, and/or portions thereof (e.g., a coupling mechanism 1316 of the wearable band 1310).

The techniques described above can be used with any device for sensing neuromuscular signals, including the arm-wearable devices of FIG. 13A-13B, but could also be used with other types of wearable devices for sensing neuromuscular signals (such as body-wearable or head-wearable devices that might have neuromuscular sensors closer to the brain or spinal column).

In some embodiments, a wrist-wearable device 1300 can be used in conjunction with a head-wearable device described below (e.g., AR device 1400 and VR device 1410) and/or an HIPD 1500; and the wrist-wearable device 1300 can also be configured to be used to allow a user to control aspect of the artificial reality (e.g., by using EMG-based gestures to control user interface objects in the artificial reality and/or by allowing a user to interact with the touchscreen on the wrist-wearable device to also control aspects of the artificial reality). In some embodiments, a wrist-wearable device 1300 can also be used in conjunction with a wearable garment, such as smart textile-based garment 1600 described below in reference to FIGS. 16A-16C. Having thus described example wrist-wearable device, attention will now be turned to example head-wearable devices, such AR device 1400 and VR device 1410.

### Example Head-Wearable Devices

FIGS. 14A-14C show example head-wearable devices, in accordance with some embodiments. Head-wearable devices can include, but are not limited to, AR devices 1410 (e.g., AR or smart eyewear devices, such as smart glasses, smart monocles, smart contacts, etc.), VR devices 1410 (e.g., VR headsets, head-mounted displays (HMD)s, etc.), or other ocularly coupled devices. The AR devices 1400 and the VR devices 1410 are instances of the head-wearable devices as illustrated in and described in reference to FIGS. 4A-4F herein, such that the head-wearable device should be understood to have the features of the AR devices 1400 and/or the VR devices 1410, and vice versa. The AR devices 1400 and the VR devices 1410 can perform various functions and/or operations associated with navigating through user interfaces and selectively opening applications, as well as the functions and/or operations described above with reference to FIGS. 4A-4F.

In some embodiments, an AR system (e.g., AR systems 1200a-1200d; FIGS. 12A-12D-2) includes an AR device 1400 (as shown in FIG. 14A) and/or VR device 1410 (as shown in FIGS. 14B-1-B-2). In some embodiments, the AR device 1400 and the VR device 1410 can include one or more analogous components (e.g., components for presenting interactive artificial-reality environments, such as processors, memory, and/or presentation devices, including one or more displays and/or one or more waveguides), some of which are described in more detail with respect to FIG. 14C. The head-wearable devices can use display projectors (e.g., display projector assemblies 1407A and 1407B) and/or waveguides for projecting representations of data to a user. Some embodiments of head-wearable devices do not include displays.

FIG. 14A shows an example visual depiction of the AR device 1400 (e.g., which may also be described herein as augmented-reality glasses, and/or smart glasses). The AR device 1400 can work in conjunction with additional electronic components that are not shown in FIGS. 14A, such as a wearable accessory device and/or an intermediary processing device, in electronic communication or otherwise configured to be used in conjunction with the AR device 1400. In some embodiments, the wearable accessory device and/or the intermediary processing device may be configured to couple with the AR device 1400 via a coupling mechanism in electronic communication with a coupling sensor 1424, where the coupling sensor 1424 can detect when an electronic device becomes physically or electronically coupled with the AR device 1400. In some embodiments, the AR device 1400 can be configured to couple to a housing (e.g., a portion of frame 1404 or temple arms 1405), which may include one or more additional coupling mechanisms configured to couple with additional accessory devices. The components shown in FIG. 14A can be implemented in hardware, software, firmware, or a combination thereof, including one or more signal-processing components and/or application-specific integrated circuits (ASICs).

The AR device 1400 includes mechanical glasses components, including a frame 1404 configured to hold one or more lenses (e.g., one or both lenses 1406-1 and 1406-2). One of ordinary skill in the art will appreciate that the AR device 1400 can include additional mechanical components, such as hinges configured to allow portions of the frame 1404 of the AR device 1400 to be folded and unfolded, a bridge configured to span the gap between the lenses 1406-1 and 1406-2 and rest on the user's nose, nose pads configured to rest on the bridge of the nose and provide support for the AR device 1400, earpieces configured to rest on the user's ears and provide additional support for the AR device 1400, temple arms 1405 configured to extend from the hinges to the earpieces of the AR device 1400, and the like. One of ordinary skill in the art will further appreciate that some examples of the AR device 1400 can include none of the mechanical components described herein. For example, smart contact lenses configured to present artificial-reality to users may not include any components of the AR device 1400.

The lenses 1406-1 and 1406-2 can be individual displays or display devices (e.g., a waveguide for projected representations). The lenses 1406-1 and 1406-2 may act together or independently to present an image or series of images to a user. In some embodiments, the lenses 1406-1 and 1406-2 can operate in conjunction with one or more display projector assemblies 1407A and 1407B to present image data to a user. While the AR device 1400 includes two displays, embodiments of this disclosure may be implemented in AR devices with a single near-eye display (NED) or more than two NEDs.

The AR device 1400 includes electronic components, many of which will be described in more detail below with respect to FIG. 14C. Some example electronic components are illustrated in FIG. 14A, including sensors 1423-1, 1423-2, 1423-3, 1423-4, 1423-5, and 1423-6, which can be distributed along a substantial portion of the frame 1404 of the AR device 1400. The different types of sensors are described below in reference to FIG. 14C. The AR device 1400 also includes a left camera 1439A and a right camera 1439B, which are located on different sides of the frame 1404. And the eyewear device includes one or more processors 1448A and 1448B (e.g., an integral microprocessor, such as an ASIC) that is embedded into a portion of the frame 1404.

FIGS. 14B-1 and 14B-2 show an example visual depiction of the VR device 1410 (e.g., a head-mounted display (HMD) 1412, also referred to herein as an artificial-reality headset, a head-wearable device, a VR headset, etc.). The HMD 1412 includes a front body 1414 and a frame 1416 (e.g., a strap or band) shaped to fit around a user's head. In some embodiments, the front body 1414 and/or the frame 1416 includes one or more electronic elements for facilitating presentation of and/or interactions with an AR and/or VR system (e.g., displays, processors (e.g., processor 1448A-1), IMUs, tracking emitter or detectors, sensors, etc.). In some embodiments, the HMD 1412 includes output audio transducers (e.g., an audio transducer 1418-1), as shown in FIG. 14B-2. In some embodiments, one or more components, such as the output audio transducer(s) 1418 and the frame 1416, can be configured to attach and detach (e.g., are detachably attachable) to the HMD 1412 (e.g., a portion or all of the frame 1416, and/or the output audio transducer 1418), as shown in FIG. 14B-2. In some embodiments, coupling a detachable component to the HMD 1412 causes the detachable component to come into electronic communication with the HMD 1412. The VR device 1410 includes electronic components, many of which will be described in more detail below with respect to FIG. 14C.

FIG. 14B-1 to 14B-2 also show that the VR device 1410 one or more cameras, such as the left camera 1439A and the right camera 1439B, which can be analogous to the left and right cameras on the frame 1404 of the AR device 1400. In some embodiments, the VR device 1410 includes one or more additional cameras (e.g., cameras 1439C and 1439D), which can be configured to augment image data obtained by the cameras 1439A and 1439B by providing more information. For example, the camera 1439C can be used to supply color information that is not discerned by cameras 1439A and 1439B. In some embodiments, one or more of the cameras 1439A to 1439D can include an optional IR cut filter configured to remove IR light from being received at the respective camera sensors.

The VR device 1410 can include a housing 1490 storing one or more components of the VR device 1410 and/or additional components of the VR device 1410. The housing 1490 can be a modular electronic device configured to couple with the VR device 1410 (or an AR device 1400) and supplement and/or extend the capabilities of the VR device 1410 (or an AR device 1400). For example, the housing 1490 can include additional sensors, cameras, power sources, processors (e.g., processor 1448A-2), etc. to improve and/or increase the functionality of the VR device 1410. Examples of the different components included in the housing 1490 are described below in reference to FIG. 14C.

Alternatively or in addition, in some embodiments, the head-wearable device, such as the VR device 1410 and/or the AR device 1400), includes, or is communicatively coupled to, another external device (e.g., a paired device), such as an HIPD 15 (discussed below in reference to FIGS. 15A-15B) and/or an optional neckband. The optional neckband can couple to the head-wearable device via one or more connectors (e.g., wired or wireless connectors). The head-wearable device and the neckband can operate independently without any wired or wireless connection between them. In some embodiments, the components of the head-wearable device and the neckband are located on one or more additional peripheral devices paired with the head-wearable device, the neckband, or some combination thereof. Furthermore, the neckband is intended to represent any suitable type or form of paired device. Thus, the following discussion of neckband may also apply to various other paired devices, such as smart watches, smart phones, wrist bands, other wearable devices, hand-held controllers, tablet computers, or laptop computers.

In some situations, pairing external devices, such as an intermediary processing device (e.g., an HIPD device 1500, an optional neckband, and/or wearable accessory device) with the head-wearable devices (e.g., an AR device 1400 and/or VR device 1410) enables the head-wearable devices to achieve a similar form factor of a pair of glasses while still providing sufficient battery and computation power for expanded capabilities. Some, or all, of the battery power, computational resources, and/or additional features of the head-wearable devices can be provided by a paired device or shared between a paired device and the head-wearable devices, thus reducing the weight, heat profile, and form factor of the head-wearable devices overall while allowing the head-wearable devices to retain its desired functionality. For example, the intermediary processing device (e.g., the HIPD 1500) can allow components that would otherwise be included in a head-wearable device to be included in the intermediary processing device (and/or a wearable device or accessory device), thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on the head-wearable devices, standing alone. Because weight carried in the intermediary processing device can be less invasive to a user than weight carried in the head-wearable devices, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

In some embodiments, the intermediary processing device is communicatively coupled with the head-wearable device and/or to other devices. The other devices may provide certain functions (e.g., tracking, localizing, depth mapping, processing, storage, etc.) to the head-wearable device. In some embodiments, the intermediary processing device includes a controller and a power source. In some embodiments, sensors of the intermediary processing device are configured to sense additional data that can be shared with the head-wearable devices in an electronic format (analog or digital).

The controller of the intermediary processing device processes information generated by the sensors on the intermediary processing device and/or the head-wearable devices. The intermediary processing device, like an HIPD 1500, can process information generated by one or more sensors of its sensors and/or information provided by other communicatively coupled devices. For example, a head-wearable device can include an IMU, and the intermediary processing device (neckband and/or an HIPD 1500) can compute all inertial and spatial calculations from the IMUs located on the head-wearable device. Additional examples of processing performed by a communicatively coupled device, such as the HIPD 1500, are provided below in reference to FIGS. 15A and 15B.

Artificial-reality systems may include a variety of types of visual feedback mechanisms. For example, display devices in the AR devices 1400 and/or the VR devices 1410 may include one or more liquid-crystal displays (LCDs), light emitting diode (LED) displays, organic LED (OLED) displays, and/or any other suitable type of display screen. Artificial-reality systems may include a single display screen for both eyes or may provide a display screen for each eye, which may allow for additional flexibility for varifocal adjustments or for correcting a refractive error associated with the user's vision. Some artificial-reality systems also include optical subsystems having one or more lenses (e.g., conventional concave or convex lenses, Fresnel lenses, or adjustable liquid lenses) through which a user may view a display screen. In addition to or instead of using display screens, some artificial-reality systems include one or more projection systems. For example, display devices in the AR device 1400 and/or the VR device 1410 may include micro-LED projectors that project light (e.g., using a waveguide) into display devices, such as clear combiner lenses that allow ambient light to pass through. The display devices may refract the projected light toward a user's pupil and may enable a user to simultaneously view both artificial-reality content and the real world. Artificial-reality systems may also be configured with any other suitable type or form of image projection system. As noted, some AR systems may, instead of blending an artificial reality with actual reality, substantially replace one or more of a user's sensory perceptions of the real world with a virtual experience.

While the example head-wearable devices are respectively described herein as the AR device 1400 and the VR device 1410, either or both of the example head-wearable devices described herein can be configured to present fully-immersive VR scenes presented in substantially all of a user's field of view, additionally or alternatively to, subtler augmented-reality scenes that are presented within a portion, less than all, of the user's field of view.

In some embodiments, the AR device 1400 and/or the VR device 1410 can include haptic feedback systems. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback can be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices (e.g., wrist-wearable devices which may be incorporated into headwear, gloves, body suits, handheld controllers, environmental devices (e.g., chairs or floormats), and/or any other type of device or system, such as a wrist-wearable device 1300, an HIPD 1500, smart textile-based garment 1600, etc.), and/or other devices described herein.

FIG. 14C illustrates a computing system 1420 and an optional housing 1490, each of which show components that can be included in a head-wearable device (e.g., the AR device 1400 and/or the VR device 1410). In some embodiments, more or less components can be included in the optional housing 1490 depending on practical restraints of the respective head-wearable device being described. Additionally or alternatively, the optional housing 1490 can include additional components to expand and/or augment the functionality of a head-wearable device.

In some embodiments, the computing system 1420 and/or the optional housing 1490 can include one or more peripheral interfaces 1422A and 1422B, one or more power systems 1442A and 1442B (including charger input 1443, PMIC 1444, and battery 1445), one or more controllers 1446A 1446B (including one or more haptic controllers 1447), one or more processors 1448A and 1448B (as defined above, including any of the examples provided), and memory 1450A and 1450B, which can all be in electronic communication with each other. For example, the one or more processors 1448A and/or 1448B can be configured to execute instructions stored in the memory 1450A and/or 1450B, which can cause a controller of the one or more controllers 1446A and/or 1446B to cause operations to be performed at one or more peripheral devices of the peripherals interfaces 1422A and/or 1422B. In some embodiments, each operation described can occur based on electrical power provided by the power system 1442A and/or 1442B.

In some embodiments, the peripherals interface 1422A can include one or more devices configured to be part of the computing system 1420, many of which have been defined above and/or described with respect to wrist-wearable devices shown in FIGS. 13A and 13B. For example, the peripherals interface can include one or more sensors 1423A. Some example sensors include: one or more coupling sensors 1424, one or more acoustic sensors 1425, one or more imaging sensors 1426, one or more EMG sensors 1427, one or more capacitive sensors 1428, and/or one or more IMU sensors 1429. In some embodiments, the sensors 1423A further include depth sensors 1467, light sensors 1468 and/or any other types of sensors defined above or described with respect to any other embodiments discussed herein.

In some embodiments, the peripherals interface can include one or more additional peripheral devices, including one or more NFC devices 1430, one or more GPS devices 1431, one or more LTE devices 1432, one or more WiFi and/or Bluetooth devices 1433, one or more buttons 1434 (e.g., including buttons that are slidable or otherwise adjustable), one or more displays 1435A, one or more speakers 1436A, one or more microphones 1437A, one or more cameras 1438A (e.g., including the a first camera 1439-1 through nth camera 1439-n, which are analogous to the left camera 1439A and/or the right camera 1439B), one or more haptic devices 1440; and/or any other types of peripheral devices defined above or described with respect to any other embodiments discussed herein.

The head-wearable devices can include a variety of types of visual feedback mechanisms (e.g., presentation devices). For example, display devices in the AR device 1400 and/or the VR device 1410 can include one or more liquid-crystal displays (LCDs), light emitting diode (LED) displays, organic LED (OLED) displays, micro-LEDs, and/or any other suitable types of display screens. The head-wearable devices can include a single display screen (e.g., configured to be seen by both eyes), and/or can provide separate display screens for each eye, which can allow for additional flexibility for varifocal adjustments and/or for correcting a refractive error associated with the user's vision. Some embodiments of the head-wearable devices also include optical subsystems having one or more lenses (e.g., conventional concave or convex lenses, Fresnel lenses, or adjustable liquid lenses) through which a user can view a display screen. For example, respective displays 1435A can be coupled to each of the lenses 1406-1 and 1406-2 of the AR device 1400. The displays 1435A coupled to each of the lenses 1406-1 and 1406-2 can act together or independently to present an image or series of images to a user. In some embodiments, the AR device 1400 and/or the VR device 1410 includes a single display 1435A (e.g., a near-eye display) or more than two displays 1435A.

In some embodiments, a first set of one or more displays 1435A can be used to present an augmented-reality environment, and a second set of one or more display devices 1435A can be used to present a virtual-reality environment. In some embodiments, one or more waveguides are used in conjunction with presenting artificial-reality content to the user of the AR device 1400 and/or the VR device 1410 (e.g., as a means of delivering light from a display projector assembly and/or one or more displays 1435A to the user's eyes). In some embodiments, one or more waveguides are fully or partially integrated into the AR device 1400 and/or the VR device 1410. Additionally, or alternatively to display screens, some artificial-reality systems include one or more projection systems. For example, display devices in the AR device 1400 and/or the VR device 1410 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. The head-wearable devices can also be configured with any other suitable type or form of image projection system. In some embodiments, one or more waveguides are provided additionally or alternatively to the one or more display(s) 1435A.

In some embodiments of the head-wearable devices, ambient light and/or a real-world live view (e.g., a live feed of the surrounding environment that a user would normally see) can be passed through a display element of a respective head-wearable device presenting aspects of the AR system. In some embodiments, ambient light and/or the real-world live view can be passed through a portion less than all, of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable devices, and an amount of ambient light and/or the real-world live view (e.g., 15-50% of the ambient light and/or the real-world live view) can be passed through the user interface element, such that the user can distinguish at least a portion of the physical environment over which the user interface element is being displayed.

The head-wearable devices can include one or more external displays 1435A for presenting information to users. For example, an external display 1435A can be used to show a current battery level, network activity (e.g., connected, disconnected, etc.), current activity (e.g., playing a game, in a call, in a meeting, watching a movie, etc.), and/or other relevant information. In some embodiments, the external displays 1435A can be used to communicate with others. For example, a user of the head-wearable device can cause the external displays 1435A to present a do not disturb notification. The external displays 1435A can also be used by the user to share any information captured by the one or more components of the peripherals interface 1422A and/or generated by head-wearable device (e.g., during operation and/or performance of one or more applications).

The memory 1450A can include instructions and/or data executable by one or more processors 1448A (and/or processors 1448B of the housing 1490) and/or a memory controller of the one or more controllers 1446A (and/or controller 1446B of the housing 1490). The memory 1450A can include one or more operating systems 1451; one or more applications 1452; one or more communication interface modules 1453A; one or more graphics modules 1454A; one or more AR processing modules 1455A; one or more haptics modules 1456A determining, generating, and provided instructions for causing the performance of a haptic response, such as the haptic responses described above in reference to FIGS. 1A-9; and/or any other types of modules or components defined above or described with respect to any other embodiments discussed herein. The haptics modules 1456A is analogous to the haptics modules 1687 (FIG. 16C) such that features of the haptics modules 1687 described below are included in the haptics modules 1456A.

The data 1460 stored in memory 1450A can be used in conjunction with one or more of the applications and/or programs discussed above. The data 1460 can include profile data 1461; sensor data 1462; media content data 1463; AR application data 1464; haptics data 1465 for storing data related to the performance of the features described above in reference to FIGS. 1A-9; and/or any other types of data defined above or described with respect to any other embodiments discussed herein. The haptics data 1465 is analogous to the haptics data 1694 (FIG. 16C) such that features of the haptics data 1694 described below are included in the haptics data 1465.

In some embodiments, the controller 1446A of the head-wearable devices processes information generated by the sensors 1423A on the head-wearable devices and/or another component of the head-wearable devices and/or communicatively coupled with the head-wearable devices (e.g., components of the housing 1490, such as components of peripherals interface 1422B). For example, the controller 1446A can process information from the acoustic sensors 1425 and/or image sensors 1426. For each detected sound, the controller 1446A can perform a direction of arrival (DOA) estimation to estimate a direction from which the detected sound arrived at a head-wearable device. As one or more of the acoustic sensors 1425 detects sounds, the controller 1446A can populate an audio data set with the information (e.g., represented by sensor data 1462).

In some embodiments, a physical electronic connector can convey information between the head-wearable devices and another electronic device, and/or between one or more processors 1448A of the head-wearable devices and the controller 1446A. The information can be in the form of optical data, electrical data, wireless data, or any other transmittable data form. Moving the processing of information generated by the head-wearable devices to an intermediary processing device can reduce weight and heat in the eyewear device, making it more comfortable and safer for a user. In some embodiments, an optional accessory device (e.g., an electronic neckband or an HIPD 1500) is coupled to the head-wearable devices via one or more connectors. The connectors can be wired or wireless connectors and can include electrical and/or non-electrical (e.g., structural) components. In some embodiments, the head-wearable devices and the accessory device can operate independently without any wired or wireless connection between them.

The head-wearable devices can include various types of computer vision components and subsystems. For example, the AR device 1400 and/or the VR device 1410 can include one or more optical sensors such as two-dimensional (2D) or three-dimensional (3D) cameras, time-of-flight depth sensors, single-beam or sweeping laser rangefinders, 3D LiDAR sensors, and/or any other suitable type or form of optical sensor. A head-wearable device can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate interactable virtual objects (which can be replicas or digital twins of real-world objects that can be interacted with in AR environment), among a variety of other functions. For example, FIGS. 14B-1 and 14B-2 show the VR device 1410 having cameras 1439A-1439D, which can be used to provide depth information for creating a voxel field and a two-dimensional mesh to provide object information to the user to avoid collisions.

The optional housing 1490 can include analogous components to those describe above with respect to the computing system 1420. For example, the optional housing 1490 can include a respective peripherals interface 1422B including more or less components to those described above with respect to the peripherals interface 1422A. As described above, the components of the optional housing 1490 can be used augment and/or expand on the functionality of the head-wearable devices. For example, the optional housing 1490 can include respective sensors 1423B, speakers 1436B, displays 1435B, microphones 1437B, cameras 1438B, and/or other components to capture and/or present data. Similarly, the optional housing 1490 can include one or more processors 1448B, controllers 1446B, and/or memory 1450B (including respective communication interface modules 1453B; one or more graphics modules 1454B; one or more AR processing modules 1455B, one or more haptics modules 1456B, haptics data 1465, etc.) that can be used individually and/or in conjunction with the components of the computing system 1420.

The techniques described above in FIGS. 14A-14C can be used with different head-wearable devices. In some embodiments, the head-wearable devices (e.g., the AR device 1400 and/or the VR device 1410) can be used in conjunction with one or more wearable device such as a wrist-wearable device 1300 (or components thereof) and/or a smart textile-based garment 1600 (FIGS. 16A-16C), as well as an HIPD 1500. Having thus described example the head-wearable devices, attention will now be turned to example handheld intermediary processing devices, such as HIPD 1500.

### Example Handheld Intermediary Processing Devices

FIGS. 15A and 15B illustrate an example handheld intermediary processing device (HIPD) 1500, in accordance with some embodiments. The HIPD 1500 is an instance of the intermediary device such as a wireless controller described in reference to FIG. 8 herein, such that the HIPD 1500 should be understood to have the features described with respect to any intermediary device defined above or otherwise described herein, and vice versa. The HIPD 1500 can perform various functions and/or operations associated with navigating through user interfaces and selectively opening applications, as well as the functions and/or operations described above with reference to FIG. 8.

FIG. 15A shows a top view 1505 and a side view 1525 of the HIPD 1500. The HIPD 1500 is configured to communicatively couple with one or more wearable devices (or other electronic devices) associated with a user. For example, the HIPD 1500 is configured to communicatively couple with a user's wrist-wearable device 1300 (or components thereof, such as the watch body 1320 and the wearable band 1310), AR device 1400, and/or VR device 1410. The HIPD 1500 can be configured to be held by a user (e.g., as a handheld controller), carried on the user's person (e.g., in their pocket, in their bag, etc.), placed in proximity of the user (e.g., placed on their desk while seated at their desk, on a charging dock, etc.), and/or placed at or within a predetermined distance from a wearable device or other electronic device (e.g., where, in some embodiments, the predetermined distance is the maximum distance (e.g., 10 meters) at which the HIPD 1500 can successfully be communicatively coupled with an electronic device, such as a wearable device).

The HIPD 1500 can perform various functions independently and/or in conjunction with one or more wearable devices (e.g., wrist-wearable device 1300, AR device 1400, VR device 1410, etc.). The HIPD 1500 is configured to increase and/or improve the functionality of communicatively coupled devices, such as the wearable devices. The HIPD 1500 is configured to perform one or more functions or operations associated with interacting with user interfaces and applications of communicatively coupled devices, interacting with an AR environment, interacting with VR environment, and/or operating as a human-machine interface controller, as well as functions and/or operations described above with reference to FIGS. 4A-4F and 8. Additionally, as will be described in more detail below, functionality and/or operations of the HIPD 1500 can include, without limitation, task offloading and/or handoffs; thermals offloading and/or handoffs; 6 degrees of freedom (6DoF) raycasting and/or gaming (e.g., using imaging devices or cameras 1514A and 1514B, which can be used for simultaneous localization and mapping (SLAM) and/or with other image processing techniques); portable charging; messaging; image capturing via one or more imaging devices or cameras (e.g., cameras 1522A and 1522B); sensing user input (e.g., sensing a touch on a multi-touch input surface 1502); wireless communications and/or interlining (e.g., cellular, near field, Wi-Fi, personal area network, etc.); location determination; financial transactions; providing haptic feedback; alarms; notifications; biometric authentication; health monitoring; sleep monitoring; etc. The above-example functions can be executed independently in the HIPD 1500 and/or in communication between the HIPD 1500 and another wearable device described herein. In some embodiments, functions can be executed on the HIPD 1500 in conjunction with an AR environment. As the skilled artisan will appreciate upon reading the descriptions provided herein, the novel the HIPD 1500 described herein can be used with any type of suitable AR environment.

While the HIPD 1500 is communicatively coupled with a wearable device and/or other electronic device, the HIPD 1500 is configured to perform one or more operations initiated at the wearable device and/or the other electronic device. In particular, one or more operations of the wearable device and/or the other electronic device can be offloaded to the HIPD 1500 to be performed. The HIPD 1500 performs the one or more operations of the wearable device and/or the other electronic device and provides to data corresponded to the completed operations to the wearable device and/or the other electronic device. For example, a user can initiate a video stream using AR device 1400 and back-end tasks associated with performing the video stream (e.g., video rendering) can be offloaded to the HIPD 1500, which the HIPD 1500 performs and provides corresponding data to the AR device 1400 to perform remaining front-end tasks associated with the video stream (e.g., presenting the rendered video data via a display of the AR device 1400). In this way, the HIPD 1500, which has more computational resources and greater thermal headroom than a wearable device, can perform computationally intensive tasks for the wearable device improving performance of an operation performed by the wearable device.

The HIPD 1500 includes a multi-touch input surface 1502 on a first side (e.g., a front surface) that is configured to detect one or more user inputs. In particular, the multi-touch input surface 1502 can detect single tap inputs, multi-tap inputs, swipe gestures and/or inputs, force-based and/or pressure-based touch inputs, held taps, and the like. The multi-touch input surface 1502 is configured to detect capacitive touch inputs and/or force (and/or pressure) touch inputs. The multi-touch input surface 1502 includes a first touch-input surface 1504 defined by a surface depression, and a second touch-input surface 1506 defined by a substantially planar portion. The first touch-input surface 1504 can be disposed adjacent to the second touch-input surface 1506. In some embodiments, the first touch-input surface 1504 and the second touch-input surface 1506 can be different dimensions, shapes, and/or cover different portions of the multi-touch input surface 1502. For example, the first touch-input surface 1504 can be substantially circular and the second touch-input surface 1506 is substantially rectangular. In some embodiments, the surface depression of the multi-touch input surface 1502 is configured to guide user handling of the HIPD 1500. In particular, the surface depression is configured such that the user holds the HIPD 1500 upright when held in a single hand (e.g., such that the using imaging devices or cameras 1514A and 1514B are pointed toward a ceiling or the sky). Additionally, the surface depression is configured such that the user's thumb rests within the first touch-input surface 1504.

In some embodiments, the different touch-input surfaces include a plurality of touch-input zones. For example, the second touch-input surface 1506 includes at least a first touch-input zone 1508 within a second touch-input zone 1506 and a third touch-input zone 1510 within the first touch-input zone 1508. In some embodiments, one or more of the touch-input zones are optional and/or user defined (e.g., a user can specific a touch-input zone based on their preferences). In some embodiments, each touch-input surface and/or touch-input zone is associated with a predetermined set of commands. For example, a user input detected within the first touch-input zone 1508 causes the HIPD 1500 to perform a first command and a user input detected within the second touch-input zone 1506 causes the HIPD 1500 to perform a second command, distinct from the first. In some embodiments, different touch-input surfaces and/or touch-input zones are configured to detect one or more types of user inputs. The different touch-input surfaces and/or touch-input zones can be configured to detect the same or distinct types of user inputs. For example, the first touch-input zone 1508 can be configured to detect force touch inputs (e.g., a magnitude at which the user presses down) and capacitive touch inputs, and the second touch-input zone 1506 can be configured to detect capacitive touch inputs.

The HIPD 1500 includes one or more sensors 1551 for sensing data used in the performance of one or more operations and/or functions. For example, the HIPD 1500 can include an IMU sensor that is used in conjunction with cameras 1514 for 3-dimensional object manipulation (e.g., enlarging, moving, destroying, etc. an object) in an AR or VR environment. Non-limiting examples of the sensors 1551 included in the HIPD 1500 include a light sensor, a magnetometer, a depth sensor, a pressure sensor, and a force sensor. Additional examples of the sensors 1551 are provided below in reference to FIG. 15B.

The HIPD 1500 can include one or more light indicators 1512 to provide one or more notifications to the user. In some embodiments, the light indicators are LEDs or other types of illumination devices. The light indicators 1512 can operate as a privacy light to notify the user and/or others near the user that an imaging device and/or microphone are active. In some embodiments, a light indicator is positioned adjacent to one or more touch-input surfaces. For example, a light indicator can be positioned around the first touch-input surface 1504. The light indicators can be illuminated in different colors and/or patterns to provide the user with one or more notifications and/or information about the device. For example, a light indicator positioned around the first touch-input surface 1504 can flash when the user receives a notification (e.g., a message), change red when the HIPD 1500 is out of power, operate as a progress bar (e.g., a light ring that is closed when a task is completed (e.g., 0% to 100%)), operates as a volume indicator, etc.).

In some embodiments, the HIPD 1500 includes one or more additional sensors on another surface. For example, as shown FIG. 15A, HIPD 1500 includes a set of one or more sensors (e.g., sensor set 1520) on an edge of the HIPD 1500. The sensor set 1520, when positioned on an edge of the of the HIPD 1500, can be pe positioned at a predetermined tilt angle (e.g., 26 degrees), which allows the sensor set 1520 to be angled toward the user when placed on a desk or other flat surface. Alternatively, in some embodiments, the sensor set 1520 is positioned on a surface opposite the multi-touch input surface 1502 (e.g., a back surface). The one or more sensors of the sensor set 1520 are discussed in detail below.

The side view 1525 of the of the HIPD 1500 shows the sensor set 1520 and camera 1514B. The sensor set 1520 includes one or more cameras 1522A and 1522B, a depth projector 1524, an ambient light sensor 1528, and a depth receiver 1530. In some embodiments, the sensor set 1520 includes a light indicator 1526. The light indicator 1526 can operate as a privacy indicator to let the user and/or those around them know that a camera and/or microphone is active. The sensor set 1520 is configured to capture a user's facial expression such that the user can puppet a custom avatar (e.g., showing emotions, such as smiles, laughter, etc., on the avatar or a digital representation of the user). The sensor set 1520 can be configured as a side stereo RGB system, a rear indirect Time-of-Flight (iToF) system, or a rear stereo RGB system. As the skilled artisan will appreciate upon reading the descriptions provided herein, the novel HIPD 1500 described herein can use different sensor set 1520 configurations and/or sensor set 1520 placement.

In some embodiments, the HIPD 1500 includes one or more haptic devices 1571 (FIG. 15B; e.g., a vibratory haptic actuator) that are configured to provide haptic feedback (e.g., kinesthetic sensation). The sensors 1551, and/or the haptic devices 1571 can be configured to operate in conjunction with multiple applications and/or communicatively coupled devices including, without limitation, a wearable devices, health monitoring applications, social media applications, game applications, and artificial reality applications (e.g., the applications associated with artificial reality).

The HIPD 1500 is configured to operate without a display. However, in optional embodiments, the HIPD 1500 can include a display 1568 (FIG. 15B). The HIPD 1500 can also income one or more optional peripheral buttons 1567 (FIG. 15B). For example, the peripheral buttons 1567 can be used to turn on or turn off the HIPD 1500. Further, the HIPD 1500 housing can be formed of polymers and/or elastomer elastomers. The HIPD 1500 can be configured to have a non-slip surface to allow the HIPD 1500 to be placed on a surface without requiring a user to watch over the HIPD 1500. In other words, the HIPD 1500 is designed such that it would not easily slide off a surfaces. In some embodiments, the HIPD 1500 include one or magnets to couple the HIPD 1500 to another surface. This allows the user to mount the HIPD 1500 to different surfaces and provide the user with greater flexibility in use of the HIPD 1500.

As described above, the HIPD 1500 can distribute and/or provide instructions for performing the one or more tasks at the HIPD 1500 and/or a communicatively coupled device. For example, the HIPD 1500 can identify one or more back-end tasks to be performed by the HIPD 1500 and one or more front-end tasks to be performed by a communicatively coupled device. While the HIPD 1500 is configured to offload and/or handoff tasks of a communicatively coupled device, the HIPD 1500 can perform both back-end and front-end tasks (e.g., via one or more processors, such as CPU 1577; FIG. 15B). The HIPD 1500 can, without limitation, can be used to perform augmenting calling (e.g., receiving and/or sending 3D or 2.5D live volumetric calls, live digital human representation calls, and/or avatar calls), discreet messaging, 6DoF portrait/landscape gaming, AR/VR object manipulation, AR/VR content display (e.g., presenting content via a virtual display), and/or other AR/VR interactions. The HIPD 1500 can perform the above operations alone or in conjunction with a wearable device (or other communicatively coupled electronic device).

FIG. 15B shows block diagrams of a computing system 1540 of the HIPD 1500, in accordance with some embodiments. The HIPD 1500, described in detail above, can include one or more components shown in HIPD computing system 1540. The HIPD 1500 will be understood to include the components shown and described below for the HIPD computing system 1540. In some embodiments, all, or a substantial portion of the components of the HIPD computing system 1540 are included in a single integrated circuit. Alternatively, in some embodiments, components of the HIPD computing system 1540 are included in a plurality of integrated circuits that are communicatively coupled.

The HIPD computing system 1540 can include a processor (e.g., a CPU 1577, a GPU, and/or a CPU with integrated graphics), a controller 1575, a peripherals interface 1550 that includes one or more sensors 1551 and other peripheral devices, a power source (e.g., a power system 1595), and memory (e.g., a memory 1578) that includes an operating system (e.g., an operating system 1579), data (e.g., data 1588), one or more applications (e.g., applications 1580), and one or more modules (e.g., a communications interface module 1581, a graphics module 1582, a task and processing management module 1583, an interoperability module 1584, an AR processing module 1585, a data management module 1586, a haptics module 1587, etc.). The HIPD computing system 1540 further includes a power system 1595 that includes a charger input and output 1596, a PMIC 1597, and a battery 1598, all of which are defined above.

In some embodiments, the peripherals interface 1550 can include one or more sensors 1551. The sensors 1551 can include analogous sensors to those described above in reference to FIG. 13B. For example, the sensors 1551 can include imaging sensors 1554, (optional) EMG sensors 1556, IMU sensors 1558, and capacitive sensors 1560. In some embodiments, the sensors 1551 can include one or more pressure sensor 1552 for sensing pressure data, an altimeter 1553 for sensing an altitude of the HIPD 1500, a magnetometer 1555 for sensing a magnetic field, a depth sensor 1557 (or a time-of flight sensor) for determining a difference between the camera and the subject of an image, a position sensor 1559 (e.g., a flexible position sensor) for sensing a relative displacement or position change of a portion of the HIPD 1500, a force sensor 1561 for sensing a force applied to a portion of the HIPD 1500, and a light sensor 1562 (e.g., an ambient light sensor) for detecting an amount of lighting. The sensors 1551 can include one or more sensors not shown in FIG. 15B.

Analogous to the peripherals described above in reference to FIGS. 13B, the peripherals interface 1550 can also include an NFC component 1563, a GPS component 1564, an LTE component 1565, a Wi-Fi and/or Bluetooth communication component 1566, a speaker 1569, a haptic device 1571, and a microphone 1573. As described above in reference to FIG. 15A, the HIPD 1500 can optionally include a display 1568 and/or one or more buttons 1567. The peripherals interface 1550 can further include one or more cameras 1570, touch surfaces 1572, and/or one or more light emitters 1574. The multi-touch input surface 1502 described above in reference to FIG. 15A is an example of touch surface 1572. The light emitters 1574 can be one or more LEDs, lasers, etc. and can be used to project or present information to a user. For example, the light emitters 1574 can include light indicators 1512 and 1526 described above in reference to FIG. 15A. The cameras 1570 (e.g., cameras 1514A, 1514B, and 1522 described above in FIG. 15A) can include one or more wide angle cameras, fish-eye cameras, spherical cameras, compound eye cameras (e.g., stereo and multi cameras), depth cameras, RGB cameras, ToF cameras, RGB-D cameras (depth and ToF cameras), and/or other available cameras. Cameras 1570 can be used for SLAM; 6 DoF ray casting, gaming, object manipulation, and/or other rendering; facial recognition and facial expression recognition, etc.

Similar to the watch body computing system 1360 and the watch band computing system 1330 described above in reference to FIG. 13B, the HIPD computing system 1540 can include one or more haptic controllers 1576 and associated componentry (e.g., haptic devices 1571) for providing haptic events at the HIPD 1500.

Memory 1578 can include high-speed random-access memory and/or non-volatile memory, such as one or more magnetic disk storage devices, flash memory devices, or other non-volatile solid-state memory devices. Access to the memory 1578 by other components of the HIPD 1500, such as the one or more processors and the peripherals interface 1550, can be controlled by a memory controller of the controllers 1575.

In some embodiments, software components stored in the memory 1578 include one or more operating systems 1579, one or more applications 1580, one or more communication interface modules 1581, one or more graphics modules 1582, one or more data management modules 1585, which are analogous to the software components described above in reference to FIG. 13B. The software components stored in the memory 1578 can also include the haptics modules 1587, which is analogous to the haptics modules 1687 (FIG. 16C) such that features of the haptics modules 1687 described below are included in the haptics modules 1587.

In some embodiments, software components stored in the memory 1578 include a task and processing management module 1583 for identifying one or more front-end and back-end tasks associated with an operation performed by the user, performing one or more front-end and/or back-end tasks, and/or providing instructions to one or more communicatively coupled devices that cause performance of the one or more front-end and/or back-end tasks. In some embodiments, the task and processing management module 1583 uses data 1588 (e.g., device data 1590) to distribute the one or more front-end and/or back-end tasks based on communicatively coupled devices' computing resources, available power, thermal headroom, ongoing operations, and/or other factors. For example, the task and processing management module 1583 can cause the performance of one or more back-end tasks (of an operation performed at communicatively coupled AR device 1400) at the HIPD 1500 in accordance with a determination that the operation is utilizing a predetermined amount (e.g., at least 70%) of computing resources available at the AR device 1400.

In some embodiments, software components stored in the memory 1578 include an interoperability module 1584 for exchanging and utilizing information received and/or provided to distinct communicatively coupled devices. The interoperability module 1584 allows for different systems, devices, and/or applications to connect and communicate in a coordinated way without user input. In some embodiments, software components stored in the memory 1578 include an AR module 1585 that is configured to process signals based at least on sensor data for use in an AR and/or VR environment. For example, the AR processing module 1585 can be used for 3D object manipulation, gesture recognition, facial and facial expression, recognition, etc.

The memory 1578 can also include data 1588, including structured data. In some embodiments, the data 1588 can include profile data 1589, device data 1589 (including device data of one or more devices communicatively coupled with the HIPD 1500, such as device type, hardware, software, configurations, etc.), sensor data 1591, media content data 1592, application data 1593, and haptics data 1594, which stores data related to the performance of the features described above in reference to FIGS. 1A-9. The haptics data 1594 is analogous to the haptics data 1694 (FIG. 16C) such that features of the haptics data 1694 described below are included in the haptics data 1594.

It should be appreciated that the HIPD computing system 1540 is an example of a computing system within the HIPD 1500, and that the HIPD 1500 can have more or fewer components than shown in the HIPD computing system 1540, combine two or more components, and/or have a different configuration and/or arrangement of the components. The various components shown in HIPD computing system 1540 are implemented in hardware, software, firmware, or a combination thereof, including one or more signal processing and/or application-specific integrated circuits.

The techniques described above in FIG. 15A-15B can be used with any device used as a human-machine interface controller. In some embodiments, an HIPD 1500 can be used in conjunction with one or more wearable device such as a head-wearable device (e.g., AR device 1400 and VR device 1410) and/or a wrist-wearable device 1300 (or components thereof). In some embodiments, an HIPD 1500 can also be used in conjunction with a wearable garment, such as smart textile-based garment 1600 (FIGS. 16A-16C). Having thus described example HIPD 1500, attention will now be turned to example feedback devices, such as smart textile-based garment 1600.

### Example Smart Textile-Based Garments

FIGS. 16A and 16B illustrate an example smart textile-based garment, in accordance with some embodiments. The smart textile-based garment 1600 (e.g., wearable gloves, a shirt, a headband, a wristbands, socks, etc.) is configured to communicatively couple with one or more electronic devices, such as a wrist-wearable device 1300, a head-wearable device, an HIPD 1500, a laptop, tablet, and/or other computing devices. The smart textile-based garment 1600 is an instance of the smart textile-based such as the wearable glove device described in reference to FIGS. 1A-4F herein, such that the smart textile-based garment 1600 should be understood to have the features described with respect to any smart textile-based garment defined above or otherwise described herein, and vice versa. The smart textile-based garment 1600 can perform various functions and/or operations associated with navigating through user interfaces and selectively opening applications, as well as the functions and/or operations described above with reference to FIGS. 1A-8.

The smart textile-based garment 1600 can be part of an AR system, such as AR system 1200d described above in reference to FIGS. 12D-1 and 12D-2. The smart textile-based garment 1600 is also configured to provide feedback (e.g., tactile or other haptic feedback) to a user based on the user's interactions with a computing system (e.g., navigation of a user interface, operation of an application (e.g., game vibrations, media responsive haptics), device notifications, etc.)), and/or the user's interactions within an AR environment. In some embodiments, the smart textile-based garment 1600 receives instructions from a communicatively coupled device (e.g., the wrist-wearable device 1300, a head-wearable device, and HIPD 1500, etc.) for causing the performance of a feedback response. Alternatively, or in addition, in some embodiments, the smart textile-based garment 1600 determines one or more feedback responses to provide a user. The smart textile-based garment 1600 can determine the one or more feedback responses based on sensor data captured by one or more of its sensors (e.g., sensors 1651; FIG. 16C) or communicatively coupled sensors (e.g., sensors of a wrist-wearable device 1300, a head-wearable device, an HIPD 1500, and/or other computing device).

Non-limiting examples of the feedback determined by the smart textile-based garment 1600 and/or a communicatively coupled device include visual feedback, audio feedback, haptic (e.g., tactile, kinesthetic, etc.) feedback, thermal or temperature feedback, and/or other sensory perceptible feedback. The smart textile-based garment 1600 can include respective feedback devices (e.g., a haptic device or assembly 1662 or other feedback devices or assemblies) to provide the feedback responses to the user. Similarly, the smart textile-based garment 1600 can communicatively couple with another device (and/or the other device's feedback devices) to coordinate the feedback provided to the user. For example, a VR device 1410 can present an AR environment to a user and as the user interacts with objects within the AR environment, such as a virtual cup, the smart textile-based garment 1600 provides respective response to the user. In particular, the smart textile-based garment 1600 can provide haptic feedback to prevent (or, at a minimum, hinder/resist movement of) one or more of the user's fingers from bending past a certain point to simulate the sensation of touching a solid cup and/or thermal feedback to simulate the sensation of a cold or warm beverage.

Additionally or alternatively, in some embodiments, the smart textile-based garment 1600 is configured to operate as a controller configured to perform one or more functions or operations associated with interacting with user interfaces and applications of communicatively coupled devices, interacting with an AR environment, interacting with VR environment, and/or operating as a human-machine interface controller, as well as functions and/or operations described above with reference to FIG. 8.

FIG. 16A shows one or more haptic assemblies 1662 (e.g., first through fourth haptic assemblies 1662-1 through 1662-4) on a portion of the smart textile-based garment 1600 adjacent to a palmar side of the user's hand and FIG. 16B shows additional haptic assemblies (e.g., a fifth haptic assembly 1662-5) on a portion of the smart textile-based garment 1600 adjacent to a dorsal side of the user's hand. In some embodiments, the haptic assemblies 1662 include a mechanism that, at a minimum, provide resistance when a respective haptic assembly 1662 is transitioned from a first state (e.g., a first pressurized state (e.g., at atmospheric pressure or deflated)) to a second state (e.g., a second pressurized state (e.g., inflated to a threshold pressure)). In other words, the haptic assemblies 1662 described can transition between a first pressurized state and a second pressurized state to provide haptic feedback to the user. Structures of haptic assemblies 1662 can be integrated into various devices configured to be in contact or proximity to a user's skin, including, but not limited to devices such as glove worn devices, body worn clothing device, headset devices. Each of the haptic assemblies 1662 can be included in or physically coupled to a garment component 1604 of the smart textile-based garment 1600. For example, each of the haptic assemblies 1662-1, 1662-2, 1662-3, . . . 1662-N are physically coupled to the garment 1604 are configured to contact respective phalanges of a user's thumb and fingers.

Due to the ever-changing nature of artificial-reality, the haptic assemblies 1662 may be required to transition between the multiple states hundreds, or perhaps thousands of times, during a single use. Thus, the haptic assemblies 1662 described herein are durable and designed to quickly transition from state to state. To provide some context, in a first pressurized state, the haptic assemblies 1662 do not impede free movement of a portion of the wearer's body. For example, one or more haptic assemblies 1662 incorporated into a glove are made from flexible materials that do not impede free movement of the wearer's hand and fingers (e.g., an electrostatic-zipping actuator). The haptic assemblies 1662 are configured to conform to a shape of the portion of the wearer's body when in the first pressurized state. However, once in a second pressurized state, the haptic assemblies 1662 can be configured to restrict and/or impede free movement of the portion of the wearer's body (e.g., appendages of the user's hand). For example, the respective haptic assembly 1662 (or multiple respective haptic assemblies) can restrict movement of a wearer's finger (e.g., prevent the finger from curling or extending) when the haptic assembly 1662 is in the second pressurized state. Moreover, once in the second pressurized state, the haptic assemblies 1662 may take different shapes, with some haptic assemblies 1662 configured to take a planar, rigid shape (e.g., flat and rigid), while some other haptic assemblies 1662 are configured to curve or bend, at least partially.

The smart textile-based garment 1600 can be one of a plurality of devices in an AR system (e.g., AR systems of FIGS. 12A-12D-2). For example, a user can wear a pair of gloves (e.g., a first type of smart textile-based garment 1600), wear a haptics component of a wrist-wearable device 1300 (FIGS. 13A-13B), wear a headband (e.g., a second type of smart textile-based garment 1600), hold an HIPD 1500, etc. As explained above, the haptic assemblies 1662 are configured to provide haptic simulations to a wearer of the smart textile-based garments 1600. The garment 1604 of each smart textile-based garment 1600 can be one of various articles of clothing (e.g., gloves, socks, shirts, pants, etc.). Thus, a user may wear multiple smart textile-based garments 1600 that are each configured to provide haptic stimulations to respective parts of the body where the smart textile-based garments 1600 are being worn. Although the smart textile-based garment 1600 are described as an individual device, in some embodiments, the smart textile-based garment 1600 can be combined with other wearable devices described herein. For example, the smart textile-based garment 1600 can form part of a VR device 1410 (e.g., a headband portion).

FIG. 16C shows block diagrams of a computing system 1640 of the haptic assemblies 1662, in accordance with some embodiments. The computing system 1640 can include one or more peripheral interfaces 1650, one or more power systems 1695 (including charger input 1696, PMIC 1697, and battery 1698), one or more controllers 1675 (including one or more haptic controllers 1676), one or more processors 1677 (as defined above, including any of the examples provided), and memory 1678, which can all be in electronic communication with each other. For example, the one or more processors 1677 can be configured to execute instructions stored in the memory 1678, which can cause a controller of the one or more controllers 1675 to cause operations to be performed at one or more peripheral devices of the peripherals interface 1650. In some embodiments, each operation described can occur based on electrical power provided by the power system 1695.

In some embodiments, the peripherals interface 1650 can include one or more devices configured to be part of the computing system 1640, many of which have been defined above and/or described with respect to wrist-wearable devices shown in FIGS. 13A-15B. For example, the peripherals interface 1650 can include one or more sensors 1651, such as one or more pressure sensors 1652, one or more EMG sensors 1656, one or more IMU sensors 1658, one or more position sensors 1659, one or more capacitive sensors 1660, one or more force sensors 1661; and/or any other types of sensors defined above or described with respect to any other embodiments discussed herein. In some embodiments, the peripherals interface can include one or more additional peripheral devices including one or more WiFi and/or Bluetooth devices 1668; an LTE component 1669; a GPS component 1670; a microphone 1671; one or more haptic assemblies 1662; one or more support structures 1663 (which can include one or more bladders 1664; one or more manifolds 1665; one or more pressure-changing devices 1667; one or more displays 1672; one or more buttons 1673; one or more speakers 1674; and/or any other types of peripheral devices defined above or described with respect to any other embodiments discussed herein. In some embodiments, computing system 1640 includes more or less components that those shown in FIG. 16C.

In some embodiments, each haptic assembly 1662 includes a support structure 1663, and at least one bladder 1664. The bladder 1664 (e.g., a membrane) is a sealed, inflatable pocket made from a durable and puncture resistance material, such as thermoplastic polyurethane (TPU), a flexible polymer, or the like. The bladder 1664 contains a medium (e.g., a fluid such as air, inert gas, or even a liquid) that can be added to or removed from the bladder 1664 to change a pressure (e.g., fluid pressure) inside the bladder 1664. The support structure 1663 is made from a material that is stronger and stiffer than the material of the bladder 1664. A respective support structure 1663 coupled to a respective bladder 1664 is configured to reinforce the respective bladder 1664 as the respective bladder changes shape and size due to changes in pressure (e.g., fluid pressure) inside the bladder. The haptic assembly 1662 can include an array of individually controlled electrohydraulic-controlled haptic tactors and each electrohydraulic-controlled haptic tactor described above in reference to FIGS. 1A-11.

The haptic assembly 1662 provides haptic feedback (i.e., haptic stimulations) to the user by applying or removing a force applied to a portion of the user's body (e.g., percussion force on the user's finger). Alternatively, or in addition, the haptic assembly 1662 provides haptic feedback to the user by forcing a portion of the user's body (e.g., hand) to move in certain ways and/or preventing the portion of the user's body from moving in certain ways. To accomplish this, the haptic assembly 1622 is configured to apply a force that counteracts movements of the user's body detected by the sensors 914, increasing the rigidity of certain portions of the device 920, or some combination thereof.

The haptic assemblies 1662 described herein are configured to transition between two or more states (e.g., a first pressurized state and a second pressurized state) to provide haptic feedback to the user. Due to the various applications, the haptic assemblies 1662 may be required to transition between the two or more states hundreds, or perhaps thousands of times, during a single use. Thus, the haptic assemblies 1622 described herein are durable and designed to quickly transition from state to state. As an example, in the first pressurized state, the haptic assemblies 922 do not impede free movement of a portion of the wearer's body. For example, one or more haptic assemblies 1622 incorporated into a wearable glove 410 are made from flexible materials that do not impede free movement of the wearer's hand and fingers (e.g., the array of EC haptic tactors 100, shown in FIGS. 1A-8, and is made from a flexible polymer). The haptic assemblies 1622 are configured to conform to a shape of the portion of the wearer's body when in the first pressurized state. However, once in the second pressurized state, the haptic assemblies 1622 are configured to impede free movement of the portion of the wearer's body. For example, the respective haptic assembly 1622 (or multiple respective haptic assemblies) can restrict movement of a wearer's finger (e.g., prevent the finger from curling or extending) when the haptic assembly 1622 is in the second pressurized state. Moreover, once in the second pressurized state, the haptic assemblies 1622 may take different shapes, with some haptic assemblies 1622 configured to take a planar, rigid shape (e.g., flat and rigid), while some other haptic assemblies 1622 are configured to curve or bend, at least partially.

The above example haptic assembly 1662 is non-limiting. The haptic assembly 1662 can include eccentric rotating mass (ERM), linear resonant actuators (LRA), voice coil motor (VCM), piezo haptic actuator, thermoelectric devices, solenoid actuators, ultrasonic transducers, thermo-resistive heaters, Peltier devices, and/or other devices configured to generate a perceptible response.

The smart textile-based garment 1600 also includes a haptic controller 1676 and a pressure-changing device 1667. Alternatively, in some embodiments, the computing system 1640 is communicatively coupled with a haptic controller 1676 and/or pressure-changing device 1667 (e.g., in electronic communication with one or more processors 1677 of the computing system 1640). The haptic controller 1676 is configured to control operation of the pressure-changing device 1667, and in turn operation of the smart textile-based garments 1600. For example, the haptic controller 1676 sends one or more signals to the pressure-changing device 1667 to activate the pressure-changing device 1667 (e.g., turn it on and off) and/or causes an adjustment to voltages provided to a haptic assembly 1622. The one or more signals can specify a desired pressure (e.g., pounds-per-square inch) to be output by the pressure-changing device 1667. Generation of the one or more signals, and in turn the pressure output by the pressure-changing device 1667, can be based on information collected by sensors 1651 of the smart textile-based garment 1600 and/or other communicatively coupled device. For example, the haptic controller 1676 can provide one or more signals, based on collected sensor data, to cause the pressure-changing device 1667 to increase the pressure (e.g., fluid pressure) inside a first haptic assembly 1662 at a first time, and provide one or more additional signals, based on additional sensor data, to the pressure-changing device 1667 to cause the pressure-changing device 1667 to further increase the pressure inside a second haptic assembly 1662 at a second time after the first time. Further, the haptic controller 1676 can provide one or more signals to cause the pressure-changing device 1667 to inflate one or more bladders 1664 in a first portion of a smart textile-based garment 1600 (e.g., a first finger), while one or more bladders 1664 in a second portion of the smart textile-based garment 1600 (e.g., a second finger) remain unchanged. Additionally, the haptic controller 1676 can provide one or more signals to cause the pressure-changing device 1667 to inflate one or more bladders 1664 in a first smart textile-based garment 1600 to a first pressure and inflate one or more other bladders 1664 in the first smart textile-based garment 1600 to a second pressure different from the first pressure. Depending on the number of smart textile-based garments 1600 serviced by the pressure-changing device 1667, and the number of bladders therein, many different inflation configurations can be achieved through the one or more signals and the examples above are not meant to be limiting.

The smart textile-based garment 1600 may include an optional manifold 1665 between the pressure-changing device 1667, the haptic assemblies 1662, and/or other portions of the smart textile-based garment 1600. The manifold 1665 may include one or more valves (not shown) that pneumatically couple each of the haptic assemblies 1662 with the pressure-changing device 1667 via tubing. In some embodiments, the manifold 1665 is in communication with the controller 1675, and the controller 1675 controls the one or more valves of the manifold 1665 (e.g., the controller generates one or more control signals). The manifold 1665 is configured to switchably couple the pressure-changing device 1667 with one or more haptic assemblies 1662 of the smart textile-based garment 1600. In some embodiments, one or more smart textile-based garment 1600 or other haptic devices can be coupled in a network of haptic device and the manifold 1665 can distribute the fluid between the coupled smart textile-based garments 1600.

In some embodiments, instead of using the manifold 1665 to pneumatically couple the pressure-changing device 1667 with the haptic assemblies 1662, the smart textile-based garment 1600 may include multiple pressure-changing devices 1667, where each pressure-changing device 1667 is pneumatically coupled directly with a single (or multiple) haptic assembly 1662. In some embodiments, the pressure-changing device 1667 and the optional manifold 1665 can be configured as part of one or more of the smart textile-based garments 1600 (not illustrated) while, in other embodiments, the pressure-changing device 1667 and the optional manifold 1665 can be configured as external to the smart textile-based garments 1600. In some embodiments, a single pressure-changing device 1667 can be shared by multiple smart textile-based garment 1600 or other haptic devices. In some embodiments, the pressure-changing device 1667 is a pneumatic device, hydraulic device, a pneudraulic device, or some other device capable of adding and removing a medium (e.g., fluid, liquid, gas) from the one or more haptic assemblies 1662.

The memory 1678 includes instructions and data, some or all of which may be stored as non-transitory computer-readable storage media within the memory 1678. For example, the memory 1678 can include one or more operating systems 1679; one or more communication interface applications 1681; one or more interoperability modules 1684; one or more AR processing applications 1685; one or more data management modules 1686; and/or one or more haptics modules 1687 for determining, generating, and provided instructions for causing the performance of a haptic response; and/or any other types of data defined above or described with respect to FIGS. 13A-15B. The haptics modules 1687 is configured to cause the performance of the different haptic responses shown and described above in reference to FIG. 1A-9.

The one or more haptics modules 1687 receive data from one or more components, applications, and/or modules of the smart textile-based garment 1600 and/or any other communicatively coupled device (e.g., wrist-wearable device 1300, AR device 1400, VR device 1410, and/or any other devices described above in reference to FIGS. 12A-12D-2 and determine a type of haptic feedback (e.g., vibration, tactile, auditory, thermal, etc.), characteristics of the haptic feedback (e.g., frequency, duration, magnitude, pattern, etc.), and/or a device to perform the haptic feedback (e.g., the haptic assemblies 1662 of the smart textile-based garment 1600 or the haptic assemblies or haptic devices of other communicatively coupled devices). For example, the haptics modules 1687 can receive data related to a virtual object presented, via a head-wearable device, on a user's hand and cause an array of individually controlled electrohydraulic-controlled haptic tactors 100 (a type of haptic assembly 1662) to generate a haptic response in accordance with the virtual object's movements on the user's hand. In some embodiments, the one or more haptics modules 1687 generate audio cues that mirror the user's movements. For example, if the user moves their head to the left towards an area of interest (e.g., a location in a map application), the one or more haptics modules 1687 can cause a communicatively coupled device to provide audio feedback to the user. Additionally, the one or more haptics modules 1687 can provide instructions to generate haptic feedback to simulate an AR environment. For example, an AR application can provide data to the one or more haptics modules 1687 indicating that the user has closed his fingers around a position corresponding to a coffee mug in the artificial environment and raised his hand, and the one or more haptics modules 1687 can provide instructions for generating haptic feedback that simulate contact with the artificial coffee mug (e.g., only allowing the user's fingers to squeeze up to a circumference of the artificial coffee mug), movement of the artificial coffee mug (e.g., velocity, height, collision, etc.), and the weight of the artificial coffee mug.

The memory 1678 also includes data 1688 which can be used in conjunction with one or more of the applications discussed above. The data 1688 can include device data 1690; sensor data 1691; haptics data 1694; and/or any other types of data defined above or described with respect to FIGS. 13A-15B. The haptics data 1694 can include one or more stored haptic feedback responses, functions or models for generating a haptic feedback, machine learning systems for generating a haptic feedback, user preferences in haptic feedback (e.g., no vibration, vibration only, etc.), haptic assembly 1662 data (e.g., types of haptic assemblies 1662, number of available, position of the haptic assemblies 1662, etc.). The haptics data 1694 can also store data related to the performance of the features described above in reference to FIGS. 1A-9.

The different components of the computing system 1640 (and the smart textile-based garment 1600) shown in FIGS. 16A-16C can be coupled via a wired connection (e.g., via busing). Alternatively, one or more of the devices shown in FIGS. 16A-16C may be wirelessly connected (e.g., via short-range communication signals).

### Example System for Knitting Smart Textile-Based Garments

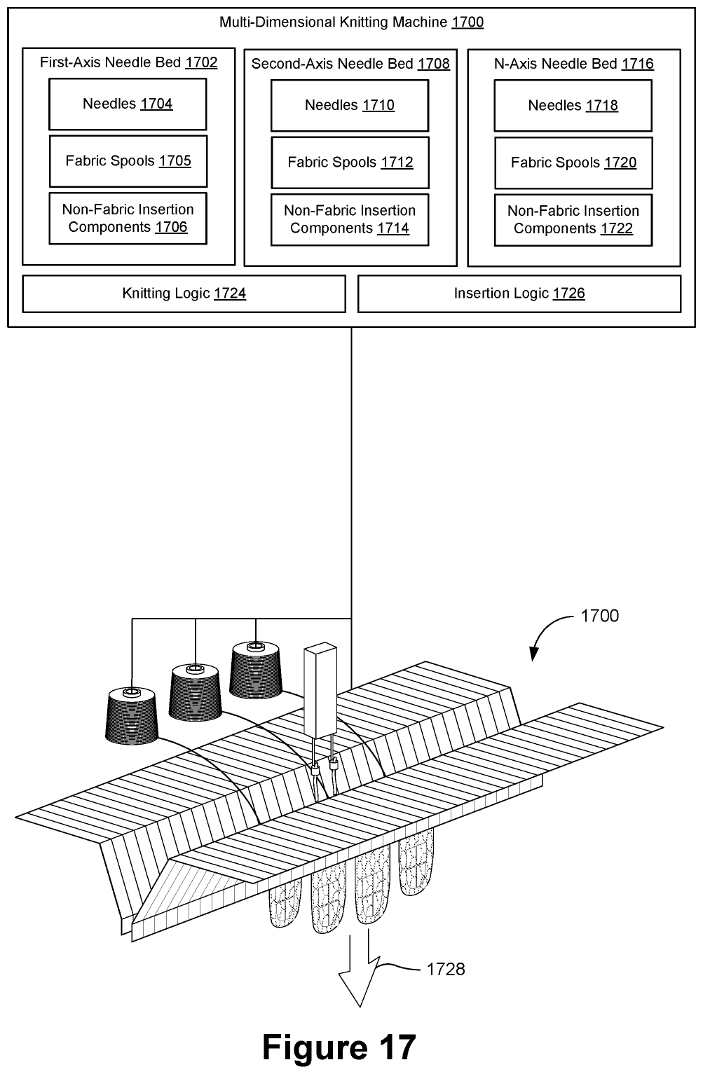

Attention is now directed to FIG. 17, which illustrates a multi-dimensional knitting machine configured to produce multi-dimensional knitted garments in an automated fashion (e.g., with the needing for any hand knitting or other user intervention after initiating the knitting process, including allowing for having an electronic component automatically knitted as an integrated component of the multi-dimensional knitted garments), in accordance with some embodiments. The multi-dimensional knitting machine 1700 is a garment-producing device that is computer controlled and user programmable to allow for complex knitted structures to be produced (e.g., smart textile-based garments 1600 (FIGS. 16A-16C); such as gloves, tubular fabrics, fabrics with embedded electronic devices, complex knit patterns, special stretch characteristics, unique pattern structures, multi-thread structures, etc.). The multi-dimensional knitting machine 1700 includes a first-axis needle bed 1702, a second-axis needle bed 1708, and N-axis needle bed (indicating more than three needle beds are possible). Each one of these needle beds (e.g., needles 1704, needles 1710, and needles 1718) is configured to use multiple different types of knit patterns (e.g., jersey knits, rib knits, interlock knits, French-terry knits, fleece knits, etc.) based on a programmed sequence providing to the multi-dimensional knitting machine 1700, and variations of these knits can be employed to form a single continuous garment (e.g., a combination of jersey knits and French terry knit and/or a first variation of a jersey knit and a second variation of a jersey knit). In some embodiments, the variations of these knits in a single continuous garment can be done without producing seams (e.g., a seamless wearable device can be produced). In some embodiments, the knitting machine is further configured to layer fabrics to produce multilayered wearable structures (e.g., to house one or more electronic components). In some embodiments, each layer in a multilayered wearable structure can be made from a different fabric, which in one example is produced using a conductive yarn. For example, a two-layer knitted capacitive sensor can be produced using the multi-dimensional knitting machine 1700, where the first layer and the second layer use different thread (e.g., a coated-conductive thread and an uncoated-conductive thread). A plurality of fabric spools (e.g., fabric spools 1705, fabric spools 1712, and fabric spools 1720) can be included for each one of the needle beds. Multiple types of fabric spools can be used for each needle bed allowing for even more complex woven structures (also referred to as garments) to be produced. In some embodiments, the fabric spools can also include elastic thread allowing for stretchable fabrics and/or fabrics with shape memory to be produced.

Each of the needle beds discussed above can also include one or more non-fabric insertion components (e.g., non-fabric insertion components 1706, non-fabric insertion components 1714, and non-fabric insertion components 1722) that are configured to be used to allow for insertion of non-fabric structures into the needle beds, such that the non-knitted structure can be knitted into the knitted structure, while the knitted structure (e.g., garment) is being produced. For example, non-fabric structures can include flexible printed circuit boards, rigid circuit boards, conductive wires, structural ribbing, sensors (e.g., neuromuscular signal sensors, light sensors, PPG sensors, etc.), etc. In some embodiments, a stitch pattern can be adjusted by the multi-dimensional knitting machine (e.g., in accordance with a programmed sequence of knit instructions provided to the machine) to accommodate these structures, which, in some embodiments, means that these structures are knitted into the fabric, instead of being sewn on top of a knitted fabric. This allows for garments to be lighter, thinner, and more comfortable to wear (e.g., by having fewer protrusions applying uneven pressure to the wearer's skin). In some embodiments, these multi-dimensional knitting machines can also knit knitted structures along either or both of a vertical axis or a horizontal depending on desired characteristics of the knitted structure. Knitting along a horizontal axis means that the garment would be produced from a left side to a right side (e.g., a glove would be produced starting with the pinky finger, then moving to the ring finger, then middle finger, etc. Sewing on the vertical means that the garment is produced in a top-down fashion (e.g., a glove would be produced starting from the top of the tallest finger and move down to the wrist portion of the glove (e.g., as shown by 1728 in FIG. 17)). With respect to the glove examples, a reverse manufacturing process is also contemplated (e.g., knitting a thumb first when knitting on the horizontal and knitting the wrist portions when knitting on the vertical). In some embodiments, the insertion component can feed the non-knitted structure to the knitting machine or, in some other embodiments, the insertion component is fed through the knitting machine with the non-knitted structure. In the latter, the insertion component is not integrated into the garment and is discarded. In some embodiments, the insertion component is not fed at all, but is an integrated component of the multi-dimensional knitting machine that is activated based on a programming knit sequence to then allow for insertion of a non-knitting component into a knitted structure.

The multi-dimensional knitting machine 1700 also includes knitting logic module 1724, which is a module that is user programmable to allow for a user (which can be a manufacturing entity producing wearable structures on mass scale) to define a knitting sequence to produce a garment using any of the above-described materials, stitch patterns, knitting techniques, etc. As stated above, the knitting logic module 1724 allows for a seamless combination of any of the above-described techniques, thereby allowing unique complex knitted structures to be produced in a single knitting sequence (e.g., the user does not need to remove the knitted structure, then reinsert and reorient it to complete knitting the knitted structure). The multi-dimensional knitting machine 1700 also includes insertion logic module 1726, which works in tandem with the knitting logic module 1724, to allow for insertion of non-fabric components to be seamlessly inserted into the knitted structure while the knitted structure is knitted together. The insertion logic is in communication with the knitting logic to allow for the knit to be adjusted in accordance with where the non-fabric structure is being inserted. In some embodiments, the user need only show where the non-fabric structure is to be inserted in their mock-up (e.g., at a user interface associated with the multi-dimensional knitting machine, which user interface allows for creating and editing a programmed knit sequence) and the knitting logic module 1724 and insertion logic module 1726 automatically work together to allow for the knitted structure to be produced.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt-in or opt-out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

### EXAMPLE ASPECTS

A few example aspects will now be briefly described.

(A1) In accordance with some embodiments, a wearable device for generating a haptic response is disclosed. The wearable device includes a wearable structure configured to be worn by a user, and an array of electrohydraulic-controlled (EC) haptic tactors coupled to a portion of wearable structure. Each EC haptic tactor of the array of EC haptic tactors is in fluid communication with an actuator pouch filled with a dielectric substance (e.g., as illustrated in FIG. 1A-1D). A first end of the actuator pouch is positioned between at least two opposing electrodes that, when provided a voltage, create an electrostatic force that attracts the at least two opposing electrodes closing the first end of the actuator pouch and driving a portion of the dielectric substance to a second end of the actuator pouch opposite the first end via an intermediary portion of the actuator pouch (e.g., as illustrated in FIGS. 1A-1D and 2A). The intermediary portion of the actuator pouch fluidically couples the first and second ends of the actuator pouch and the second end of the actuator pouch is coupled with the EC haptic tactor, such that movement of the dielectric substance to the second end of the actuator pouch is configured to cause the EC haptic tactor to expand a predetermined amount (e.g., as illustrated in FIGS. 1A-1D). The wearable device further includes a power source for providing the voltage to the at least two opposing electrodes, and circuitry configured to provide instructions for generating a haptic response by expanding one or more of the EC haptic tactors of the array of EC haptic tactors.

(A2) In some embodiments of A1, the intermediary portion includes a semi-rigid tube forming a channel for the dielectric substance to move between the first and second ends of the actuator pouch. FIGS. 1A-1E illustrates the dielectric substance moving through the semi-rigid tube.

(A3) In some embodiments of A2, the semi-rigid tube is formed of elastomer as described in FIGS. 1A-1E.

(A4) In some embodiments of any one of A2 and A3, the semi-rigid tube has 300 μm inner diameter and 600 μm outer diameter as described in FIGS. 1A-1E.

(A5) In some embodiments of any one of A1-A4, the wearable device is a wearable glove, and the portion of the wearable structure to which the array of EC haptic tactors is coupled to is a finger of the wearable glove that is configured to contact a user's finger, as illustrated in 3A-4F. For each actuator pouch fluidically coupled to an EC haptic tactor, the second end of the actuator pouch is configured to couple adjacent to a respective portion of a finger pad of the user's finger, the intermediary portion of the actuator pouch is configured to couple adjacent to a respective portion of a side portion of the user's finger, and the first end of the actuator pouch is configured to couple adjacent to a respective portion of a top portion of the user's finger opposite the finger pad (e.g., fingernail). For example, as described above in reference to FIGS. 3A-3C, the bladder or reservoir of each EC haptic tactor is configured to be adjacent to a user's fingernail, and the expandable surface of each EC haptic tactor is configured to be placed adjacent to the user's finger pad. The intermediary portion of the EC haptic tactor allows for the dielectric substance to move between the reservoir and the finger pad without interference.

(A6) In some embodiments of any one of A1-A5, each EC haptic tactor of the array of EC haptic tactors applies a respective perceptible percussion force at distinct portion of wearable structure when the voltage is provided. For example, as illustrated in 4A-4F as the fairy dances on the tip of the users finger in virtual reality, the EC haptic tactors apply percussion forces at different portions of the user's finger tips that correspond with the movements of the fairy.

(A7) In some embodiments of any one of A1-A6, each EC haptic tactor of the array of EC haptic tactors applies a respective perceptible vibration force at distinct portion of wearable structure when the voltage is provided. For example, as shown in FIGS. 4A-4F, as the fairy moves around the users finger in virtual reality, the EC haptic tactors can provide vibrations that correspond with the fairy's movements.

(A8) In some embodiments of A7, the respective perceptible vibration force is between 200 to 300 Hz, as described in FIGS. 1A-8.

(A9) In some embodiments of any one of A1-A8, the predetermined amount is a height between 0 mm to 2 mm, as described in FIGS. 1A-8.

(A10) In some embodiments of any one of A1-A9, an expandable surface has a predetermined diameter between 0.2 mm to 0.6 mm, wherein the expandable surface is a portion of the second end that is expanded the predetermined amount, as described in FIGS. 1A-1E.

(A11) In some embodiments of A10, the expandable surface has a predetermined diameter between 0.6 mm to 1 mm, as described in FIGS. 1A-1E.

(A12) In some embodiments of A11, the expandable surface has a predetermined diameter between 1 mm to 1.5 mm, as described in FIGS. 1A-1E.

(A13) In some embodiments of any one of A1-A12, each respective EC haptic tactor of the array of electrohydraulic-controlled haptic tactors is separated by a predetermined distance from an adjacent EC haptic tactor of the array of electrohydraulic-controlled haptic tactors, as illustrated in FIGS. 2A-2B.

(A14) In some embodiments of A13, the predetermined distance is substantially the same as a predetermined diameter of an expandable surface, as described in FIGS. 1A-1E.

(A15) In some embodiments of any one of A13, the predetermined distance is a center-to-center distance between 0.3 mm to 0.5 mm, as described in FIGS. 1A-1E.

(A16) In some embodiments of A15, the predetermined distance is a center-to-center distance between 0.5 mm to 1 mm, as described in FIGS. 1A-1E.

(A17) In some embodiments of A16, the predetermined distance is a center-to-center distance between 1 mm to 2 mm. Additional examples of the separation distance between the expandable surfaces of the EC haptic tactors 110 are provided above in reference to FIGS. 1A-7.

(A18) In some embodiments of any one of A1-A17, the array of EC haptic tactors has an area of 1 cm2, as described in FIGS. 1A-1E.

(A19) In some embodiments of any one of A1-A18, the array of EC haptic tactors includes a first layer of EC haptic tactors including a first predetermined number of EC haptic tactors and a second layer EC haptic tactors including a second predetermined number of EC haptic tactors. The second layer EC haptic tactors is overlayed over the first layer EC haptic tactors and respective second ends of the actuator pouches of the first and second layers of EC haptic tactors are positioned in a first direction. For example, as shown in FIGS. 1A-2C, the expandable surfaces of the EC haptic tactors are adjacent to one another (e.g., towards a center portion of the array of EC haptic tactors 100).

(A20) In some embodiments of A19, the first and second predetermined number of EC haptic tactors are the same. Alternatively, in some embodiments, the first and second predetermined number of EC haptic tactors are distinct. For example, FIGS. 1A, and 2A-2B show an equal number of EC haptic tactors.

(A21) In some embodiments of any one of A19-A20, the first layer of EC haptic tactors and the second layer of EC haptic tactors are offset such that the respective second ends of the actuator pouches of the EC haptic tactors do not overlap. FIGS. 1A, and 2A-2B illustrate the first and second layers of EC haptic tactors and how they are offset.

(A22) In some embodiments of any one of A1-A21, the array of EC haptic tactors includes a third layer of EC haptic tactors including a third predetermined number of EC haptic tactors and a fourth layer EC haptic tactors including a fourth predetermined number of EC haptic tactors. The fourth layer EC haptic tactors is overlaid over the third layer EC haptic tactors and respective second ends of the actuator pouches of the third and fourth layers of EC haptic tactors are positioned in a second direction adjacent to and opposite the first direction. FIGS. 2A and 2B illustrate an example of multiple layers of EC haptic tactors.

(A23) In some embodiments of any one of A18-A22, the array of EC haptic tactors is a first array of EC haptic tactors coupled to a first portion of wearable structure, and the wearable device further includes a second array of EC haptic tactors coupled to a second portion of wearable structure. For example, there are one or more arrays of EC haptic tactors coupled to the wearable structure as illustrated in FIGS. 1A-2B.

(A24) In some embodiments of any one of A1-A23, the wearable device is a wearable glove, as illustrated in FIGS. 4A-4F.

(A25) In some embodiments of A24, the first portion of wearable structure to which the first array of EC haptic tactors is coupled to is a first finger of the wearable glove that is configured to contact a user's first finger, and the second portion of wearable structure to which the second array of EC haptic tactors is coupled to is a second finger of the wearable glove that is configured to contact a user's second finger. For example as shown in FIGS. 1A-4F,

(A26) In some embodiments of any one of A1-A25, each EC haptic tactor of the array of EC haptic tactors is individually controlled by the circuitry. For example, each respective EC haptic tactors can be controlled individually or multiple EC haptic tactors can be controlled at once as described in FIGS. 1A-4E.

(A27) In some embodiments of any one of A1-A26, the circuitry is configured to adaptively adjust a voltage provided to the at least two opposing electrodes based on user participation in an artificial-reality environment and/or instructions received via an intermediary device. For example, as shown in FIGS. 4A-4F via the head-wearable device the user is interacting with an artificial-reality environment and based on the user's interaction with the fairy, the voltage provided to the two opposing electrodes is adjusted.

(A28) In some embodiments of any one of A1-A27, the circuitry is configured to, while a voltage is provided to the at least two opposing electrodes, detect a force applied to the EC haptic tactor and adjust the voltage provided to the at least two opposing electrodes based on force applied to the EC haptic tactor. In some embodiments, the circuitry is configured to detect a force applied to each EC haptic tactor of the array of EC haptic tactors. The circuitry is configured to individually adjust a voltage provided to each of the EC haptic tactors. For example.

(A29) In some embodiments of any one of A1-A28, the circuitry is configured to, while a voltage is provided to the at least two opposing electrodes, detect a force applied to the EC haptic tactor and, in response to detecting a force applied to the EC haptic tactor, cause an input command to be performed at a communicatively coupled intermediary device or in an artificial-reality environment.

(A30) In some embodiments of any one of A1-A29, the voltage is independently adjustable at each of the at least two opposing electrodes to cause changes in the haptic response provided to a user.

(A31) In some embodiments of any one of A1-A30, the array of EC haptic tactors includes at least at least two EC haptic tactors.

(A32) In some embodiments of any one of A1-A31, the array of EC haptic tactors includes at least at least four EC haptic tactors.

(A33) In some embodiments of any one of A1-A32, the array of EC haptic tactors includes at least at least eight EC haptic tactors.

(A34) In some embodiments of any one of A1-A33, the array of EC haptic tactors includes at least at least sixteen EC haptic tactors.

(A35) In some embodiments of any one of A1-A34, the voltage is at least 3 kV.

(A36) In some embodiments of any one of A1-A35, the voltage is at least 5 kV

(A37) In some embodiments of any one of A1-A36, the voltage is no more than 10 kV.

(A37) In some embodiments of any one of A1-A36, the wearable device further includes one or more conductors coupling the at least two opposing electrodes to the power source. The one or more conductors are configured to carry at least a voltage from the power source to the EC haptic tactors of the array of EC haptic tactors.

(B1) In accordance with some embodiments, a method of generating a haptic response at a wearable device is disclosed. The method includes, at wearable device including a wearable structure configured to be worn by a user; an array of EC haptic tactors coupled to a portion of wearable structure; a power source; and circuitry, receiving instructions for actuating an EC haptic tactor of the array of EC haptic tactors. The method further includes, responsive to the instructions for actuating the EC haptic tactor, causing, via the circuitry, the power source to provide a voltage to the EC haptic tactor such that the EC haptic tactor generates a haptic response.

(B2) In some embodiments of B1, the array of EC haptic tactors and the EC haptic tactors are configured in accordance with any one of A1-A37.

(C1) In accordance with some embodiments, a method of manufacturing an array of EC haptic tactors for generating haptic responses is disclosed. The method includes providing a first layer of material including one or more circular cutouts, coupling an elastic layer of material to a first side of the first layer of material, providing a second layer of material, and coupling, in part, the first layer of material to the second layer of material via a second side of the first layer of material opposite the first side to form an actuator pouch. The method further includes filling the actuator pouch with a dielectric substance; sealing the actuator pouch; coupling at least two opposing electrodes to opposite sides of a first end of the actuator pouch, the first end of the actuator pouch opposite a second end that includes the elastic layer of material; and coupling respective isolation layers over the at least two opposing electrodes.

(C2) In some embodiments of C1, the array of EC haptic tactors and the EC haptic tactors are configured in accordance with any one of A1-A37.

(D1) In accordance with some embodiments, a method of manufacturing a wearable device for generating a haptic response is disclosed. The method includes providing a wearable structure configured to be worn by a user; coupling an array of EC haptic tactors coupled to a portion of wearable structure. Each EC haptic tactor is in fluid communication with an actuator pouch filled with a dielectric substance. A first end of the actuator pouch is positioned between at least two opposing electrodes that, when provided a voltage, create an electrostatic force that attracts the at least two opposing electrodes closing the first end of the actuator pouch and driving a portion of the dielectric substance to a second end of the actuator pouch opposite the first end via an intermediary portion of the actuator pouch. The intermediary portion of the actuator pouch fluidically couples the first and second ends of the actuator pouch and the second end of the actuator pouch is coupled with the electrohydraulic-controlled haptic tactor, such that movement of the dielectric substance to the second end of the actuator pouch is configured to cause the electrohydraulic-controlled haptic tactor to expand a predetermined amount. The method further includes coupling a power source to the wearable structure and the at least two opposing electrodes and coupling circuitry to the power source. The power source is configured to provide the voltage to the at least two opposing electrodes, and the circuitry configured to receive and provide instructions for generating a haptic response.

(D2) In some embodiments of D1, the array of EC haptic tactors and the EC haptic tactors are configured in accordance with any one of A2-A37.

(E1) In accordance with some embodiments, a system of providing haptic responses is disclosed. A system includes (i) a wearable glove having the electrostatically-controlled haptic tactors of any one of A1-A37 and a (ii) virtual-reality or augmented-reality headset, wherein the system is configured to generate haptic feedback via the electrostatically-controlled haptic tactors of the wearable glove in response to determinations that a user's hand is near or holding virtual or augmented objects presented via the virtual-reality or augmented-reality headset.

(F1) In accordance with some embodiments, a wearable device for generating a haptic response is disclosed. The wearable device includes a wearable structure configured to be worn by a user and an array of individually controlled electrohydraulic-controlled haptic tactors coupled to a portion of the wearable structure. Each electrohydraulic-controlled haptic tactor is in fluid communication with an actuator pouch filled with a dielectric substance. A first end of the actuator pouch is positioned between at least two opposing electrodes that, when provided a voltage, are actuated to drive a portion of the dielectric substance within the actuator pouch, an intermediary portion of the actuator pouch fluidically couples a first end and a second end of the actuator pouch, and the second end of the actuator pouch is coupled with the electrohydraulic-controlled haptic tactor, such that movement of the dielectric substance to the second end of the actuator pouch is configured to cause the electrohydraulic-controlled haptic tactor to generate a haptic response. The wearable device includes a power source for providing the voltage to the at least two opposing electrodes circuitry configured to provide instructions for generating the haptic response. The electrohydraulic-controlled haptic tactor of the array of individually controlled electrohydraulic-controlled haptic tactors is discussed detail above in reference to FIGS. 1A-3C. Additionally, the electrohydraulic-controlled haptic tactor of the array of individually controlled electrohydraulic-controlled haptic tactors is configured in accordance with any one of A1-A37. Additional examples of haptic responses are provided above in reference to FIGS. 4A-4F.

(F2) In some embodiments of F1, the intermediary portion includes a semi-rigid tube forming a channel for the dielectric substance to move between the first and second ends of the actuator pouch. The intermediary portion is described above in reference to FIGS. 1A-1E.

(F3) In some embodiments of any one of F1-F2, each electrohydraulic-controlled haptic tactor of the array of individually controlled electrohydraulic-controlled haptic tactors applies a respective perceptible percussion force at distinct portion of wearable structure when the voltage is provided. Examples of the different forces provided by the array of individually controlled electrohydraulic-controlled haptic tactors are provided above in reference to FIG. 4A-4F.

(F4) In some embodiments of any one of F1-F3, the wearable device is a wearable glove and the portion of the wearable structure to which the array of individually controlled electrohydraulic-controlled haptic tactors is coupled to is a finger of the wearable glove that is configured to contact a user's finger. For each actuator pouch fluidically coupled to the electrohydraulic-controlled haptic tactor the second end of the actuator pouch is configured to couple adjacent to a respective portion of a finger pad of the user's finger. The intermediary portion of the actuator pouch is configured to couple adjacent to a respective portion of a side portion of the user's finger and the first end of the actuator pouch is configured to couple adjacent to a respective portion of a top portion of the user's finger opposite the finger pad. For example, as shown and described above in reference to FIGS. 3A-4F, each finger of the wearable glove can include an array of individually controlled electrohydraulic-controlled haptic tactors coupled thereto.

(F5) In some embodiments of F4, the array of individually controlled electrohydraulic-controlled haptic tactors is a first array of individually controlled electrohydraulic-controlled haptic tactors coupled to a first portion of wearable structure. The first portion of wearable structure is a first finger of the wearable glove that is configured to contact a user's first finger. The wearable device further includes a second array of individually controlled electrohydraulic-controlled haptic tactors coupled to a second portion of wearable structure wherein the second portion of wearable structure is a second finger of the wearable glove that is configured to contact a user's second finger. For example, as described above in reference to FIGS. 4A-4F, each finger of wearable glove can include an array of individually controlled electrohydraulic-controlled haptic tactors.

(F6) In some embodiments of any one of F1-F5, the circuitry is configured to adaptively adjust the voltage provided to the at least two opposing electrodes based on user participation in an artificial-reality environment and/or instructions received via an intermediary device. For example, as described above in reference to FIGS. 4A-4F, as a virtual object moves around the user's finger, the instructions received by the wearable glove device from the head-wearable device and/or a handheld intermediary processing device can cause the wearable glove adjust a voltage provided to an array of individually controlled electrohydraulic-controlled haptic tactors.

(F7) In some embodiments of any one of F1-F6, while the voltage is provided to the at least two opposing electrodes, the circuitry is configured to detect a force applied to the electrohydraulic-controlled haptic tactor. The circuitry, in response to detecting the force applied to the electrohydraulic-controlled haptic tactor adjusts the voltage provided to the at least two opposing electrodes based on the force applied to the electrohydraulic-controlled haptic tactor, and causes an input command to be performed at a communicatively coupled intermediary device or in an artificial-reality environment. For example, as described above in reference to FIGS. 4A-4F, when the user interacts with an artificial-reality environment, forces applied to a haptic tactor can be detected and the wearable device can cause the performance of a command based on the detected force.

(G1) In accordance with some embodiments, a system including a wearable glove and a head-wearable device is disclosed. The system is configured to, when the wearable glove and the head-wearable device are worn, while displaying a virtual object on a display of the head-wearable device, in response to receiving, at the wearable glove that is in communication with the head-wearable device, instructions to provide haptic feedback to a user via an electrohydraulic-controlled haptic tactor of an array of individually controlled electrohydraulic-controlled haptic tactors coupled to a portion of the wearable glove, causing, the electrohydraulic-controlled haptic tactor to generate a haptic response. For example, as shown and described above in reference to FIGS. 4A-4F, a virtual object is displayed in an AR environment via the head-wearable device and the wearable gloves produce haptic feedback based on the movements of the virtual object. Causing the electrohydraulic-controlled haptic tactor to generate the haptic response includes providing a voltage to at least two opposing electrodes of an actuator pouch filled with a dielectric substance. The at least two opposing electrodes are coupled to an exterior portion of the actuator pouch such that a first end of the actuator pouch, positioned between the at least two opposing electrodes, drives a portion of the dielectric substance within the actuator pouch when the voltage is provided to the at least two opposing electrodes, an intermediary portion of the actuator pouch fluidically coupled to the first end and a second end of the actuator pouch allows the portion of the dielectric substance to travel between the first end and the second end, and the second end of the actuator pouch, coupled with the electrohydraulic-controlled haptic tactor, causes the electrohydraulic-controlled haptic tactor to generate the haptic response in response to movement of the dielectric substance to the second end of the actuator pouch. The electrohydraulic-controlled haptic tactor of the array of individually controlled electrohydraulic-controlled haptic tactors is discussed detail above in reference to FIGS. 1A-3C. Additionally, the electrohydraulic-controlled haptic tactor of the array of individually controlled electrohydraulic-controlled haptic tactors is configured in accordance with any one of A1-A37. Additional examples of haptic responses are provided above in reference to FIGS. 4A-4F.

(G2) In some embodiments of G1, the intermediary portion includes a semi-rigid tube forming a channel for the dielectric substance to move between the first and second ends of the actuator pouch. The intermediary portion is shown and described above in reference to FIGS. 1A-1E.

(G3) In some embodiments of any one of G1-G2, the electrohydraulic-controlled haptic tactor of the array of individually controlled electrohydraulic-controlled haptic tactors applies a respective perceptible percussion force at distinct portion of the wearable glove when the voltage is provided to the at least two opposing electrodes. For example, as described above in reference to FIGS. 4A-4F, as a virtual object dances on the tip of a user's finger in an AR environment, the EC haptic tactors apply percussion forces at different portions of the user's finger tips that correspond with the movements of the virtual object.

(G4) In some embodiments of any one of G1-G3, the portion of the wearable glove to which the array of individually controlled electrohydraulic-controlled haptic tactors is coupled to is a finger of the wearable glove that is configured to contact a user's finger. For each actuator pouch fluidically coupled to the electrohydraulic-controlled haptic tactor, the second end of the actuator pouch is configured to couple adjacent to a respective portion of a finger pad of the user's finger, the intermediary portion of the actuator pouch is configured to couple adjacent to a respective portion of a side portion of the user's finger, and the first end of the actuator pouch is configured to couple adjacent to a respective portion of a top portion of the user's finger opposite the finger pad. For example, as shown and described above in reference to FIGS. 3A-4F, each finger of the wearable glove can include an array of individually controlled electrohydraulic-controlled haptic tactors coupled thereto.

(G5) In some embodiments of any one of G1-G4, the array of individually controlled electrohydraulic-controlled haptic tactors is a first array of individually controlled electrohydraulic-controlled haptic tactors coupled to a first finger of the wearable glove configured to contact a user's first finger. The wearable glove further includes a second array of individually controlled electrohydraulic-controlled haptic tactors coupled to a second finger of the wearable glove that is configured to contact a user's second finger. For example, each finger of the wearable glove can include an array or individually controlled electrohydraulic-controlled haptic tactors as described above in reference to FIGS. 4A-4F.

(G6) In some embodiments of any one of G1-G5, the system is configured to adaptively adjust the voltage provided to the at least two opposing electrodes based on user participation in an artificial-reality environment and/or instructions received via an intermediary device. For example, as shown and described above in reference to FIGS. 4A-4F, as a virtual object moves around the user's finger, the instructions received by the wearable glove device from the head-wearable device cause the wearable glove device to adjust voltages provided to an array of individually controlled electrohydraulic-controlled haptic tactors such that haptic feedback provided to the user is based on the user's participating in the artificial-reality environment (e.g., the adjusted voltages cause a change in the haptic feedback location, intensity, frequency, etc.). The wearable glove device can receive instructions from the head-wearable device or an intermediary device (e.g., a handheld intermediary processing device 1500; FIGS. 15A and 15B) coupled with the wearable glove device and/or the head-wearable device).

(G7) In some embodiments of G6, while the voltage is provided to the at least two opposing electrodes, the system is configured to detect a force applied to the electrohydraulic-controlled haptic tactor. The circuitry is further configured to, in response to detecting the force applied to the electrohydraulic-controlled haptic tactor, adjust the voltage provided to the at least two opposing electrodes based on the force applied to the electrohydraulic-controlled haptic tactor, and cause an input command to be performed at a communicatively coupled intermediary device or in an artificial-reality environment. For example, as described above in reference to FIGS. 4A-4F, user inputs, such as hand movements, finger presses, hand gestures, etc., can cause a communicatively coupled device to execute a command associated with the user input.

(H1) In some embodiments, a non-transitory computer-readable storage medium storing executable instructions for generating haptic responses via a wearable device is disclosed. The executable instructions stored in the non-transitory computer-readable storage medium, when executed by one or more processors of a wearable glove, cause the wearable glove to, in response to receiving instructions to provide haptic feedback to a user via an electrohydraulic-controlled haptic tactor of an array of individually controlled electrohydraulic-controlled haptic tactors coupled to a portion of the wearable glove, cause, the electrohydraulic-controlled haptic tactor to generate a haptic response. Causing the electrohydraulic-controlled haptic tactor to generate the haptic response includes providing a voltage to at least two opposing electrodes of an actuator pouch filled with a dielectric substance. The at least two opposing electrodes are coupled to an exterior portion of the actuator pouch such that a first end of the actuator pouch, positioned between the at least two opposing electrodes, drives a portion of the dielectric substance within the actuator pouch when the voltage is provided to the at least two opposing electrodes, an intermediary portion of the actuator pouch fluidically coupled to the first end and a second end of the actuator pouch allows the portion of the dielectric substance to travel between the first end and the second end, and the second end of the actuator pouch, coupled with the electrohydraulic-controlled haptic tactor, causes the electrohydraulic-controlled haptic tactor to generate the haptic response in response to movement of the dielectric substance to the second end of the actuator pouch. The electrohydraulic-controlled haptic tactor of the array of individually controlled electrohydraulic-controlled haptic tactors is discussed detail above in reference to FIGS. 1A-3C. Additionally, the electrohydraulic-controlled haptic tactor of the array of individually controlled electrohydraulic-controlled haptic tactors is configured in accordance with any one of A1-A37. Examples of haptic responses are provided above in reference to FIGS. 4A-4F.

(H2) In some embodiments of H1, the intermediary portion includes a semi-rigid tube forming a channel for the dielectric substance to move between the first and second ends of the actuator pouch. An example of the intermediary portion are described above in reference to FIGS. 1A-1E.

(H3) In some embodiments of any one of H1-H2, the electrohydraulic-controlled haptic tactor of the array of individually controlled electrohydraulic-controlled haptic tactors applies a respective perceptible percussion force at distinct portion of the wearable glove when the voltage is provided to the at least two opposing electrodes. For example, as described above in reference to FIGS. 4A-4F, as a virtual object dances on the tip of a user's finger in an AR environment, the EC haptic tactors apply percussion forces at different portions of the user's finger tips that correspond with the movements of the virtual object.

(H4) In some embodiments of any one of H1-H3, the array of individually controlled electrohydraulic-controlled haptic tactors is a first array of individually controlled electrohydraulic-controlled haptic tactors coupled to a first finger of the wearable glove, the first finger of the wearable glove being configured to contact a user's first finger. The wearable glove further includes a second array of individually controlled electrohydraulic-controlled haptic tactors coupled to a second portion of the wearable glove that is configured to contact a user's second finger. For example, as shown and described above in reference to FIGS. 3A-4F, each finger of the wearable glove can include an array of individually controlled electrohydraulic-controlled haptic tactors coupled thereto.

(H5) In some embodiments of any one of H1-H4, the executable instructions, when executed by the one or more processors of the wearable glove, further cause the wearable glove to adaptively adjust the voltage provided to the at least two opposing electrodes based on user participation in an artificial-reality environment and/or instructions received via an intermediary device. For example, as described above in reference to FIGS. 4A-4F, user interaction with an artificial-reality environment can cause a voltage to be adaptively adjusted such that different haptic feedback is provided to the user.

(H6) In some embodiments of H5, while the voltage is provided to the at least two opposing electrodes, the executable instructions, when executed by one or more processors of the wearable glove, cause the wearable glove to detect a force applied to the electrohydraulic-controlled haptic tactor. The executable instructions, when executed by one or more processors of the wearable glove, cause the wearable glove to in response to detecting the force applied to the electrohydraulic-controlled haptic tactor, adjust the voltage provided to the at least two opposing electrodes based on the force applied to the electrohydraulic-controlled haptic tactor, and cause an input command to be performed at a communicatively coupled intermediary device or in an artificial-reality environment. For example, as described above in reference to FIGS. 4A-4F, when the user interacts with the artificial-reality environment, the wearable glove detect an applied force, and cause the performance of a command at a communicatively coupled device and/or within the artificial-reality system.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A wearable device for generating a haptic response, the wearable device comprising: a wearable structure configured to be worn by a user;
an array of individually controlled electrohydraulic-controlled haptic tactors coupled to a portion of the wearable structure, each electrohydraulic-controlled haptic tactor being in fluid communication with:
an actuator pouch filled with a dielectric substance, wherein:
a first end of the actuator pouch is positioned between at least two opposing electrodes that, when provided a voltage, are actuated to drive a portion of the dielectric substance within the actuator pouch,
an intermediary portion of the actuator pouch fluidically couples a first end and a second end of the actuator pouch, and
the second end of the actuator pouch is coupled with the electrohydraulic-controlled haptic tactor, such that movement of the dielectric substance to the second end of the actuator pouch is configured to cause the electrohydraulic-controlled haptic tactor to generate a haptic response; and
a power source for providing the voltage to the at least two opposing electrodes; and
circuitry configured to provide instructions for generating the haptic response.

2. The wearable device of claim 1, wherein the intermediary portion includes a semi-rigid tube forming a channel for the dielectric substance to move between the first and second ends of the actuator pouch.

3. The wearable device of claim 1, wherein each electrohydraulic-controlled haptic tactor of the array of individually controlled electrohydraulic-controlled haptic tactors applies a respective perceptible percussion force at distinct portion of wearable structure when the voltage is provided.

4. The wearable device of claim 1, wherein:
the wearable device is a wearable glove; and
the portion of the wearable structure to which the array of individually controlled electrohydraulic-controlled haptic tactors is coupled to is a finger of the wearable glove that is configured to contact a user's finger, wherein, for each actuator pouch fluidically coupled to the electrohydraulic-controlled haptic tactor:
the second end of the actuator pouch is configured to couple adjacent to a respective portion of a finger pad of the user's finger,
the intermediary portion of the actuator pouch is configured to couple adjacent to a respective portion of a side portion of the user's finger, and
the first end of the actuator pouch is configured to couple adjacent to a respective portion of a top portion of the user's finger opposite the finger pad.

5. The wearable device of claim 4, wherein:
the array of individually controlled electrohydraulic-controlled haptic tactors is a first array of individually controlled electrohydraulic-controlled haptic tactors coupled to a first portion of wearable structure, wherein the first portion of wearable structure is a first finger of the wearable glove that is configured to contact a user's first finger; and
the wearable device further comprises a second array of individually controlled electrohydraulic-controlled haptic tactors coupled to a second portion of wearable structure wherein the second portion of wearable structure is a second finger of the wearable glove that is configured to contact a user's second finger.

6. The wearable device of claim 1, wherein the circuitry is configured to adaptively adjust the voltage provided to the at least two opposing electrodes based on user participation in an artificial-reality environment and/or instructions received via an intermediary device.

7. The wearable device of claim 1, wherein while the voltage is provided to the at least two opposing electrodes, the circuitry is configured to:
detect a force applied to the electrohydraulic-controlled haptic tactor; and
in response to detecting the force applied to the electrohydraulic-controlled haptic tactor:
adjust the voltage provided to the at least two opposing electrodes based on the force applied to the electrohydraulic-controlled haptic tactor, and
cause an input command to be performed at a communicatively coupled intermediary device or in an artificial-reality environment.

8. A system comprising:
a wearable glove; and
a head-wearable device,
wherein, when the wearable glove and the head-wearable device are worn, the system is configured to:
while displaying a virtual object on a display of the head-wearable device:
in response to receiving, at the wearable glove that is in communication with the head-wearable device, instructions to provide haptic feedback to a user via an electrohydraulic-controlled haptic tactor of an array of individually controlled electrohydraulic-controlled haptic tactors coupled to a portion of the wearable glove, causing, the electrohydraulic-controlled haptic tactor to generate a haptic response,
wherein causing the electrohydraulic-controlled haptic tactor to generate the haptic response includes:
providing a voltage to at least two opposing electrodes of an actuator pouch filled with a dielectric substance, wherein the at least two opposing electrodes are coupled to an exterior portion of the actuator pouch, such that:
a first end of the actuator pouch, positioned between the at least two opposing electrodes, drives a portion of the dielectric substance within the actuator pouch when the voltage is provided to the at least two opposing electrodes,
an intermediary portion of the actuator pouch fluidically coupled to the first end and a second end of the actuator pouch allows the portion of the dielectric substance to travel between the first end and the second end, and
the second end of the actuator pouch coupled with the electrohydraulic-controlled haptic tactor causes the electrohydraulic-controlled haptic tactor to generate the haptic response in response to movement of the dielectric substance to the second end of the actuator pouch.

9. The system of claim 8, wherein the intermediary portion includes a semi-rigid tube forming a channel for the dielectric substance to move between the first and second ends of the actuator pouch.

10. The system of claim 8, wherein the electrohydraulic-controlled haptic tactor of the array of individually controlled electrohydraulic-controlled haptic tactors applies a respective perceptible percussion force at distinct portion of the wearable glove when the voltage is provided to the at least two opposing electrodes.

11. The system of claim 8, wherein:
the portion of the wearable glove to which the array of individually controlled electrohydraulic-controlled haptic tactors is coupled to is a finger of the wearable glove that is configured to contact a user's finger, wherein, for each actuator pouch fluidically coupled to the electrohydraulic-controlled haptic tactor:
the second end of the actuator pouch is configured to couple adjacent to a respective portion of a finger pad of the user's finger,
the intermediary portion of the actuator pouch is configured to couple adjacent to a respective portion of a side portion of the user's finger, and
the first end of the actuator pouch is configured to couple adjacent to a respective portion of a top portion of the user's finger opposite the finger pad.

12. The system of claim 8, wherein:
the array of individually controlled electrohydraulic-controlled haptic tactors is a first array of individually controlled electrohydraulic-controlled haptic tactors coupled to a first finger of the wearable glove configured to contact a user's first finger; and
the wearable glove further comprises a second array of individually controlled electrohydraulic-controlled haptic tactors coupled to a second finger of the wearable glove that is configured to contact a user's second finger.

13. The system of claim 8, wherein the system is configured to adaptively adjust the voltage provided to the at least two opposing electrodes based on user participation in an artificial-reality environment and/or instructions received via an intermediary device.

14. The system of claim 13, wherein while the voltage is provided to the at least two opposing electrodes, the system is configured to:
detect a force applied to the electrohydraulic-controlled haptic tactor; and
in response to detecting the force applied to the electrohydraulic-controlled haptic tactor:
adjust the voltage provided to the at least two opposing electrodes based on the force applied to the electrohydraulic-controlled haptic tactor, and
cause an input command to be performed at a communicatively coupled intermediary device or in an artificial-reality environment.

15. A non-transitory computer-readable storage medium storing executable instructions that, when executed by one or more processors of a wearable glove, cause the wearable glove to: in response to receiving instructions to provide haptic feedback to a user via an electrohydraulic-controlled haptic tactor of an array of individually controlled electrohydraulic-controlled haptic tactors coupled to a portion of the wearable glove, cause, the electrohydraulic-controlled haptic tactor to generate a haptic response,
wherein causing, the electrohydraulic-controlled haptic tactor to generate the haptic response includes:
providing a voltage to at least two opposing electrodes of an actuator pouch filled with a dielectric substance, wherein the at least two opposing electrodes are coupled to an exterior portion of the actuator pouch, such that:
a first end of the actuator pouch, positioned between the at least two opposing electrodes, drives a portion of the dielectric substance within the actuator pouch when the voltage is provided to the at least two opposing electrodes,
an intermediary portion of the actuator pouch fluidically coupled to the first end and a second end of the actuator pouch allows the portion of the dielectric substance to travel between the first end and the second end, and
the second end of the actuator pouch coupled with the electrohydraulic-controlled haptic tactor causes the electrohydraulic-controlled haptic tactor to generate the haptic response in response to movement of the dielectric substance to the second end of the actuator pouch.

16. The non-transitory computer-readable storage medium of claim 15, wherein the intermediary portion includes a semi-rigid tube forming a channel for the dielectric substance to move between the first and second ends of the actuator pouch.

17. The non-transitory computer-readable storage medium of claim 15, wherein the electrohydraulic-controlled haptic tactor of the array of individually controlled electrohydraulic-controlled haptic tactors applies a respective perceptible percussion force at distinct portion of the wearable glove when the voltage is provided to the at least two opposing electrodes.

18. The non-transitory computer-readable storage medium of claim 15, wherein:
the array of individually controlled electrohydraulic-controlled haptic tactors is a first array of individually controlled electrohydraulic-controlled haptic tactors coupled to a first finger of the wearable glove, wherein the first finger of the wearable glove is configured to contact a user's first finger; and
the wearable glove further comprises a second array of individually controlled electrohydraulic-controlled haptic tactors coupled to a second portion of the wearable glove that is configured to contact a user's second finger.

19. The non-transitory computer-readable storage medium of claim 15, wherein the executable instructions, when executed by one or more processors of the wearable glove, further cause the wearable glove to:
adaptively adjust the voltage provided to the at least two opposing electrodes based on user participation in an artificial-reality environment and/or instructions received via an intermediary device.

20. The non-transitory computer-readable storage medium of claim 19, wherein while the voltage is provided to the at least two opposing electrodes, the executable instructions, when executed by one or more processors of the wearable glove, cause the wearable glove to:
detect a force applied to the electrohydraulic-controlled haptic tactor and in response to detecting the force applied to the electrohydraulic-controlled haptic tactor:
adjust the voltage provided to the at least two opposing electrodes based on the force applied to the electrohydraulic-controlled haptic tactor, and
cause an input command to be performed at a communicatively coupled intermediary device or in an artificial-reality environment.
